(19) United States
(12) Patent Application Publication
(10) Pub. No.: US 2026/0051651 A1
(43) Pub. Date: Feb. 19, 2026

(54) ELECTRONIC DEVICE

(71) Applicant: HUAWEI TECHNOLOGIES CO., LTD., Shenzhen (CN)

(72) Inventors: Chuanbo Shi, Shanghai (CN); Libin Sun, Shanghai (CN); Liang Xue, Shanghai (CN); Huiliang Xu, Shenzhen (CN); Shaogang Deng, Dongguan (CN); Hanyang Wang, Reading (GB)

(73) Assignee: HUAWEI TECHNOLOGIES CO., LTD., Shenzhen (CN)

(21) Appl. No.: 19/370,395

(22) Filed: Oct. 27, 2025

Related U.S. Application Data
(63) Continuation of application No. PCT/CN2024/089442, filed on Apr. 24, 2024.

(30) Foreign Application Priority Data
Apr. 28, 2023 (CN) 202310483943.3
Aug. 29, 2023 (CN) 202311104696.8
Sep. 28, 2023 (CN) 202311294342.4

(51) Int. Cl. H01Q 1/24; H01Q 5/20; H01Q 5/30; H01Q 21/30

(52) U.S. Cl. CPC H01Q 1/243; H01Q 5/20; H01Q 5/30; H01Q 21/30

(57) ABSTRACT

An electronic device includes an antenna. A conductive part of a side frame of the electronic device is used as a radiator of the antenna. A first radiator of the antenna includes a conductive part of the side frame between a first position and a second position. Slots are provided at the first position and the second position of the side frame. The first position and the second position are located on a short side of the electronic device. An operating frequency band of the antenna includes a satellite communication frequency band.

### CROSS-REFERENCE TO RELATED APPLICATIONS

This is a continuation of International Application No. PCT/CN2024/089442 filed on Apr. 24, 2024, which claims priorities to Chinese Patent Application No. 202310483943.3 filed on Apr. 28, 2023 and Chinese Patent Application No. 202311104696.8, filed on Aug. 29, 2023 and Chinese Patent Application No. 202311294342.4, filed on Sep. 28, 2023. All of the aforementioned patent applications are hereby incorporated by reference in their entireties.

### TECHNICAL FIELD

Disclosed embodiments relate to the field of wireless communication, and in particular, to an electronic device.

### BACKGROUND

Currently, in an existing terminal electronic device, a side frame is used as an antenna radiator. For example, in a satellite navigation or satellite communication system, a side frame radiator is mainly configured to form a linearly polarized antenna. When a user performs satellite navigation or satellite communication, a maximum radiation direction of an antenna needs to point to a satellite, to implement satellite alignment (establish a communication connection to the satellite). However, a maximum radiation direction of the linearly polarized antenna formed by the side frame radiator is perpendicular to a display of the electronic device. When performing satellite navigation or communication, the user needs to make the display face the sky, causing great inconvenience in use.

### SUMMARY

Embodiments of this disclosure provide an electronic device. The electronic device includes an antenna. A part of a conductive side frame of the electronic device is used as a main radiator and a parasitic stub of the antenna, so that user experience during satellite navigation or communication can be improved.

According to a first aspect, an electronic device is provided, including: a ground plane; a side frame, including a first side and a second side that intersect at an angle, where a length of the first side is greater than a length of the second side, the second side includes a first position, a second position, and a first ground member located (i.e., positioned) between the first position and the second position, a first slot and a second slot are respectively provided at the first position and the second position of the side frame, and the side frame is coupled to the ground plane via the first ground member, where a width of a connection between the first ground member and the side frame is greater than or equal to 2 mm and less than or equal to 8 mm, or an electronic component is coupled between the first ground member and the ground plane, and an equivalent capacitance value of the electronic component is greater than or equal to 3 pF; and a first antenna, including: a first radiator, where the first radiator is a conductive part of the side frame between the first position and the second position, an end of the first radiator at the first position is a first end, and an end of the first radiator at the second position is a second end; a first feed circuit, where the first radiator includes a first feed point, a length of the first radiator between the first feed point and the first end is different from a length of the first radiator between the first feed point and the second end, and the first feed circuit is coupled to the first feed point; and a first tuning circuit and a second tuning circuit, where the first radiator further includes a first connection point and a second connection point, the first connection point is located between the first end and the first ground member, the second connection point is located between the second end and the first ground member, the first tuning circuit is coupled to the first connection point, and the second tuning circuit is coupled to the second connection point. An operating frequency band of the first antenna includes a satellite communication frequency band.

According to embodiments of this disclosure, a wire DM mode of the first radiator can be excited at the same time through side feed. When the first radiator is disposed on the second side, radiation efficiency and system efficiency of a resonance generated by an antenna in the wire DM mode are high. Because a gain of the antenna is related to directionality and efficiency (radiation efficiency and system efficiency) of the antenna, when efficiency (radiation efficiency and system efficiency) of the antenna is improved, and directionality remains unchanged, the gain of the antenna can still be improved.

With reference to the first aspect, in some implementations of the first aspect, a length of the first radiator between the first connection point and the first end is less than or equal to one half of a length of the first radiator between the first end and a connection position between the first radiator and the first ground member, and/or a length of the first radiator between the second connection point and the second end is less than or equal to one half of a length of the first radiator between the second end and the connection position between the first radiator and the first ground member.

According to embodiments of this disclosure, the first connection point and the second connection point can be disposed in an area close to the first slot and the second slot. The first end and the second end of the first radiator are open ends. In an area near the open end, there is generally a strong electric field, and an area with a strong electric field has good tuning performance.

With reference to the first aspect, in some implementations of the first aspect, the first tuning circuit and the second tuning circuit are in a first circuit state, and the first radiator is configured to generate a first main resonance, where a resonant frequency band of the first main resonance includes a first frequency band. The first tuning circuit and the second tuning circuit are in a second circuit state, and the first radiator is configured to generate a second main resonance, where a resonant frequency band of the second main resonance includes a second frequency band.

With reference to the first aspect, in some implementations of the first aspect, the first tuning circuit and the second tuning circuit are in the first circuit state, and the first radiator is configured to generate a first resonance and a second resonance, where a resonant point frequency of the first resonance is lower than a resonant point frequency of the second resonance, and the second resonance is the first main resonance. The first tuning circuit and the second tuning circuit are in the second circuit state, and the first radiator is configured to generate a third resonance and a fourth resonance, where a resonant point frequency of the third resonance is lower than a resonant point frequency of the fourth resonance, and the fourth resonance is the second main resonance.

With reference to the first aspect, in some implementations of the first aspect, a frequency difference between a resonant point of the second resonance and a resonant point of the first resonance is less than or equal to 300 MHz; and/or a frequency difference between a resonant point of the fourth resonance and a resonant point of the third resonance is less than or equal to 300 MHz.

With reference to the first aspect, in some implementations of the first aspect, the frequency difference between the resonant point of the second resonance and the resonant point of the first resonance is greater than or equal to 100 MHz; and/or the frequency difference between the resonant point of the fourth resonance and the resonant point of the third resonance is greater than or equal to 100 MHz.

With reference to the first aspect, in some implementations of the first aspect, based on that the width of the connection between the first ground member and the side frame is greater than or equal to 2 mm and less than 4 mm, a frequency difference between a resonant point of the second resonance and a resonant point of the first resonance is less than or equal to 450 MHz, and/or a frequency difference between a resonant point of the fourth resonance and a resonant point of the third resonance is less than or equal to 450 MHz; and based on that the width of the connection between the first ground member and the side frame is greater than or equal to 4 mm and less than or equal to 8 mm, the frequency difference between the resonant point of the second resonance and the resonant point of the first resonance is less than or equal to 400 MHz, and/or the frequency difference between the resonant point of the fourth resonance and the resonant point of the third resonance is less than or equal to 400 MHz; or based on that the electronic component is coupled between the first ground member and the ground plane, a frequency difference between a resonant point of the second resonance and a resonant point of the first resonance is less than or equal to 500 MHz, and/or a frequency difference between a resonant point of the fourth resonance and a resonant point of the third resonance is less than or equal to 500 MHz.

With reference to the first aspect, in some implementations of the first aspect, based on that the width of the connection between the first ground member and the side frame is greater than or equal to 2 mm and less than 4 mm, the frequency difference between the resonant point of the second resonance and the resonant point of the first resonance is greater than or equal to 50 MHz, and/or the frequency difference between the resonant point of the fourth resonance and the resonant point of the third resonance is greater than or equal to 50 MHz; and based on that the width of the connection between the first ground member and the side frame is greater than or equal to 4 mm and less than or equal to 8 mm, the frequency difference between the resonant point of the second resonance and the resonant point of the first resonance is greater than or equal to 50 MHz, and/or the frequency difference between the resonant point of the fourth resonance and the resonant point of the third resonance is greater than or equal to 50 MHz; or based on that the electronic component is coupled between the first ground member and the ground plane, the frequency difference between the resonant point of the second resonance and the resonant point of the first resonance is greater than or equal to 50 MHz, and/or the frequency difference between the resonant point of the fourth resonance and the resonant point of the third resonance is greater than or equal to 50 MHz.

With reference to the first aspect, in some implementations of the first aspect, at the resonant point of the first main resonance, current on the first radiator is co-directional; and at the resonant point of the second main resonance, the current on the first radiator is co-directional.

With reference to the first aspect, in some implementations of the first aspect, the side frame further includes a third position and a second ground point. The third position is located on the first side. The second position is located between the first position and the third position. The second ground point is located between the second position and the third position. A third slot is provided at the third position of the side frame. The side frame is coupled to the ground plane at the second ground point. The first antenna further includes a second radiator and a third radiator. The second radiator is a conductive part of the side frame between the second position and the second ground point. The third radiator is a conductive part of the side frame between the second ground point and the third position.

With reference to the first aspect, in some implementations of the first aspect, the third radiator further includes a third connection point. The electronic device further includes a third tuning circuit. The third tuning circuit is coupled to the third connection point.

With reference to the first aspect, in some implementations of the first aspect, the third tuning circuit is in the first circuit state, and the third radiator is configured to generate a first parasitic resonance, where a frequency difference between the resonant point of the first main resonance and a resonant point of the first parasitic resonance is less than or equal to 200 MHz. The third tuning circuit is in the second circuit state, and the third radiator is configured to generate a second parasitic resonance, where a frequency difference between the resonant point of the second main resonance and a resonant point of the second parasitic resonance is less than or equal to 200 MHz.

With reference to the first aspect, in some implementations of the first aspect, a length R1 of the third radiator and a length L1 of the first radiator satisfy: L1×30%≤R1≤L1×55%.

With reference to the first aspect, in some implementations of the first aspect, the second radiator further includes a fourth connection point. The electronic device further includes a fourth tuning circuit. The fourth tuning circuit is coupled to the fourth connection point.

With reference to the first aspect, in some implementations of the first aspect, the fourth tuning circuit is in the first circuit state, and the second radiator is configured to generate a third parasitic resonance, where a frequency difference between a resonant point of the third parasitic resonance and the resonant point of the first main resonance is greater than or equal to 200 MHz and less than or equal to 500 MHz. The fourth tuning circuit is in the second circuit state, and the second radiator is configured to generate a fourth parasitic resonance, where a frequency difference between a resonant point of the fourth parasitic resonance and the resonant point of the second main resonance is greater than or equal to 200 MHz and less than or equal to 500 MHz.

With reference to the first aspect, in some implementations of the first aspect, a length R2 of the second radiator and a length L1 of the first radiator satisfy: L1×35%≤R2≤L1×60%.

With reference to the first aspect, in some implementations of the first aspect, the electronic device further includes a second antenna. The second antenna includes: the second radiator, where the second radiator includes a second feed point; and a second feed circuit, where the second feed circuit is coupled to the second feed point.

With reference to the first aspect, in some implementations of the first aspect, the second feed point coincides with the fourth connection point.

With reference to the first aspect, in some implementations of the first aspect, the electronic device further includes a third antenna. The third antenna includes: the third radiator, where the third radiator includes a third feed point; and a third feed circuit, where the third feed circuit is coupled to the third feed point.

With reference to the first aspect, in some implementations of the first aspect, the third feed point coincides with the third connection point.

With reference to the first aspect, in some implementations of the first aspect, the side frame further includes a fourth position and a third ground point. The first position is located between the second position and the fourth position. The third ground point is located between the first position and the fourth position. A fourth slot is provided at the fourth position of the side frame. The side frame is coupled to the ground plane at the third ground point. The first antenna further includes a fourth radiator and a fifth radiator. The fourth radiator is a conductive part of the side frame between the first position and the third ground point. The fifth radiator is a conductive part of the side frame between the third ground point and the fourth position.

With reference to the first aspect, in some implementations of the first aspect, the fifth radiator further includes a fifth connection point. The electronic device further includes a fifth tuning circuit. The fifth tuning circuit is coupled to the fifth connection point.

With reference to the first aspect, in some implementations of the first aspect, the fifth tuning circuit is in the first circuit state, and the fifth radiator is configured to generate a fifth parasitic resonance, where a frequency difference between the resonant point of the first main resonance and a resonant point of the fifth parasitic resonance is less than or equal to 200 MHz. The fifth tuning circuit is in the second circuit state, and the fifth radiator is configured to generate a sixth parasitic resonance, where a frequency difference between the resonant point of the second main resonance and a resonant point of the sixth parasitic resonance is less than or equal to 200 MHz.

With reference to the first aspect, in some implementations of the first aspect, a length R3 of the fifth radiator and a length L1 of the first radiator satisfy: L1×40%≤R3≤L1×65%.

With reference to the first aspect, in some implementations of the first aspect, a fourth antenna. The fourth antenna includes: the fourth radiator, where the fourth radiator includes a fourth feed point; and a fourth feed circuit, where the fourth feed circuit is coupled to the fourth feed point.

With reference to the first aspect, in some implementations of the first aspect, a fifth antenna. The fifth antenna includes: the fifth radiator, where the fifth radiator includes a fifth feed point; and a fifth feed circuit, where the fifth feed circuit is coupled to the fifth feed point.

With reference to the first aspect, in some implementations of the first aspect, the electronic device further includes a second ground member. The side frame is coupled to the ground plane at the second ground point via the second ground member. A width of a connection between the second ground member and the side frame is greater than or equal to 2 mm and less than or equal to 12 mm.

With reference to the first aspect, in some implementations of the first aspect, the electronic device further includes a third ground member. The side frame is coupled to the ground plane at the third ground point via the third ground member. A width of a connection between the third ground member and the side frame is greater than or equal to 1 mm and less than or equal to 20 mm.

With reference to the first aspect, in some implementations of the first aspect, a length by which the first ground member extends between the side frame and the ground plane is less than or equal to 6 mm.

With reference to the first aspect, in some implementations of the first aspect, the first ground member is located in a central area of the first radiator. The central area includes the center of the first radiator. The first radiator has a same length on two sides of the center.

With reference to the first aspect, in some implementations of the first aspect, the electronic device includes a middle frame. The middle frame includes the side frame and a middle plate. The middle plate is electrically connected to the ground plane. The first ground member is connected between the side frame and the middle plate, and is integrated with the side frame and the middle plate.

With reference to the first aspect, in some implementations of the first aspect, the first feed point is disposed between the first ground member and the second end. The electronic device further includes a sixth antenna. The sixth antenna includes: a sixth radiator, where the sixth radiator is a radiator part of the first radiator between the first ground member and the first end, and the sixth radiator includes a sixth feed point; and a sixth feed circuit, where the sixth feed circuit is coupled to the sixth feed point.

According to a second aspect, an electronic device is provided, including: a ground plane; a side frame, including a first side and a second side that intersect at an angle, where a length of the first side is greater than a length of the second side, the first side includes a first position, the second side includes a second position, the side frame further includes a first ground member between the first position and the second position, a first slot and a second slot are respectively provided at the first position and the second position of the side frame, and the side frame is coupled to the ground plane at the first ground member, where a width of a connection between the first ground member and the side frame is greater than or equal to 2 mm and less than or equal to 8 mm; and a first antenna, including: a first radiator, where the first radiator is a conductive part of the side frame between the first position and the second position, an end of the first radiator at the first position is a first end, and an end of the first radiator at the second position is a second end; a first feed circuit, where the first radiator includes a first feed point, a length of the first radiator between the first feed point and the first end is different from a length of the first radiator between the first feed point and the second end, and the first feed circuit is coupled to the first feed point; and a first tuning circuit and a second tuning circuit, where the first radiator further includes a first connection point and a second connection point, the first connection point is located between the first end and the first ground member, the second connection point is located between the second end and the first ground member, the first tuning circuit is coupled to the first connection point, and the second tuning circuit is coupled to the second connection point.

With reference to the second aspect, in some implementations of the second aspect, a length of the first radiator between the first connection point and the first end is less than or equal to one half of a length of the first radiator between the first end and a connection position between the first radiator and the first ground member, and/or a length of the first radiator between the second connection point and the second end is less than or equal to one half of a length of the first radiator between the second end and the connection position between the first radiator and the first ground member.

With reference to the second aspect, in some implementations of the second aspect, a length of a first part is greater than or equal to one half of a length of a second part and less than or equal to three halves of the length of the second part. The first part is a part of the first radiator on the first side. The second part is a part of the first radiator on the second side.

According to a third aspect, an electronic device is provided, including: a ground plane; a side frame, including a first side and a second side that intersect at an angle, where a length of the first side is greater than a length of the second side, the second side includes a first position and a second position, and a first slot and a second slot are respectively provided at the first position and the second position of the side frame; and a first antenna, including: a first radiator, where the first radiator is a conductive part of the side frame between the first position and the second position, an end of the first radiator at the first position is a first end, and an end of the first radiator at the second position is a second end; a first feed circuit, where the first radiator includes a first feed point, the first feed circuit is coupled to the first feed point, and a length of the first radiator between the first feed point and the first end is different from a length of the first radiator between the first feed point and the second end; and a first tuning circuit and a second tuning circuit, where the first radiator further includes a first connection point and a second connection point, the first connection point is located between the first end and a first ground member, the second connection point is located between the second end and the first ground member, the first tuning circuit is coupled to the first connection point, and the second tuning circuit is coupled to the second connection point. An operating frequency band of the first antenna includes a satellite communication frequency band, an L1 frequency band in a GPS, and at least a part of frequency bands in sub 6G. When the electronic device performs satellite communication, the first feed circuit is configured to feed an electrical signal of the satellite communication frequency band. When the electronic device does not perform satellite communication, the first feed circuit is configured to feed an electrical signal of the L1 frequency band in the GPS and/or an electrical signal of at least the part of frequency bands in the sub 6G.

With reference to the third aspect, in some implementations of the third aspect, the first feed point coincides with the first connection point or the second connection point.

With reference to the third aspect, in some implementations of the third aspect, the side frame further includes a third position and a first ground point. The third position is located on the first side. The second position is located between the first position and the third position. The first ground point is located between the second position and the third position. A third slot is provided at the third position of the side frame. The side frame is coupled to the ground plane at the first ground point. The first antenna further includes a second radiator and a third radiator. The second radiator is a conductive part of the side frame between the second position and the first ground point. The third radiator is a conductive part of the side frame between the first ground point and the third position.

With reference to the third aspect, in some implementations of the third aspect, the electronic device further includes a second antenna. The second antenna includes: the second radiator, where the second radiator includes a second feed point; and a second feed circuit, where the second feed circuit is coupled to the second feed point.

With reference to the third aspect, in some implementations of the third aspect, the electronic device further includes a third antenna. The third antenna includes: the third radiator, where the third radiator includes a third feed point; and a third feed circuit, where the third feed circuit is coupled to the third feed point.

According to a fourth aspect, an electronic device is provided, including: a ground plane; a side frame, including a first position, a second position, a third position, and a fourth position that are successively disposed, where the side frame further includes a first side and a second side that intersect at an angle, a length of the first side is greater than a length of the second side, the second side includes the first position, the second position, and the third position, the first side includes the fourth position, and a first slot and a second slot are respectively provided at the first position and the second position of the side frame; and an antenna, including: a first radiator, where the first radiator is a conductive part of the side frame between the first position and the second position, an end of the first radiator at the first position is a first end, and an end of the first radiator at the second position is a second end; a second radiator, where the second radiator is a conductive part of the side frame between the third position and the fourth position; a first feed circuit and a second feed circuit, where the first radiator includes a first feed point, the second radiator includes a second feed point, the first feed circuit is coupled to the first feed point, the second feed circuit is coupled to the second feed point, and a length of the first radiator between the first feed point and the first end is different from a length of the first radiator between the first feed point and the second end; and a first tuning circuit and a second tuning circuit, where the first radiator further includes a first connection point and a second connection point, the first connection point is located between the first end and a first ground member, the second connection point is located between the second end and the first ground member, the first tuning circuit is coupled to the first connection point, and the second tuning circuit is coupled to the second connection point. An operating frequency band of the first antenna includes a satellite communication frequency band and a first frequency band. When the electronic device performs satellite communication, the first feed circuit is configured to feed an electrical signal of the satellite communication frequency band, and the second feed circuit is configured to feed an electrical signal of the first frequency band.

With reference to the fourth aspect, in some implementations of the fourth aspect, the second position coincides with the third position.

With reference to the fourth aspect, in some implementations of the fourth aspect, the first frequency band includes a GPS frequency band.

With reference to the fourth aspect, in some implementations of the fourth aspect, the first frequency band includes a Wi-Fi frequency band or a BT frequency band.

According to a fifth aspect, an electronic device is provided, including: a ground plane; a side frame, including a first ground point, and a first position, a second position, and a third position that are successively disposed, where the first ground point is located between the second position and the third position, a first slot, a second slot, and a third slot are respectively provided at the first position, the second position, and the third position of the side frame, and the side frame is coupled to the ground plane at the first ground point; and an antenna, including: a first radiator, a second radiator, and a third radiator, where the first radiator is a conductive part of the side frame between the first position and the second position, the second radiator is a conductive part of the side frame between the second position and the first ground point, and the third radiator is a conductive part of the side frame between the first ground point and the third position; and a first feed circuit, where the first radiator includes a first feed point, a distance between the first feed point and the first position is different from a distance between the first feed point and the second position, and the first feed circuit is coupled to the first feed point. The first radiator is configured to generate a first resonance and a second resonance, where a resonant point frequency of the first resonance is lower than a resonant point frequency of the second resonance, and a resonant frequency band of the second resonance includes a first frequency band. The third radiator is configured to generate a first parasitic resonance, where a resonant point frequency of the first parasitic resonance is lower than the resonant point frequency of the second resonance. The first frequency band includes a satellite communication frequency band.

With reference to the fifth aspect, in some implementations of the fifth aspect, the side frame includes a first side and a second side that intersect at an angle. A length of the first side is greater than a length of the second side. The second side includes the first position, the second position, and a first ground member located between the first position and the second position. The side frame is coupled to the ground plane via the first ground member.

With reference to the fifth aspect, in some implementations of the fifth aspect, a width of a connection between the first ground member and the side frame is greater than or equal to 2 mm and less than or equal to 8 mm. Alternatively, an electronic component is coupled between the first ground member and the ground plane, and an equivalent capacitance value of the electronic component is greater than or equal to 3 pF.

With reference to the fifth aspect, in some implementations of the fifth aspect, based on that the first feed circuit feeds an electrical signal, at a resonant point of the second resonance, a current on the first radiator and a current on the third radiator are co-directional.

With reference to the fifth aspect, in some implementations of the fifth aspect, the second radiator is configured to generate a second parasitic resonance, where resonant point frequency of the second parasitic resonance is higher than the resonant point frequency of the second resonance.

With reference to the fifth aspect, in some implementations of the fifth aspect, a frequency difference between a resonant point of the second parasitic resonance and the resonant point of the second resonance is greater than or equal to 200 MHz and less than or equal to 500 MHz.

With reference to the fifth aspect, in some implementations of the fifth aspect, a frequency difference between the resonant point of the second resonance and a resonant point of the first parasitic resonance is greater than 0 MHz and less than or equal to 200 MHz.

### BRIEF DESCRIPTION OF DRAWINGS

FIG. 1 is a diagram of an electronic device 10 according to an embodiment of this disclosure;

FIG. 2 is a diagram of a structure of a wire antenna in a common mode and corresponding current and electric field distribution according to this application;

FIG. 3 is a diagram of a structure of another wire antenna in a differential mode and corresponding current and electric field distribution according to this application;

FIG. 4 is a diagram of another electronic device 10 according to an embodiment of this disclosure;

FIG. 5 shows a simulation result of an S-parameter of an antenna 100 in the electronic device 10 shown in FIG. 4;

FIG. 6 shows simulation results of system efficiency and radiation efficiency of an antenna 100 in the electronic device 10 shown in FIG. 4;

FIG. 7 is a diagram of an electronic device 10 according to an embodiment of this disclosure;

FIG. 8 is a diagram of an electronic device 10 according to an embodiment of this disclosure;

FIG. 9A is a diagram of an electronic device 10 according to an embodiment of this disclosure;

FIG. 9B is a diagram of an electronic device 10 according to an embodiment of this disclosure;

FIG. 10 is a diagram of an electronic device 10 according to an embodiment of this disclosure;

FIG. 11 shows a simulation result of an S-parameter of an antenna 200 shown in FIG. 10;

FIG. 12 shows simulation results of system efficiency and radiation efficiency of an antenna 200 shown in FIG. 10;

FIG. 13 is a diagram of current distribution corresponding to a quarter-wavelength mode when an antenna 200 shown in FIG. 10 operates at 2.2 GHz;

FIG. 14 is a diagram of current distribution corresponding to a CM mode when an antenna 200 shown in FIG. 10 operates at 2.2 GHz;

FIG. 15 is a diagram of current distribution corresponding to a DM mode when an antenna 200 shown in FIG. 10 operates at 2.2 GHz;

FIG. 16(a) to FIG. 16(d) are a diagram (rear view) of current distribution of an antenna 200 shown in FIG. 10 when a third connection point is grounded;

FIG. 17(a) to FIG. 17(d) are a diagram (rear view) of current distribution of an antenna 200 shown in FIG. 10 when a third connection point is not grounded;

FIG. 18 is a diagram (rear view) of electric field distribution of an antenna 200 shown in FIG. 10 when a third connection point is grounded;

FIG. 19 is a diagram (rear view) of electric field distribution of an antenna 200 shown in FIG. 10 when a third connection point is not grounded;

FIG. 20 is a pattern of a directional gain of an antenna 200 shown in FIG. 10 when a third connection point is grounded;

FIG. 21 is a pattern of left-hand circular polarization directionality of an antenna 200 shown in FIG. 10 when a third connection point is grounded;

FIG. 22 is a pattern of a directional gain of an antenna 200 shown in FIG. 10 when a third connection point is not grounded;

FIG. 23 is a pattern of left-hand circular polarization directionality of an antenna 200 shown in FIG. 10 when a third connection point is not grounded;

FIG. 24 shows a simulation result of an S-parameter of an antenna 200 shown in FIG. 10;

FIG. 25 shows simulation results of system efficiency and radiation efficiency of an antenna 200 shown in FIG. 10;

FIG. 26 is a diagram of another electronic device 10 according to an embodiment of this disclosure;

FIG. 27 is a diagram of another electronic device 10 according to an embodiment of this disclosure;

FIG. 28(a) to FIG. 28(d) are a diagram of a graphical user interface of an electronic device 10 according to an embodiment of this disclosure;

FIG. 29 is a diagram of another electronic device 10 according to an embodiment of this disclosure; and

FIG. 30 is a diagram of another electronic device 10 according to an embodiment of this disclosure.

### DESCRIPTION OF EMBODIMENTS

The following explains terms that may appear in embodiments of this disclosure.

It should be understood that the term “and/or” used in this specification describes only a same field between associated objects and indicates that three relationships may exist. For example, A and/or B may indicate the following three cases: Only A exists, both A and B exist, and only B exists. In addition, the character “/” in this specification generally indicates an “or” relationship between associated objects.

The term “in a range of . . . ” used in this application includes end values at the two ends of the range by default, unless it is separately indicated that the end values are not included. For example, in a range of 1 to 5, two values 1 and 5 are included.

A coupling may be understood as a direct coupling and/or an indirect coupling, and a “coupling connection” may be understood as a direct coupling connection and/or an indirect coupling connection. The direct coupling may also be referred to as an “electrical connection”, and may be understood as physical contact and electrical conduction of components, or may be understood as a form in which different components in a line structure are connected through a physical line that can transmit an electrical signal, for example, a copper foil or a conductive wire of a printed circuit board (PCB). The “indirect coupling” may be understood as electrical conduction of two conductors through air or without contact. In an embodiment, the indirect coupling may also be referred to as a capacitive coupling. For example, signal transmission is implemented by forming an equivalent capacitor through a coupling in a spacing formed by spacing two conductive members.

An element/a component includes at least one of a lumped element/component and a distributed element/component.

A lumped element/component is a general term for all elements whose sizes are much less than a wavelength corresponding to an operating frequency of a circuit. For a signal, a characteristic of the element always remains unchanged at any time, regardless of a frequency.

A distributed element/component is different from a lumped element, where if a size of an element is close to or greater than a wavelength corresponding to an operating frequency of a circuit, when a signal passes through the element, a characteristic of each point of the element varies with the signal. In this case, the element cannot be integrally regarded as a single entity with a fixed characteristic, but should be referred to as a distributed element.

A capacitor may be understood as a lumped capacitor and/or a distributed capacitor. The lumped capacitor is a capacitive component, for example, a capacitive element. The distributed capacitor is an equivalent capacitor formed by spacing two conductive members at a specific spacing.

An inductor may be understood as a lumped inductor and/or a distributed inductor. The lumped inductor is an inductive component, for example, an inductive element. The distributed inductor is an equivalent inductor formed by a conductive member with a specific length.

A radiator is an apparatus configured to receive/send electromagnetic wave radiation in an antenna. In some cases, in a narrow sense, the “antenna” is the radiator. The radiator converts guided wave energy from a transmitter into a radio wave, or converts a radio wave into guided wave energy to radiate and receive a radio wave. A modulated high-frequency current energy (or guided wave energy) generated by the transmitter is transmitted to a transmit radiator through a feeder. The radiator converts the modulated high-frequency current energy (or guided wave energy) into polarized electromagnetic wave energy, and radiates the polarized electromagnetic wave energy in a required direction. A receive radiator converts polarized electromagnetic wave energy from a specific direction in space into modulated high-frequency current energy, and transmits the modulated high-frequency current energy to an input end of a receiver through a feeder.

The radiator may include a conductor in a specific shape and size, for example, a linear conductor or a sheet-like conductor. A specific shape is not limited in this application. In an embodiment, a linear radiator may be referred to as a wire antenna for short. In an embodiment, the linear radiator may be implemented by a conductive side frame, and may alternatively be referred to as a side frame antenna. In an embodiment, the linear radiator may be implemented by a support conductor, and may alternatively be referred to as a support antenna. In an embodiment, for the linear radiator or a radiator of the wire antenna, a wire diameter (for example, including a thickness and a width) is much less than a wavelength (for example, a medium wavelength) (for example, the wire diameter is less than 1/16 of the wavelength), and a length may be compared to the wavelength (for example, the medium wavelength) (for example, the length is approximately ⅛ of the wavelength, or is ⅛ to ¼ or ¼ to ½ of the wavelength, or is longer). Main forms of the wire antenna are a dipole antenna, a half-wave dipole antenna, a monopole antenna, a loop antenna, and an inverted F antenna (also referred to as an IFA, Inverted F Antenna). For example, for the dipole antenna, each dipole antenna usually includes two radiation stubs, and each stub is fed by a feed part from a feed end of the radiation stub. For example, the IFA may be considered as being obtained by adding a ground path to a monopole antenna. The IFA has one feed point and one ground point, and is referred to as the inverted F antenna because a side view of the IFA is in an inverted F shape. In an embodiment, a sheet-like radiator may include a microstrip antenna or a patch (patch) antenna, for example, a planar inverted F antenna (also referred to as a PIFA, Planar Inverted F Antenna). In an embodiment, the sheet-like radiator may be implemented by a planar conductor (for example, a conductive sheet or a conductive coating). In an embodiment, the sheet-like radiator may include a conductive sheet, for example, a copper sheet. In an embodiment, the sheet-like radiator may include a conductive coating, for example, silver paste. A shape of the sheet-like radiator includes a circle, a rectangle, a ring, and the like. A specific shape is not limited in this application. A structure of the microstrip antenna generally includes a dielectric substrate, a radiator, and a ground plane. The dielectric substrate is disposed between the radiator and the ground plane.

The radiator may also include a gap or a slot formed on a conductor, for example, a closed or semi-closed gap or slot formed on a grounded conductor surface. In an embodiment, a radiator provided with a gap or a slot may be referred to as a slot antenna or a slotted antenna for short. In an embodiment, for the gap or the slot of the slot antenna/slotted antenna, a radial size (for example, including a width) is much less than a wavelength (for example, a medium wavelength) (for example, the radial size is less than 1/16 of the wavelength), and a length size may be compared to the wavelength (for example, the medium wavelength) (for example, the length is approximately ⅛ of the wavelength, or is ⅛ to ¼ or ¼ to ½ of the wavelength, or is longer). In an embodiment, a radiator having a closed gap or slot may be referred to as a closed slot antenna for short. In an embodiment, a radiator having a semi-closed gap or slot (for example, an opening is additionally provided on a closed gap or slot) may be referred to as an open slot antenna for short. In some embodiments, a shape of the slot is a long strip. In some embodiments, a length of the slot is approximately half a wavelength (for example, the medium wavelength). In some embodiments, a length of the slot is approximately an integer multiple of the wavelength (for example, twice the medium wavelength). In some embodiments, the slot may be fed by a transmission line that is connected to one side or two sides of the slot through bridging. In this way, a radio frequency electromagnetic field is excited in the slot, and an electromagnetic wave is radiated to space. In an embodiment, a radiator of the slot antenna or the slotted antenna may be implemented by a conductive side frame that is grounded at two ends, and may alternatively be referred to as a side frame antenna. In this embodiment, it may be considered that the slot antenna or the slotted antenna includes a linear radiator, and the linear radiator is spaced from a ground plane and is grounded at two ends of the radiator, to form a closed or semi-closed gap or slot. In an embodiment, a radiator of the slot antenna or the slotted antenna may be implemented by a support conductor that is grounded at two ends, and may alternatively be referred to as a support antenna.

A feed circuit is a combination of all circuits configured to receive and transmit radio frequency signals. The feed circuit may include a transceiver and a radio frequency front end (RF front end). In some cases, in a narrow sense, the “feed circuit” is a radio frequency integrated circuit (RFIC), and the RFIC may be considered to include the radio frequency front end and the transceiver. The feed circuit has a function of converting a radio wave (for example, a radio frequency signal) and an electrical signal (for example, a digital signal). Usually, the feed circuit is considered as a part of radio frequency.

In some embodiments, an electronic device may further include a test base (which may also be referred to as a radio frequency base or a radio frequency test base). A coaxial cable may be inserted into the test base, to test a characteristic of the radio frequency front end or a radiator of an antenna through the cable. The radio frequency front end may be considered as a circuit part coupled between the test base and the transceiver.

In some embodiments, the radio frequency front end may be integrated into the radio frequency front-end integrated circuit in the electronic device, or the radio frequency front end and the transceiver may be integrated into the radio frequency integrated circuit in the electronic device.

It should be understood that any two of a first feed circuit, a second feed circuit, . . . , and an N^{th} feed circuit in this application may share a same transceiver, for example, transmit a signal through a radio frequency channel in the transceiver (for example, a pin of the radio frequency integrated circuit); and may further share a radio frequency front end, for example, process the signal via a tuning circuit or an amplifier in the radio frequency front end.

It should be further understood that two of the first feed circuit, the second feed circuit, . . . , and the N^{th} feed circuit in this application usually correspond to two radio frequency test bases in the electronic device.

A matching circuit is a circuit configured to adjust a radiation characteristic of an antenna. In an embodiment, the matching circuit is coupled between a feed circuit and a corresponding radiator. In an embodiment, the matching circuit is coupled between a test base and a radiator. Generally, the matching circuit is a combination of circuits coupled between the radiator and a ground plane. In an embodiment, the matching circuit may include a tuning circuit and/or an electronic component. The tuning circuit may be an electronic component configured to switch a coupling connection of the radiator. The matching circuit has a function of impedance matching and/or frequency tuning. Usually, the matching circuit is considered as a part of an antenna.

Ground structure/feed structure: The ground structure/feed structure may include a connector, for example, a metal dome. A radiator is coupled to a ground plane via the ground structure/coupled to a feed circuit via the feed structure. In some embodiments, the feed structure may include a transmission line/feeder, and the ground structure may include a ground wire.

End/point: The “end/point” in a first end/second end/feed end/ground end/feed point/ground point/connection point of an antenna radiator cannot be certainly understood in a narrow sense as an end point or an end part that is physically disconnected from another radiator, but may also be considered as a point or a section on the continuous radiator. In an embodiment, the “end/point” may include a connection/coupling area that is on the antenna radiator and that is coupled to another conductive structure. For example, the feed end/feed point may be a coupling area that is on the antenna radiator and that is coupled to a feed structure or a feed circuit (for example, an area facing a part of the feed circuit). For another example, the ground end/ground point may be a connection/coupling area that is on the antenna radiator and that is coupled to a ground structure or a ground circuit.

Open end and closed end: In some embodiments, the open end and the closed end are, for example, relative to whether the open end and the closed end are grounded, the closed end is grounded, and the open end is not grounded. In some embodiments, the open end and the closed end are, for example, relative to another conductor, the closed end is electrically connected to the another conductor, and the open end is not electrically connected to the another conductor. In an embodiment, the open end may also be referred to as a floating end, a free end, an open end, or an open-circuit end. In an embodiment, the closed end may also be referred to as a ground end or a short-circuit end. It should be understood that, in some embodiments, the open end may be coupled to the another conductor, to transfer coupling energy (which may be understood as transferring a current).

In some embodiments, the “closed end” may alternatively be understood from a perspective of current distribution. The closed end, the ground end, or the like may be understood as a high current point on a radiator, or may be understood as a weak electric field point on a radiator. In an embodiment, the closed end is coupled to an electronic component (for example, a capacitor or an inductor), so that a current distribution characteristic of the high current point/weak electric field point on the radiator may not be changed. In an embodiment, a slot (for example, a slot filled with an insulation material) is provided at or near the closed end, so that a current distribution characteristic of the high current point/weak electric field point on the radiator may not be changed.

In some embodiments, the “open end” may alternatively be understood from the perspective of current distribution. The open end, the floating end, or the like may be understood as a low current point on the radiator, or may be understood as a strong electric field point on the radiator. In an embodiment, the open end is coupled to an electronic component (for example, a capacitor or an inductor), so that a current distribution characteristic of the low current point/strong electric field point on the radiator may not be changed.

It should be understood that a radiator end in a slot (similar to a radiator at an opening of an open end or a floating end from a perspective of a structure of the radiator) is coupled to an electronic component (for example, a capacitor or an inductor), so that the radiator end is a high current point/weak electric field point. In this case, it should be understood that the radiator end in the slot is actually a closed end or a ground end.

A “floating radiator” mentioned in embodiments of this disclosure means that the radiator is not directly connected to a feeder/feed stub and/or a ground wire/ground stub but is fed and/or grounded in an indirect coupling manner.

It should be understood that “floating” in the “floating end” and the “floating radiator” does not mean that there is no structure around the radiator to support the radiator. In an embodiment, the floating radiator may be, for example, a radiator disposed on an inner surface of an insulation rear cover.

That current(s) is/are co-directional/counter-directional in embodiments of this disclosure should be understood as that directions of main currents on conductors on a same side are same/reverse. For example, when co-directionally distributed current is excited on a bent conductor or an annular conductor (for example, a current path is also bent or annular), it should be understood that, for example, although directions of main currents excited on conductors on two sides of the annular conductor (for example, on conductors on two sides of a slot in conductors around the slot) are reverse, the main currents still fall within a definition of co-directionally distributed currents in embodiments of this disclosure. In an embodiment, that current on one conductor is co-directional may mean that the current on the conductor has no counter-directional point. In an embodiment, that current on one conductor is counter-directional may mean that the current on the conductor has at least one counter-directional point. In an embodiment, that currents on two conductors are co-directional may mean that the currents on the two conductors have no counter-directional point, and flow in a same direction. In an embodiment, that currents on two conductors are counter-directional may mean that the currents on the two conductors have no counter-directional point, and flow in reverse directions. That currents on a plurality of conductors are co-directional/counter-directional may be accordingly understood.

That electric fields are co-directional/counter-directional in embodiments of this disclosure should be understood as that directions of main electric fields generated by a conductor in space (for example, electric fields between the conductor and a ground plane) are the same/reverse. For example, when co-directionally distributed electric fields are excited on a bent conductor or an annular conductor (for example, a spacing formed between the ground plane and the conductor is also bent or annular), it should be understood that, for example, directions of electric fields in the spacing are from the ground plane to the conductor or from the conductor to the ground plane, and although directions of main electric fields excited in spacings on two sides of the annular conductor (for example, in spacings on two sides of a slot on a conductor around the slot) are reverse, the main electric fields still fall within a definition of co-directionally distributed electric fields in embodiments of this disclosure. In an embodiment, that electric fields between one conductor and the ground plane are co-directional may mean that the electric fields between the conductor and the ground plane have no counter-directional point. In an embodiment, that electric fields between one conductor and the ground plane are counter-directional may mean that the electric fields between the conductor and the ground plane have at least one counter-directional point. In an embodiment, that electric fields between two conductors and the ground plane are co-directional may mean that the electric fields between the two conductors and the ground plane have no counter-directional point, and radiate in a same direction (for example, a forward direction of a z axis). In an embodiment, that electric fields between two conductors and the ground plane are counter-directional may mean that the electric fields between the two conductors and the ground plane have no counter-directional point, and flow in reverse directions. That electric fields between a plurality of conductors and the ground plane are co-directional/counter-directional may be accordingly understood.

Resonance/resonant frequency: The resonant frequency is also referred to as a resonant vibration frequency. The resonant frequency may have a frequency range, namely, a frequency range in which resonant vibration occurs. A frequency corresponding to a strongest resonant vibration point is a center frequency. A return loss of the center frequency may be less than −20 dB. It should be understood that, unless otherwise specified, an antenna/a radiator generates a “first/second/ . . . resonance” in this application, where the first resonance should be a fundamental mode resonance generated by the antenna/radiator, or a resonance that is generated by the antenna/radiator and that has a lowest frequency. It should be understood that the antenna/radiator may generate one or more antenna modes based on specific design, and one fundamental mode resonance may be correspondingly generated in each antenna mode.

Resonant frequency band: A range of a resonant frequency is the resonant frequency band, and a return loss of any frequency in the resonant frequency band may be less than −6 dB or −5 dB.

Communication frequency band/operating frequency band: regardless of an antenna type, the antenna always operates in a specific frequency range (bandwidth). For example, an operating frequency band of an antenna supporting a B40 frequency band includes a frequency ranging from 2300 MHz to 2400 MHz. In other words, the operating frequency band of the antenna includes the B40 frequency band. A frequency range that satisfies a requirement of an indicator may be considered as the operating frequency band of the antenna.

A resonant frequency band and the operating frequency band may be the same, or may partially overlap. In an embodiment, one or more resonant frequency bands of the antenna may cover one or more operating frequency bands of the antenna.

An electrical length may be a ratio of a physical length (namely, a mechanical length or a geometric length) to a wavelength of a transmitted electromagnetic wave. The electrical length may satisfy the following formula:

$$\overline{L} = \frac{L}{λ} , where$$

L is the physical length, and λ is the wavelength of the electromagnetic wave.

A wavelength or an operating wavelength may be a wavelength corresponding to a center frequency of a resonant frequency or a center frequency of an operating frequency band supported by an antenna. For example, it is assumed that a center frequency of a B1 uplink frequency band (a resonant frequency ranges from 1920 MHz to 1980 MHz) is 1955 MHz. In this case, an operating wavelength may be a wavelength obtained through calculation by using the frequency of 1955 MHz. The “operating wavelength” is not limited to the center frequency, and may alternatively be a wavelength corresponding to a non-center frequency of a resonant frequency or an operating frequency band.

It should be understood that a wavelength of a radiated signal in the air may be calculated as follows: (air wavelength or vacuum wavelength)=speed of light/frequency, where the frequency is a frequency (MHz) of the radiation signal, and the speed of light may be 3×10⁸ m/s. A wavelength of the radiated signal in a medium may be calculated as follows: medium wavelength=(speed of light/\sqrt{ε})/frequency, where ε is a relative dielectric constant of the medium. The wavelength in embodiments of this disclosure is usually a medium wavelength, and may be a medium wavelength corresponding to the center frequency of the resonant frequency, or a medium wavelength corresponding to the center frequency of the operating frequency band supported by the antenna. For example, it is assumed that the center frequency of the B1 uplink frequency band (the resonant frequency ranges from 1920 MHz to 1980 MHz) is 1955 MHz. In this case, the wavelength may be a medium wavelength obtained through calculation by using the frequency of 1955 MHz. The “medium wavelength” is not limited to the center frequency, and may alternatively be a medium wavelength corresponding to the non-center frequency of the resonant frequency or the operating frequency band. For ease of understanding, the medium wavelength mentioned in embodiments of this disclosure may be simply calculated by using a relative dielectric constant of a medium filled on one or more sides of a radiator.

System efficiency (total efficiency) of an antenna is a ratio of input power to output power at a port of the antenna.

Radiation efficiency (radiation efficiency) of an antenna is a ratio of power radiated by the antenna to space (namely, power for effectively converting an electromagnetic wave) to active power input to the antenna. Active power input to the antenna=input power of the antenna−loss power. The loss power mainly includes return loss power, metal ohmic loss power, and/or dielectric loss power. The radiation efficiency is a value for measuring a radiation capability of the antenna. A metal loss and a dielectric loss are both factors that affect the radiation efficiency.

A person skilled in the art may understand that the efficiency is generally indicated by a percentage, and there is a corresponding conversion relationship between efficiency and dB. Efficiency closer to 0 dB indicates better efficiency of the antenna.

An antenna pattern, also referred to as a radiation pattern, is a pattern in which relative field strength (a normalized modulus value) of a radiation field of an antenna changes with a direction at a specific distance from the antenna (a far field), and is usually represented by two plane patterns that are perpendicular to each other in a maximum radiation direction of the antenna.

The antenna pattern usually includes a plurality of radiation beams. A radiation beam with highest radiation strength is referred to as a main lobe, and another radiation beam is referred to as a minor lobe or side lobe. In minor lobes, a minor lobe in a reverse direction of the main lobe is also referred to as a back lobe.

Directivity: also referred to as directionality of an antenna, is a ratio of a maximum power density to an average value in an antenna pattern at a specific distance from the antenna (a far field), is a dimensionless ratio greater than or equal to 1, and may indicate an energy radiation characteristic of the antenna. Higher directivity indicates a larger proportion of energy radiated by the antenna in a direction, and more concentrated energy radiation.

An antenna gain indicates a degree to which an antenna intensively radiates input power. Usually, a narrower main lobe of the antenna pattern indicates a smaller minor lobe, and a higher antenna gain.

Polarization direction of an antenna: At a given point in space, electric field strength E (a vector) is a function of time t. As time goes by, a vector endpoint cyclically depicts a trajectory in the space. Polarization is referred to as vertical polarization if the trajectory is a straight line and vertical to the ground. Polarization is referred to as horizontal polarization if the trajectory is a straight line and is horizontal to the ground. Polarization is referred to as right-hand circular polarization (RHCP) if the trajectory is an ellipse or a circle and rotates right-handed or clockwise with the time when viewed in a propagation direction. Polarization is referred to as left-hand circular polarization (LHCP) if the trajectory is an ellipse or a circle and rotates left-handed or anticlockwise with the time when viewed in a propagation direction.

Axial ratio (AR) of an antenna: In circular polarization, a trajectory cyclically depicted by an electric field vector endpoint in space is an ellipse, and a ratio of a major axis to a minor axis of the ellipse is referred to as an axial ratio. The axial ratio is an important performance indicator of a circularly polarized antenna, indicates purity of circular polarization, and is an important indicator for measuring a difference between signal gains of the entire antenna in different directions. A circular polarization axial ratio of the antenna closer to 1 (the trajectory cyclically depicted by the electric field vector endpoint in the space is a circle) indicates better circular polarization performance of the antenna.

An antenna return loss may be understood as a ratio of power of a signal reflected back to an antenna port through an antenna circuit to transmit power of the antenna port. A weaker reflected signal indicates a stronger signal radiated by an antenna to space and higher radiation efficiency of the antenna. A stronger reflected signal indicates a weaker signal radiated by the antenna to the space and lower radiation efficiency of the antenna.

The antenna return loss may be indicated by an S11 parameter, and S11 is one of S-parameters. S11 indicates a reflection coefficient, and the parameter can represent transmit efficiency of the antenna. The S11 parameter is usually a negative number. A smaller S11 parameter indicates a smaller antenna return loss, less energy reflected back by the antenna, namely, more energy that actually enters the antenna, and higher system efficiency of the antenna. A larger S11 parameter indicates a larger antenna return loss and lower system efficiency of the antenna.

It should be noted that, in engineering, a value of S11 is generally −6 dB as a standard. When the value of S11 of the antenna is less than −6 dB, it may be considered that the antenna can operate normally, or it may be considered that transmit efficiency of the antenna is good.

A specific absorption rate (specific absorption rate, SAR) of an electromagnetic wave is an expression unit that measures how much radio frequency radiation energy is actually absorbed by a body, is referred to as a specific absorption ratio, and is expressed in watt per kilogram (W/kg) or milliwatt per gram (mW/g). The SAR is accurately defined as a derivative, relative to time, of unit energy (dw) absorbed by unit mass (dm) in a unit volume (dv) of a given mass density (ρ-density of human tissues).

Currently, there are two international standards: the European standard of 2 w/kg and the American standard of 1.6 w/kg. A specific meaning of the European standard means that electromagnetic radiation energy absorbed by each kilogram of human tissues cannot not exceed 2 watts in 6 minutes.

A ground (ground plane) (GND) may generally be at least a part of any grounding plane, or ground plate, or ground metal layer, or the like in an electronic device (for example, a mobile phone), or at least a part of any combination of any grounding plane, or ground plate, or ground component, or the like. The “ground” may be configured to ground a component in the electronic device. In an embodiment, the “ground” may be a grounding plane of a circuit board of the electronic device, or may be a ground plate formed by using a middle frame of the electronic device or a ground metal layer formed by a metal thin film at a lower part of a screen. In an embodiment, the circuit board may be a printed circuit board (PCB), for example, an 8-layer board, a 10-layer board, a 12-layer board, a 13-layer board, or a 14-layer board having 8, 10, 12, 13, or 14 layers of conductive materials respectively, or an element that is separated and electrically insulated by a dielectric layer or an insulation layer like a glass fiber or a polymer. In an embodiment, the circuit board includes a dielectric substrate, a grounding plane, and a wiring layer. The wiring layer and the grounding layer may be electrically connected through a via. In an embodiment, components such as a display, a touchscreen, an input button, a transmitter, a processor, a memory, a battery, a charging circuit, and a system on chip (SoC) structure may be mounted on or connected to the circuit board, or electrically connected to the wiring layer and/or the grounding plane in the circuit board. For example, a radio frequency source is disposed at the wiring layer.

The any grounding plane, or ground plate, or ground metal layer is made of a conductive material. In an embodiment, the conductive material may be any one of the following materials: copper, aluminum, stainless steel, brass, an alloy thereof, copper foil on an insulation substrate, aluminum foil on the insulation substrate, gold foil on the insulation laminate, silver-plated copper, silver-plated copper foil on the insulation substrate, silver foil on the insulation substrate, tin-plated copper, cloth impregnated with graphite powder, a graphite-coated substrate, a copper-plated substrate, a brass-plated substrate, and an aluminum-plated substrate. A person skilled in the art may understand that the grounding plane/ground plate/ground metal layer may alternatively be made of another conductive material.

Grounding means coupling to a ground/ground plane in any manner. In an embodiment, grounding may be grounding via an entity. For example, entity grounding at a specific position on a side frame is implemented via some mechanical parts of a middle frame (which is also referred to as an entity ground). In an embodiment, grounding may be grounding via a component. For example, grounding is implemented using a component like a capacitor/inductor/resistor connected in series or in parallel (which may also be referred to as a component ground).

The following describes technical solutions in embodiments of this disclosure with reference to accompanying drawings.

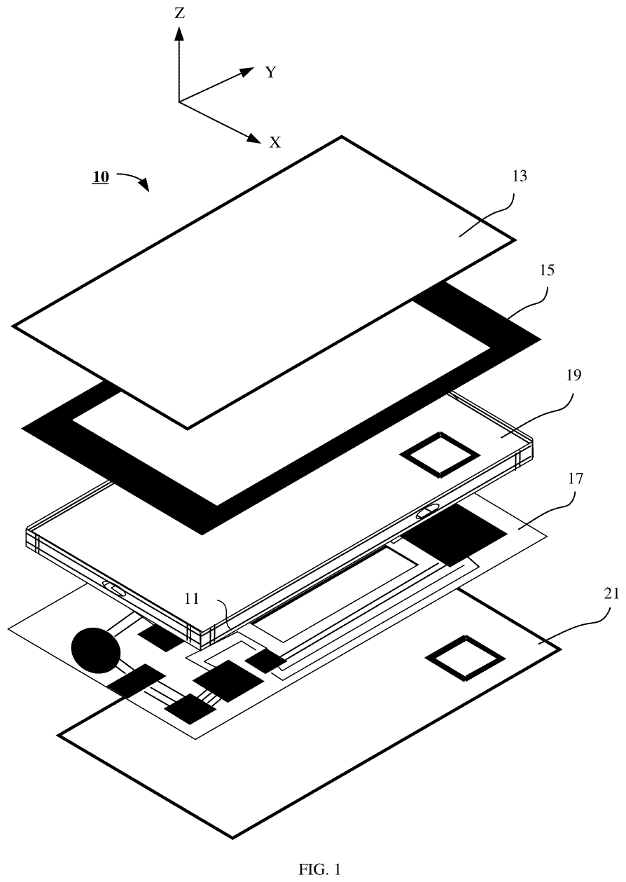

As shown in FIG. 1, an electronic device 10 may include a cover 13, a display/display module (display) 15, a printed circuit board (PCB) 17, a middle frame 19, and a rear cover 21. It should be understood that, in some embodiments, the cover 13 may be cover glass, or may be replaced with a cover of another material, for example, a polyethylene terephthalate (PET) cover.

The cover 13 may be disposed clinging to the display module 15, and may be mainly configured to implement protection and dust prevent functions for the display module 15.

In an embodiment, the display module 15 may include a liquid crystal display (LCD), a light-emitting diode (LED) display panel, an organic light-emitting semiconductor (OLED) display panel, or the like. This is not limited in embodiments of this disclosure.

The middle frame 19 is mainly configured to support the entire electronic device. FIG. 1 shows that the PCB 17 is disposed between the middle frame 19 and the rear cover 21. It should be understood that, in an embodiment, the PCB 17 may alternatively be disposed between the middle frame 19 and the display module 15. This is not limited in embodiments of this disclosure. The printed circuit board PCB 17 may be a flame-resistant material (FR-4) dielectric board, or may be a Rogers (Rogers) dielectric board, or may be a Rogers and FR-4 hybrid dielectric board, or the like. Herein, FR-4 is a grade designation of a flame-resistant material, and the Rogers dielectric board is a high-frequency board. An electronic component, for example, a radio frequency integrated circuit, is carried on the PCB 17. In an embodiment, a metal layer may be disposed on the printed circuit board PCB 17. The metal layer may be configured to ground the electronic component carried on the printed circuit board PCB 17, or may be configured to ground another element, for example, a support antenna or a side frame antenna. The metal layer may be referred to as a ground plane, a ground plate, or a grounding plane. In an embodiment, the metal layer may be formed by etching metal on a surface of any dielectric board in the PCB 17. In an embodiment, the metal layer configured for grounding may be disposed on a side that is of the printed circuit board PCB 17 that is close to the middle frame 19. In an embodiment, an edge of the printed circuit board PCB 17 may be considered as an edge of the grounding plane of the PCB 17. In an embodiment, the metal middle frame 19 may also be configured to ground the foregoing element. The electronic device 10 may further have another ground plane/ground plate/grounding plane, as described above. Details are not described herein again.

The electronic device 10 may further include a battery (not shown in the figure). The battery may be disposed between the middle frame 19 and the rear cover 21, or may be disposed between the middle frame 19 and the display module 15. This is not limited in embodiments of this disclosure. In some embodiments, the PCB 17 is divided into a main board and a sub-board. The battery may be disposed between the main board and the sub-board. The main board may be disposed between the middle frame 19 and an upper edge of the battery. The sub-board may be disposed between the middle frame 19 and a lower edge of the battery.

The electronic device 10 may further include a side frame 11. The side frame 11 may be made of a conductive material like metal. The side frame 11 may be disposed between the display module 15 and the rear cover 21, and circumferentially extends around a periphery of the electronic device 10. The side frame 11 may have four sides surrounding the display module 15, to help fasten the display module 15.

In an implementation, the side frame 11 made of the conductive material may be directly used as a conductive side frame of the electronic device 10, for example, form an appearance of the metal side frame. This is applicable to metal industrial design (industrial design, ID). In an implementation, an outer surface of the side frame 11 may be a conductive material, for example, a metal material, to form the appearance of the metal side frame. In these implementations, a conductive part of the side frame 11 may be used as an antenna radiator of the electronic device 10.

In another implementation, an outer surface of the side frame 11 may alternatively be a non-conductive material, for example, plastic, to form an appearance of a non-metal frame. This is applicable to a non-metal ID. In an implementation, an inner surface of the side frame 11 may include a conductive material, for example, a metal material. In this implementation, a conductive part of the side frame 11 may be used as the antenna radiator of the electronic device 10. It should be understood that a radiator disposed on the inner surface of the side frame 11 (which is also the conductive material on the inner surface) is attached to the non-conductive material of the side frame 11, to facilitate antenna radiation. Each of the conductive material and the non-conductive material should be considered as a part of the side frame 11.

The middle frame 19 may include the side frame 11, and the middle frame 19 including the side frame 11 is used as an integral member, and may support an electronic component in the entire electronic device. The cover 13 and the rear cover 21 respectively cover along an upper edge and a lower edge of the side frame, to form a casing or a housing (housing) of the electronic device. In an embodiment, the cover 13, the rear cover 21, the side frame 11, and/or the middle frame 19 may be collectively referred to as the casing or the housing of the electronic device 10. It should be understood that the “casing or housing” may indicate a part or all of any one of the cover 13, the rear cover 21, the side frame 11, and the middle frame 19, or indicate a part or all of any combination of the cover 13, the rear cover 21, the side frame 11, and the middle frame 19.

The side frame 11 on the middle frame 19 may be at least partially used as an antenna radiator to transmit/receive a radio frequency signal. There may be a spacing between the part of side frame used as the radiator and another part of the middle frame 19, to ensure that the antenna radiator has a good radiation environment. In an embodiment, the middle frame 19 may be provided with an aperture at the part of side frame used as the radiator, to facilitate antenna radiation.

Alternatively, the side frame 11 may not be considered as a part of the middle frame 19. In an embodiment, the side frame 11 may be connected to and integrated with the middle frame 19. In another embodiment, the side frame 11 may include a protrusion member extending inward, to be connected to the middle frame 19, for example, in a manner like a dome, a screw, or soldering. The protrusion member of the side frame 11 may be further configured to receive a feed signal, so that at least a part of the side frame 11 is used as an antenna radiator to transmit/receive a radio frequency signal. There is a spacing 42 between the part of side frame used as the radiator and the middle frame 30, to ensure that the antenna radiator has a good radiation environment, so that an antenna has a good signal transmission function.

The rear cover 21 may be a rear cover made of a metal material; or a rear cover made of a non-conductive material, for example, a non-metal rear cover like a glass rear cover or a plastic rear cover; or a rear cover including both a conductive material and a non-conductive material. In an embodiment, the rear cover 21 including the conductive material may replace the middle frame 19, and is used as an integrated member with the side frame 11, to support the electronic component in the entire electronic device.

In an embodiment, the middle frame 19 and/or a conductive part of the rear cover 21 may be used as a reference ground of the electronic device 10. The side frame 11, the PCB 17, and the like of the electronic device may be grounded by being electrically connected to the middle frame.

The antenna of the electronic device 10 may be alternatively disposed in the side frame 11. When the side frame 11 of the electronic device 10 is the non-conductive material, the antenna radiator may be located in the electronic device 10 and disposed along the side frame 11. For example, the antenna radiator is disposed approaching the side frame 11, to minimize a size occupied by the antenna radiator, and be closer to the exterior of the electronic device 10, so as to achieve a better signal transmission effect. It should be noted that, that the antenna radiator is disposed approaching the side frame 11 means that the antenna radiator may be disposed clinging to the side frame 11, or may be disposed close to the side frame 11. For example, there may be a specific small slot between the antenna radiator and the side frame 11.

The antenna of the electronic device 10 may alternatively be disposed in the housing, for example, a support antenna or a millimeter wave antenna (not shown in FIG. 1). A clearance of the antenna disposed in the housing may be obtained via a slot/hole in any one of the middle frame, and/or the side frame, and/or the rear cover, and/or the display or via a non-conductive slot/aperture formed between any several of the middle frame, the side frame, the rear cover, and the display. The clearance of the antenna is disposed, to ensure a radiation characteristic of the antenna. It should be understood that the clearance of the antenna may be a non-conductive area formed by any conductive component in the electronic device 10, and the antenna radiates a signal to external space through the non-conductive area. In an embodiment, a form of an antenna 40 may be an antenna form based on a flexible printed circuit (flexible printed circuit, FPC), an antenna form based on laser-direct-structuring (laser-direct-structuring, LDS), or an antenna form like a microstrip antenna (microstrip disk antenna, MDA). In an embodiment, the antenna may alternatively use a transparent structure embedded in a screen of the electronic device 10, so that the antenna is a transparent antenna embedded in the screen of the electronic device 10.

FIG. 1 shows, as an example, only some components included in the electronic device 10. Actual shapes, actual sizes, and actual structures of these components are not limited to those in FIG. 1.

It should be understood that, in embodiments of this disclosure, it may be considered that a surface on which the display of the electronic device is located is a front surface, a surface on which the rear cover is located is a rear surface, and a surface on which the side frame is located is a side surface.

It should be understood that, in embodiments of this disclosure, it is considered that, when a user holds (usually holds the electronic device vertically and faces the screen) the electronic device, an orientation in which the electronic device is located includes the top, the bottom, the left, and the right. It should be understood that, in embodiments of this disclosure, it is considered that, when the user holds (usually holds the electronic device vertically and faces the screen) the electronic device, the orientation in which the electronic device is located includes the top, the bottom, the left, and the right.

Embodiments of this disclosure provide an electronic device. The electronic device includes an antenna. A conductive part of a side frame of the electronic device is used as a main radiator and/or a parasitic stub of the antenna, so that user experience during satellite navigation or communication can be improved.

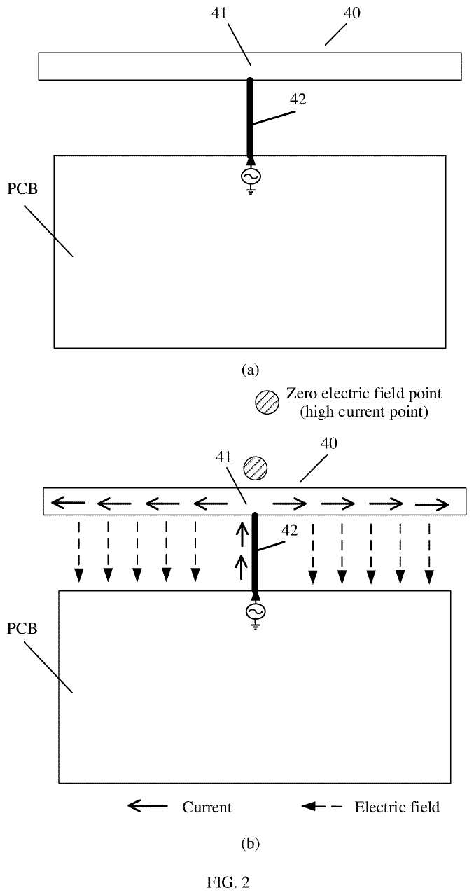

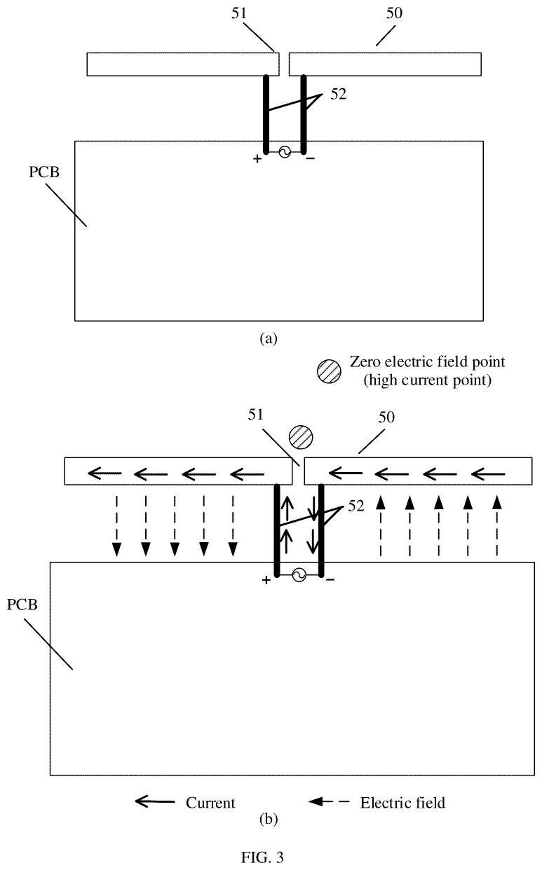

First, two antenna modes in this application are described with reference to FIG. 2 and FIG. 3. FIG. 2 is a diagram of a structure of an antenna in a common mode and corresponding current and electric field distribution according to this application. FIG. 3 is a diagram of a structure of another antenna in a differential mode and corresponding current and electric field distribution according to this application. Two ends of each of antenna radiators in FIG. 2 and FIG. 3 are open, and a common mode and a differential mode of the antenna radiators may be respectively referred to as a wire common mode and a wire differential mode.

It should be understood that a “common-differential mode” or a “CM-DM mode” in this application is a wire common mode and a wire differential mode that are generated on a same radiator.

### 1. Wire Common Mode (CM)

Herein, (a) in FIG. 2 shows that two ends of a radiator of an antenna 40 are open, and a feed circuit (not shown in the figure) is connected at a middle position 41. In an embodiment, a feed form of the antenna 40 is symmetrical feed. The feed circuit may be connected to the middle position 41 of the antenna 40 through a feeder 42. It should be understood that symmetrical feed may be understood as that one end of the feed circuit is connected to the radiator and the other end of the feed circuit is coupled to a ground plane to implement grounding. A connection point (feed point) between the feed circuit and the radiator is located in the center of the radiator. The center of the radiator may be, for example, a midpoint of a geometric structure, or a midpoint of an electrical length (or an area within a specific range near the midpoint).

The middle position 41 of the antenna 40 may be, for example, the geometric center of the antenna or the midpoint of the electrical length of the radiator. For example, a joint between the feeder 42 and the antenna 40 covers the middle position 41.

Herein, (b) in FIG. 2 shows current and electric field distribution of the antenna 40. As shown in (b) in FIG. 2, currents are counter-directionally distributed on two sides of the middle position 41, for example, symmetrically distributed. Electric fields are co-directionally distributed on the two sides of the middle position 41. As shown in (b) in FIG. 2, currents at the feeder 42 are co-directionally distributed. Based on that the currents at the feeder 42 are co-directionally distributed, such feed shown in (a) in FIG. 2 may be referred to as wire CM feed. Based on that the currents are counter-directionally distributed on two sides of the joint between the radiator and the feeder 42, such an antenna mode shown in (b) in FIG. 2 may be referred to as a wire CM mode (or may also be referred to as a CM mode for short. For example, for a wire antenna, the CM mode is the wire CM mode). The current and the electric field shown in (b) in FIG. 2 may be respectively referred to as a current and an electric field in the wire CM mode.

The currents are higher at the middle position 41 of the antenna 40 (a high current point is located near the middle position 41 of the antenna 40), and are lower at two ends of the antenna 40, as shown in (b) in FIG. 2. The electric fields are weaker at the middle position 41 of the antenna 40 and stronger at the two ends of the antenna 40.

### 2. Wire Differential Mode (DM)

As shown in (a) in FIG. 3, the left end and the right end of each of two radiators of an antenna 50 are open ends, and a feed circuit is connected at a middle position 51. In an embodiment, a feed form of the antenna 50 is anti-symmetrical feed. One end of the feed circuit is connected to one radiator through a feeder 52, and the other end of the feed circuit is connected to the other radiator through the feeder 52. The middle position 51 may be the geometric center of the antenna 50, or a slot formed between the radiators.

It should be understood that “central anti-symmetrical feed” mentioned in this application may be understood as that a positive electrode and a negative electrode of a feed element are respectively connected to two connection points near midpoints of the radiators. In an embodiment, signals output by the positive electrode and the negative electrode of the feed element have a same amplitude and opposite phases. For example, a phase difference is 180°±10°.

Herein, (b) in FIG. 3 shows current and electric field distribution of the antenna 50. As shown in (b) in FIG. 3, currents are co-directionally distributed on two sides of the middle position 51 of the antenna 50, for example, anti-symmetrically distributed. The electric fields are counter- directionally distributed on the two sides of the middle position 51. As shown in (b) in FIG. 3, currents at the feeders 52 are counter-directionally distributed. Based on that the currents at the feeders 52 are counter-directionally distributed, such feed shown in (a) in FIG. 3 may be referred to as wire DM feed. Based on that the currents are co-directionally distributed on two sides of joints between the radiators and the feeders 52, such an antenna mode shown in (b) in FIG. 3 may be referred to as a wire DM mode (or may also be referred to as a DM mode for short. For example, for a wire antenna, the DM mode is the wire DM mode). The current and the electric field shown in (b) in FIG. 3 may be respectively referred to as a current and an electric field in the wire DM mode. It should be understood that, based on that the currents are co-directionally distributed on the two sides of the joints between the radiators and the feeders 52, such an antenna mode shown in (b) in FIG. 3 may also be referred to as a one-half antenna mode or a one-half-wavelength mode, or may be referred to as a one-half mode for short.

In an embodiment, in the wire DM mode or the one-half mode, the currents are higher at the middle position 51 of the antenna 50 (a high current point is located near the middle position 51 of the antenna 50), and are lower at two ends of the antenna 50, as shown in (b) in FIG. 3. The electric fields are weaker at the middle position 51 of the antenna 50 and stronger at the two ends of the wire antenna 50.

It should be understood that the antenna radiator may be understood as a metal mechanical part that generates radiation, there may be one antenna radiator, as shown in FIG. 2, or there may be two antenna radiators, as shown in FIG. 3, and a quantity of antenna radiators may be adjusted based on an actual design or production requirement. For example, for the wire CM mode, two radiators may alternatively be used, as shown in FIG. 3. Two ends of each of the two radiators are oppositely disposed and are spaced at a slot. Symmetrical feed is used at the two ends that are close to each other. For example, an effect similar to that of the antenna structure shown in FIG. 2 may also be achieved by separately feeding a same feed source signal into the two ends that are of the two radiators and that are close to each other. Correspondingly, for the wire DM mode, one radiator may alternatively be used, as shown in FIG. 2. Two feed points are disposed at a middle position of the radiator, and anti-symmetrical feed is used. For example, an effect similar to that of the antenna structure shown in FIG. 3 may also be achieved by respectively feeding signals having a same amplitude and opposite phases into the two symmetrical feed points on the radiator.

### 3. Wire CM-DM Mode

FIG. 2 and FIG. 3 respectively show that, when two ends of a radiator are open, a wire CM mode and a wire DM mode are respectively generated in different feed manners.

When a feed form of an antenna is asymmetrical feed (a feed point deviates from a middle position of the radiator, and side feed or offset feed is included), or ground points (a position coupled to a ground plane) of the radiator is asymmetrical (the ground points deviates from the middle position of the radiator), the antenna may generate a first resonance and a second resonance at the same time that respectively correspond to the wire CM mode and the wire DM mode. For example, the first resonance corresponds to the wire CM mode, and current and electric field distribution is shown in (b) in FIG. 2. The second resonance corresponds to the wire DM mode, and current and electric field distribution is shown in (b) in FIG. 3.

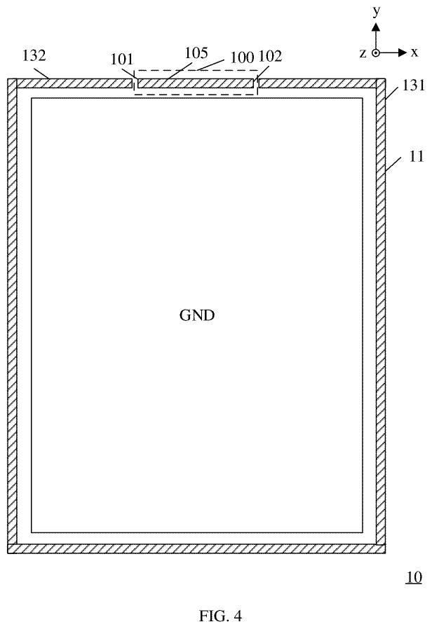

FIG. 4 is a diagram of another electronic device 10 according to an embodiment of this disclosure.

As shown in FIG. 4, a conductive side frame 11 of the electronic device 10 may include a first side 131 and a second side 132 that intersect at an angle, and a length of the first side 131 is greater than a length of the second side 132.

The second side 132 may have a first position 101 and a second position 102, and slots are provided at the first position 101 and the second position 102 of the side frame 11. A radiator 105 of an antenna 100 may include a conductive part of the side frame between the first position 101 and the second position 102.

In an embodiment, a first side frame 105 is symmetrical with respect to a virtual axis of the second side 132, and the second side 132 has a same length on two sides of the virtual axis. Due to a specific error in engineering application, when a proportion of a distance between the first position 101 and the virtual axis to a distance between the second position 102 and the virtual axis is greater than or equal to 90% and less than or equal to 110%, it may be considered that the first side frame 105 is symmetrical with respect to the virtual axis of the second side 132.

It should be understood that, for the antenna, as a structure of the antenna is symmetrical (for example, the radiator 105 is located in the center of the second side 132), a radiation characteristic (for example, a bandwidth and radiation efficiency) of the antenna is improved.

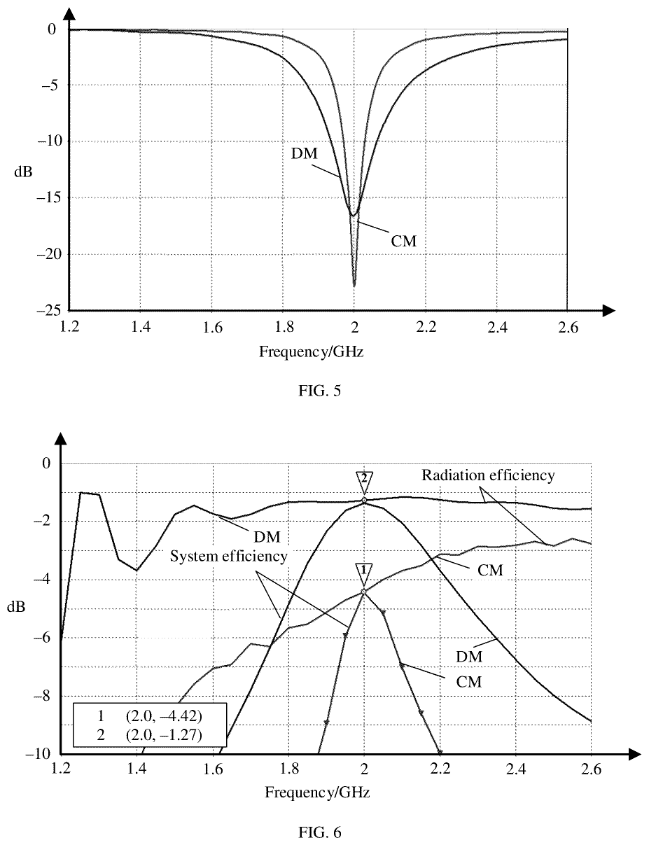

FIG. 5 and FIG. 6 are diagrams of simulation results of the antenna 100 in the electronic device 10 shown in FIG. 4. FIG. 5 shows a simulation result of an S-parameter of the antenna 100 in the electronic device 10 shown in FIG. 4. FIG. 6 shows simulation results of system efficiency and radiation efficiency of the antenna 100 in the electronic device 10 shown in FIG. 4.

As shown in FIG. 5, when the antenna shown in FIG. 4 separately uses the feed manners shown in FIG. 2 and FIG. 3, a wire CM mode and a wire DM mode may be separately generated. In both the wire CM mode and the wire DM mode, the antenna may generate resonances near a target frequency band (for example, 2 GHz).

It should be understood that, for brevity of description, in this embodiment, an example in which the wire CM mode and the wire DM mode are separately excited is merely used for description. With reference to the foregoing embodiment, the wire CM mode and the wire DM mode may alternatively be excited at the same time in a manner of asymmetrical feed (a feed point deviates from a middle position of the radiator, and side feed or offset feed is included) and/or in a manner in which a ground point (a position coupled to a ground plane) of the radiator is asymmetrical (the ground point deviates from the middle position of the radiator).

As shown in FIG. 6, when the first side frame (the radiator) is symmetrical with respect to the virtual axis of the second side (located in the center of the second side), at a resonant point (2 GHz), in the CM mode, radiation efficiency is −4.42 dB, and system efficiency is −4.47 dB, and in the DM mode, radiation efficiency is −1.27 dB, and system efficiency is −1.39 dB.

It should be understood that, when the first side frame is located in the center of the second side, a transverse mode may be excited (a proportion of the transverse mode exceeds that of a longitudinal mode), but currents corresponding to the transverse mode cancel. As a result, system efficiency and radiation efficiency in the CM mode are lower.

For the DM mode, radiation of the antenna is mainly generated by the radiator (the first side frame) in the DM mode, and system efficiency and radiation efficiency are better than those in the CM mode when the first side frame is disposed in the center of the second side.

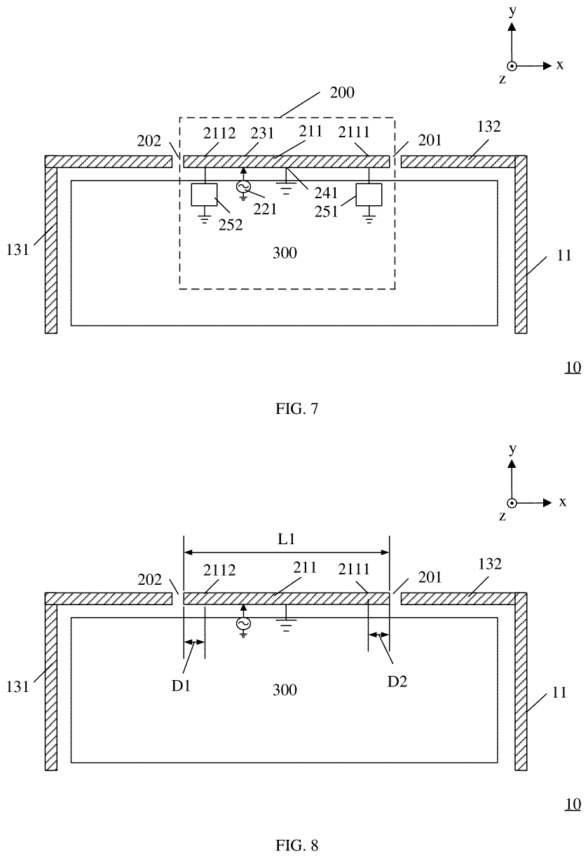

FIG. 7 is a diagram of an electronic device 10 according to an embodiment of this disclosure.

As shown in FIG. 7, the electronic device 10 includes a side frame 11, an antenna 200, and a ground plane 300.

The side frame 11 may include a first side 131 and a second side 132 that intersect at an angle, and a length of the first side 131 is greater than a length of the second side 132.

It should be understood that the technical solutions provided in embodiments of this disclosure may also be applied to a foldable electronic device. For brevity of description, only an electronic device (non-foldable) including a single display is used as an example for description. In the foldable electronic device, the first side 131 and the second side 132 may be understood as a first side and a second side corresponding to a case in which the foldable electronic device is in a folded state.

The second side 132 may have a first position 201, a second position 202, and a first ground member located between the first position 201 and the second position 202. A first slot and a second slot are respectively provided at the first position 201 and the second position 202 of the side frame 11. The side frame 11 is coupled to the ground plane 300 via the first ground member.

In an embodiment, widths of the slots provided at the first position 201 and the second position 202 are greater than or equal to 0.2 mm and less than or equal to 1.5 mm. All slots provided in embodiments of this disclosure may be within the foregoing range. It should be understood that the width of the slot may be understood as a distance between ends of the side frame on two sides of the slot.

The antenna 200 includes a first radiator 211, a first feed circuit 221, a first tuning circuit 251, and a second tuning circuit 252.

The first radiator 211 is a conductive part of the side frame between the first position 201 and the second position 202. A first end (an end close to the first position 201) and a second end (an end close to the second position 202) of the first radiator 211 are open ends.

The first radiator 211 includes a first feed point 231. A distance between the first feed point 231 and the first position 201 is different from a distance between the first feed point 231 and the second position 202, so that the first radiator 211 generates a wire CM mode and a wire DM mode at the same time. The first feed circuit 221 is coupled to the first feed point 231, and is configured to feed an electrical signal, to excite the antenna 200 to generate a resonance. That a distance between the first feed point 231 and the first position 201 is different from a distance between the first feed point 231 and the second position 202 may also be understood as that a length of the first radiator 211 between the first feed point 231 and the first end is different from a length of the first radiator 211 between the first feed point and the second end. It should be understood that, in this application, a “distance” from a first point/first end/first position to a second point/second end/second position on a radiator/side frame may be understood in a same or similar manner.

It should be understood that, that a distance between the first feed point 231 and the first position 201 is different from a distance between the first feed point 231 and the second position 202 may be understood as that an absolute value of a difference between a first distance that is between the first feed circuit 221 and the first position 201 and a second distance that is between the first feed point 231 and the second position 202 is greater than or equal to 5 mm. In addition, for brevity of description, in this embodiment of this disclosure, an example in which the first feed circuit 221 is electrically connected to the first feed point 231 is merely used for description. During actual application, the first feed circuit 221 may alternatively be indirectly coupled to the first feed point 231. This is not limited in embodiments of this disclosure. In addition, in embodiments of this disclosure, all coupling connections may be accordingly understood.

The first radiator 211 further includes a first connection point 2111 and a second connection point 2112. The first connection point 2111 is located between the first position 201 and the first ground member. The second connection point 2112 is located between the second position 202 and the first ground member. The first tuning circuit 251 is coupled to the first connection point 2111, and the second tuning circuit 252 is coupled to the second connection point 2112.

It should be understood that the first tuning circuit 251 and the second tuning circuit 252 may be configured to adjust a resonant point frequency of a resonance generated by the first radiator 211, so that the antenna 200 operates in different operating frequency bands.

In an embodiment, the first tuning circuit 251 and the second tuning circuit 252 are in a first circuit state, and the first radiator 211 is configured to generate a first main resonance, where a resonant frequency band of the first main resonance includes a first frequency band. In an embodiment, the first tuning circuit 251 and the second tuning circuit 252 are in the first circuit state, and the first radiator 211 is configured to generate a first resonance and a second resonance, where a resonant point frequency of the first resonance is lower than a resonant point frequency of the second resonance, and the second resonance is the first main resonance.

In an embodiment, the first tuning circuit 251 and the second tuning circuit 252 are in a second circuit state, and the first radiator 211 is configured to generate a second main resonance, where a resonant frequency band of the second main resonance includes a second frequency band. In an embodiment, the first tuning circuit 251 and the second tuning circuit 252 are in the second circuit state, and the first radiator 211 is configured to generate a third resonance and a fourth resonance, where a resonant point frequency of the third resonance is lower than a resonant point frequency of the fourth resonance, and the fourth resonance is the second main resonance.

It should be understood that, according to the technical solutions provided in embodiments of this disclosure, the wire CM mode and the wire DM mode of the first radiator 211 may be excited at the same time through offset feed (the distance between the first feed point 231 and the first position 201 is different from the distance between the first feed point 231 and the second position 202). In the first circuit state, the first resonance is mainly generated in the wire CM mode, and the second resonance is mainly generated in the wire DM mode. In the second circuit state, the third resonance is mainly generated in the wire CM mode, and the fourth resonance is mainly generated in the wire DM mode.

It can be learned from the foregoing embodiments that, when the first radiator 211 is disposed on the second side 132, radiation efficiency and system efficiency of a resonance generated by the antenna 200 in the wire DM mode are higher. Because a gain of the antenna is related to directionality and efficiency (radiation efficiency and system efficiency) of the antenna, when efficiency (radiation efficiency and system efficiency) of the antenna is improved, and directionality remains unchanged, the gain of the antenna can still be improved. Therefore, when the electronic device 10 performs communication in the first frequency band or the second frequency band, a polarization characteristic of radiation generated by the antenna 200 is linear polarization, and a loss of 3 dB occurs when a circularly polarized electromagnetic wave is received. However, because the antenna 200 has good efficiency (radiation efficiency and system efficiency), correspondingly, the antenna 200 also has good directionality.

In an embodiment, the first ground member may be located in a central area of the first radiator 211. The central area includes the center of the first radiator 211, and the first radiator 211 has a same length on two sides of the center. The central area of the first radiator 211 may be understood as an area whose distance from the center of the first radiator 211 is within 5 mm. That the first ground member is located in the central area of the first radiator 211 may be understood as that the center of the first ground member is located in the central area of the first radiator 211.

It should be understood that, when generating the first main resonance or the second main resonance, the first radiator 211 may correspond to the wire DM mode. In the wire DM mode, the central area includes a high current point, and disposing of the first ground member in an area near the high current point does not affect the first main resonance or the second main resonance.

In an embodiment, each of the first tuning circuit 251 and the second tuning circuit 252 is a circuit including a switch. The switch may be configured to switch between electronic components that are coupled to a connection point in different circuit states and that have different resistance values, capacitance values, or inductance values. Alternatively, the switch may be in an open state, so that an electronic component is not coupled to a connection point. Alternatively, the switch may be configured to directly couple the ground plane 300 to a connection point, and no electronic component is disposed between the ground plane 300 and the connection point.

In an embodiment, each of the first tuning circuit 251 and the second tuning circuit 252 includes no switch, and may be a circuit formed by cascading a plurality of electronic components. The first tuning circuit 251 and the second tuning circuit 252 may have different equivalent capacitance values or equivalent inductance values at different frequencies.

In an embodiment, the first frequency band and the second frequency band may respectively correspond to a transmit frequency band and a receive frequency band in satellite communication. For example, in a Tiantong satellite system, the first frequency band may include 1980 MHz to 2010 MHz, and the second frequency band may include 2170 MHz to 2200 MHz. In a BeiDou satellite system, the first frequency band may include 1610 MHz to 1626.5 MHz, and the second frequency band may include 2483.5 MHz to 2500 MHz. Alternatively, the technical solution may be applied to another satellite communication system. This is not limited in embodiments of this disclosure.

In an embodiment, the electronic device 10 may perform voice communication through the antenna 200 when the antenna 200 operates in the Tiantong satellite system (the operating frequency band of the antenna 200 includes at least a part of frequency bands in the Tiantong satellite system). In an embodiment, the electronic device 10 may send or receive a message through the antenna 200 when the antenna 200 operates in the BeiDou satellite system (the operating frequency band of the antenna 200 includes at least a part of frequency bands in the BeiDou satellite system).

It should be understood that, for brevity of description, that the electronic device 10 performs satellite communication in embodiments of this disclosure may be understood as that the electronic device 10 may send a message to a satellite or receive a message from a satellite through the antenna 200, or the electronic device 10 may perform voice communication through the antenna 200 via a satellite.

In an embodiment, a frequency difference between a resonant point of the second resonance and a resonant point of the first resonance is less than or equal to 300 MHz. In an embodiment, the frequency difference between the resonant point of the second resonance and the resonant point of the first resonance is greater than or equal to 100 MHz.

In an embodiment, a frequency difference between a resonant point of the fourth resonance and a resonant point of the third resonance is less than or equal to 300 MHz. In an embodiment, the frequency difference between the resonant point of the fourth resonance and the resonant point of the third resonance is greater than or equal to 100 MHz.

It should be understood that the first radiator 211 generates resonances in the wire CM mode and the wire DM mode. When the frequency difference between the resonant point of the second resonance (the fourth resonance) and the resonant point of the first resonance (the third resonance) is greater than or equal to 100 MHz and less than or equal to 300 MHz, a proportion of the wire DM mode in the second resonance (the fourth resonance) may increase. In this way, the antenna 200 mainly generates radiation in the wire DM mode in the resonant frequency band of the second resonance (the fourth resonance), to improve radiation efficiency and system efficiency of the antenna 200 in the first frequency band (the second frequency band). When the frequency difference between the resonant point of the second resonance (the fourth resonance) and the resonant point of the first resonance (the third resonance) is greater than 300 MHz, a proportion of another operating mode (for example, the wire CM mode) in the second resonance (the fourth resonance) increases. Consequently, radiation efficiency and system efficiency of the antenna 200 in the first frequency band (the second frequency band) decrease.

In an embodiment, based on a width of a connection between the first ground member and the side frame 11 and a center frequency of the operating frequency band of the antenna 200, the frequency difference between the resonant point of the second resonance and the resonant point of the first resonance and/or the frequency difference between the resonant point of the fourth resonance and the resonant point of the third resonance may be determined.

In an embodiment, the center frequency of the operating frequency band of the antenna 200 is greater than or equal to 1 GHz and less than 2.5 GHz. For example, the operating frequency band includes at least the part of frequency bands in the Tiantong satellite system and at least the part of frequency bands in the BeiDou satellite system.

When the width of the connection between the first ground member and the side frame 11 is greater than or equal to 2 mm and less than 4 mm, the frequency difference between the resonant point of the second resonance and the resonant point of the first resonance is less than or equal to 450 MHz, and/or the frequency difference between the resonant point of the fourth resonance and the resonant point of the third resonance is less than or equal to 450 MHz. The frequency difference between the resonant point of the second resonance and the resonant point of the first resonance is greater than or equal to 50 MHz, and/or the frequency difference between the resonant point of the fourth resonance and the resonant point of the third resonance is greater than or equal to 50 MHz.

When the width of the connection between the first ground member and the side frame 11 is greater than or equal to 4 mm and less than or equal to 8 mm, the frequency difference between the resonant point of the second resonance and the resonant point of the first resonance is less than or equal to 400 MHz, and/or the frequency difference between the resonant point of the fourth resonance and the resonant point of the third resonance is less than or equal to 400 MHz. The frequency difference between the resonant point of the second resonance and the resonant point of the first resonance is greater than or equal to 50 MHz, and/or the frequency difference between the resonant point of the fourth resonance and the resonant point of the third resonance is greater than or equal to 50 MHz.

In an embodiment, the center frequency of the operating frequency band of the antenna 200 is greater than or equal to 2.5 GHz and less than or equal to 5 GHz. For example, the operating frequency band includes at least a part of frequency bands in another system.

When the width of the connection between the first ground member and the side frame 11 is greater than or equal to 2 mm and less than 4 mm, the frequency difference between the resonant point of the second resonance and the resonant point of the first resonance is less than or equal to 450 MHz, and/or the frequency difference between the resonant point of the fourth resonance and the resonant point of the third resonance is less than or equal to 450 MHz. The frequency difference between the resonant point of the second resonance and the resonant point of the first resonance is greater than or equal to 100 MHZ, and/or the frequency difference between the resonant point of the fourth resonance and the resonant point of the third resonance is greater than or equal to 100 MHz.

When the width of the connection between the first ground member and the side frame 11 is greater than or equal to 4 mm and less than or equal to 8 mm, the frequency difference between the resonant point of the second resonance and the resonant point of the first resonance is less than or equal to 400 MHz, and/or the frequency difference between the resonant point of the fourth resonance and the resonant point of the third resonance is less than or equal to 400 MHz. The frequency difference between the resonant point of the second resonance and the resonant point of the first resonance is greater than or equal to 100 MHz, and/or the frequency difference between the resonant point of the fourth resonance and the resonant point of the third resonance is greater than or equal to 100 MHz.

In an embodiment, the first feed circuit may include a first radio frequency channel and a second radio frequency channel. The first radio frequency channel (configured to feed an electrical signal of the first frequency band) is configured to generate the first resonance and the second resonance. The second radio frequency channel (configured to feed an electrical signal of the second frequency band) is configured to generate the third resonance and the fourth resonance. The first radio frequency channel may be configured to feed a first electrical signal, and may correspond to the transmit frequency band in satellite communication. The second radio frequency channel may be configured to feed a second electrical signal, and may correspond to the receive frequency band in satellite communication. The first radio frequency channel and the second radio frequency channel may be understood as two different electrical signal transmission circuits, for example, may be understood as two different radio frequency channels in a radio frequency integrated circuit (RFIC).

It should be understood that each of feed circuits provided in embodiments of this disclosure may have the foregoing structure. The electrical signals are fed in a combined feed manner, to reduce a feed point on the radiator, and reduce system design complexity.

In an embodiment, a length of the first radiator 211 between the first connection point 2111 and the first end is less than or equal to one half of a length of the first radiator 211 between the first ground member and the first end.

In an embodiment, a distance between the first connection point 2111 and the first position 201 on the first radiator 211 is less than or equal to one half of a distance between the first ground member and the first position 201 on the first radiator 211.

In an embodiment, the ground member has a specific width, and is connected to the radiator in a direction of the width. In an embodiment, the length of the radiator between the ground member and the first end or the distance between the ground member and the first position on the radiator may be understood as a shortest distance/length from the first end of the radiator to the ground member, namely, a distance/length from the first end of the radiator to a nearest edge of the ground member.

In an embodiment, a position at which the radiator is connected to the ground member may be considered as a ground point disposed on the radiator. For brevity of description, the following describes the embodiment by using, as a first ground point 241, the position (for example, an edge position) at which the ground member is connected to the radiator. It should be understood that calculation of a distance/length related to the ground member should be understood with reference to the foregoing descriptions.

In an embodiment, a length DI of the side frame between the first connection point 2111 and the first position 201 and a length LI of the side frame between the first position 201 and the second position 202 satisfy: D1≤L1×30%. In an embodiment, D1≤L1×10%, as shown in FIG. 8. In an embodiment, D1 is less than or equal to 8 mm.

It should be understood that, in embodiments of this disclosure, a length of the side frame (or a radiator) between A and B may be understood as a length of a conductive part between A and B. For example, when the side frame (or the radiator) is coupled to A or B via a metal component like a metal dome, the distance may be understood as a distance between the side frame (or the radiator) and the center of an end that is of the metal component and that is connected to A or B.

In an embodiment, a length of the first radiator 211 between the second connection point 2112 and the second end is less than or equal to one half of a length of the first radiator 211 between the first ground point 241 and the second end. In an embodiment, a distance between the second connection point 2112 and the second position 202 on the first radiator 211 is less than or equal to one half of a distance between the first ground point 241 and the second position 202 on the first radiator 211.

In an embodiment, a length D2 of the side frame between the second connection point 2112 and the second position 202 and the length L1 of the side frame between the first position 201 and the second position 202 satisfy: D2≤L1×30%. In an embodiment, D2≤L1×10%, as shown in FIG. 8. In an embodiment, D2 is less than or equal to 8 mm.

It should be understood that the first connection point 2111 and the second connection point 2112 may be disposed in an area close to the first slot and the second slot. The first end and the second end of the first radiator 211 are open ends. In an area near the open end, there is generally a strong electric field, and an area with a strong electric field has good tuning performance.

In an embodiment, the first position 201 and the second position 202 are symmetrical with respect to a virtual axis of the second side 132, and the second side has a same length on two sides of the virtual axis. Due to a specific error in engineering application, when a proportion of a distance between the virtual axis and the first position 201 to a distance between the virtual axis and the second position 202 is greater than or equal to 90% and less than or equal to 110%, it may be considered that the first position 201 and the second position 202 are symmetrical with respect to the virtual axis of the second side 132.

It should be understood that, as symmetry of the first radiator 211 increases, a radiation characteristic (for example, a bandwidth or radiation efficiency) of the antenna 200 is improved.

In an embodiment, the first feed point 231 may coincide with the first connection point 2111 or the second connection point 2112.

It should be understood that, in embodiments of this disclosure, a feed circuit may be coupled to a feed point via a feed member (for example, a metal dome). When the feed point coincides with a connection point, both a tuning circuit and the feed circuit may be coupled to a radiator (the feed point/connection point) via the feed member, to reduce a connection position on the radiator, and facilitate engineering implementation.

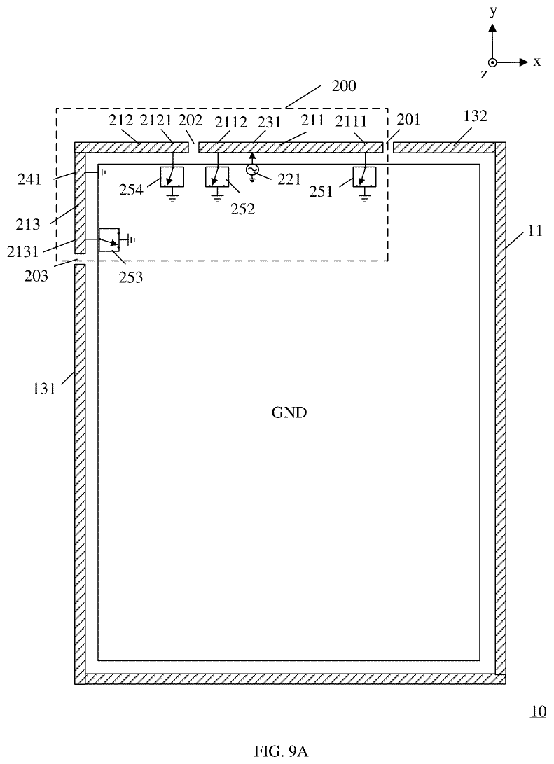

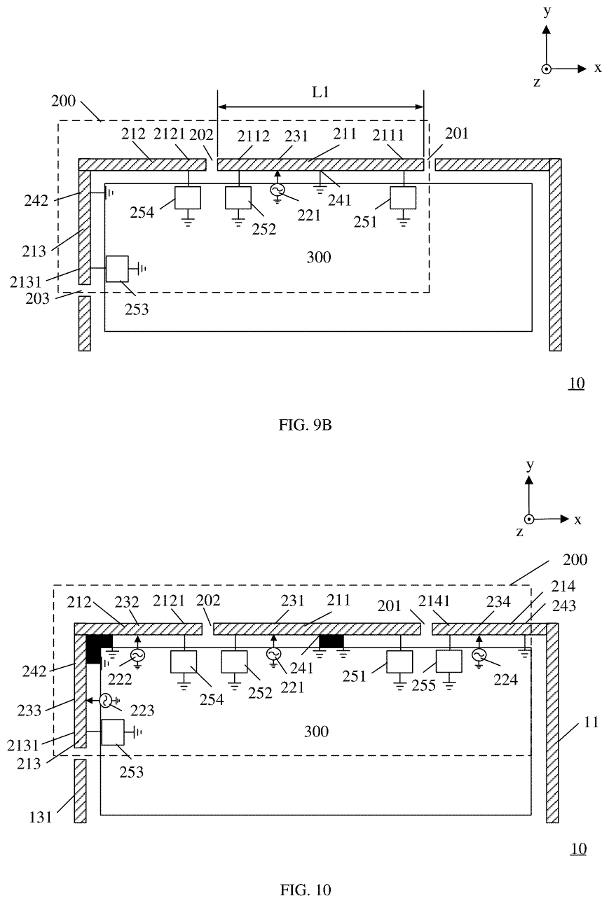

FIG. 9A is a diagram of an electronic device 10 according to an embodiment of this disclosure.

As shown in FIG. 9A, the electronic device 10 may include the conductive side frame 11, the antenna 200, and the first feed circuit 221.

The side frame 11 includes the first position 201, the second position 202, and the third position 203. The second position 202 is located between the first position 204 and the third position 203. The first ground point 241 is further included between the second position 202 and the third position 203.

The antenna 210 includes the first radiator 211, a second radiator 212, and a third radiator 213. The first radiator 211 includes at least a part of the side frame between the first position 201 and the second position 202. The second radiator 212 includes at least a part of the side frame between the second position 202 and the first ground point 241. The third radiator 213 includes at least a part of the side frame between the first ground point 241 and the third position 203.

It should be understood that, in some actual production or design, a radiator may further include a metal member disposed around the side frame. For brevity of description, in this embodiment of this disclosure, an example in which a part of the side frame is used as the radiator is merely used for description. This is not limited.

Seams are provided at the first position 201, the second position 202, and the third position 203 of the side frame 11. In an embodiment, widths of slots provided at the first position 201, the second position 202, and the third position 203 are greater than or equal to 0.2 mm and less than or equal to 1.5 mm. All slots formed by providing seams in embodiments of this disclosure may be within the foregoing range. It should be understood that the width of the slot may be understood as a distance between ends of the side frame on two sides of the slot.

The side frame 11 is grounded at the first ground point 241. A first end (an end close to the first position 201) and a second end (an end close to the second position 202) of the first radiator 211 are open ends. A first end (an end close to the second position 202) of the second radiator 212 is an open end, and a second end (an end close to the first ground point 241) of the second radiator 212 is a ground end. A first end (an end close to the first ground point 241) of the third radiator 213 is a ground end, and a second end (an end close to the third position 203) of the third radiator 213 is an open end.

The first radiator 211 includes the first feed point 231. A distance between the first feed point 231 and the first position 201 is different from a distance between the first feed point 231 and the second position 202. The first feed circuit 221 is coupled to the first feed point 231, and is configured to feed an electrical signal, to excite the antenna 200 to generate a resonance.

It should be understood that, that the distance between the first feed point 231 and the first position 201 is different from the distance between the first feed point 231 and the second position 202 may be understood as that an absolute value of a difference between a first distance that is between the first feed circuit 221 and the first position 201 and a second distance that is between the first feed point 231 and the second position 202 is greater than or equal to 5 mm. In addition, for brevity of description, in this embodiment of this disclosure, an example in which the first feed circuit 221 is electrically connected to the first feed point 231 is merely used for description. During actual application, the first feed circuit 221 may alternatively be indirectly coupled to the first feed point 231. This is not limited in embodiments of this disclosure. In addition, in embodiments of this disclosure, all coupling connections may be accordingly understood.

In an embodiment, the side frame 11 includes the first side 131 and the second side 132 that intersect at an angle. A length of the first side 131 is greater than a length of the second side 132. The first position 201 and the second position 202 are located on the second side 132.

The first radiator 211 is configured to generate a first resonance and a second resonance. A resonant point frequency of the first resonance is lower than a resonant point frequency of the second resonance. A resonant frequency band of the second resonance includes a first frequency band.

The third radiator 213 is configured to generate a first parasitic resonance. A resonant point frequency of the first parasitic resonance is lower than the resonant point frequency of the second resonance.

It should be understood that, according to the technical solutions provided in embodiments of this disclosure, a CM mode and a DM mode of the first radiator 211 may be excited at the same time through side feed (the distance between the first feed point 231 and the first position 201 is different from the distance between the first feed point 231 and the second position 202), to respectively generate the first resonance (which is mainly generated in the CM mode) and the second resonance (which is mainly generated in the DM mode). It can be learned from the foregoing embodiments that, when the first radiator 211 is disposed on the second side 132, radiation efficiency and system efficiency of a resonance generated by the antenna 200 in the DM mode are higher. Because directionality of the antenna is related to a gain and efficiency (radiation efficiency and system efficiency) of the antenna, when efficiency (radiation efficiency and system efficiency) of the antenna is improved, directionality of the antenna can still be improved. Therefore, when the electronic device 10 performs communication in the first frequency band, a polarization characteristic of radiation generated by the antenna 200 is linear polarization, and a loss of 3 dB occurs when a circularly polarized electromagnetic wave is received. However, because the antenna 200 has good efficiency (radiation efficiency and system efficiency), correspondingly, the antenna 200 also has good directionality.

In addition, when the first radiator 211 generates the second resonance in the DM mode, the third radiator 213 may be excited to generate the first parasitic resonance. In an embodiment, when the first feed circuit 221 feeds the electrical signal, at a resonant point of the second resonance, a current on the first radiator 211 and a current on the third radiator 213 are co-directional. In this way, a path of the current generated by the first radiator 211 can be extended, an effect of a similar current array can be obtained, and directionality of the antenna 200 can be improved. The third radiator 213 can be used to improve directionality of the antenna 200, and energy radiated by the antenna 200 toward the top of the electronic device 10 (for example, in a y direction) increases. In this way, when using the electronic device 10 to perform satellite navigation or communication in the first frequency band, a user does not need to change a posture of holding the electronic device 10, to obtain good user experience.

In an embodiment, a frequency difference between the resonant point of the second resonance and a resonant point of the first resonance is greater than or equal to 100 MHz and less than or equal to 300 MHz.

It should be understood that the first radiator 211 may separately generate the first resonance (in the CM mode) and the second resonance (in the DM mode) in the CM mode and the DM mode. When the frequency difference between the resonant point of the second resonance and the resonant point of the first resonance is greater than or equal to 100 MHz and less than or equal to 300 MHz, a proportion of the DM mode in the second resonance may increase. In this way, the antenna 200 mainly generates radiation in the resonant frequency band of the second resonance in the DM mode, to improve radiation efficiency and system efficiency of the antenna 200 in the first frequency band. When the frequency difference between the resonant point of the second resonance and the resonant point of the first resonance is greater than 300 MHz, a proportion of another operating mode (for example, the CM mode) in the second resonance (the fourth resonance) increases. Consequently, radiation efficiency and system efficiency of the antenna 200 in the first frequency band decrease.

In an embodiment, a frequency difference between the resonant point of the second resonance and a resonant point of the first parasitic resonance is greater than 0 MHz and less than or equal to 200 MHz.

It should be understood that, when the frequency difference between the resonant point of the second resonance and the resonant point of the first parasitic resonance is greater than 0 MHz and less than or equal to 200 MHz, the first feed circuit 221 feeds the electrical signal, and at the resonant point of the second resonance, a proportion of currents that are generated on the third radiator 213 and that are co-directional with the current on the first radiator 211 is larger, to further improve directionality of the antenna 200.

In an embodiment, a distance between the first radiator 211 and the third radiator 213 may be greater than or equal to two tenths of a first wavelength and less than or equal to one half of the first wavelength. The first wavelength is a vacuum wavelength corresponding to the first frequency band.

Correspondingly, the first radiator 211 may operate in a one-half-wavelength mode. The distance between the first radiator 211 and the third radiator 213 may be greater than or equal to four tenths of a length L1 of the side frame between the first position 201 and the second position 202 and less than or equal to the length L1 of the side frame between the first position 201 and the second position 202.

It should be understood that, when the distance between the first radiator 211 and the third radiator 213 is within the foregoing range, directionality of the antenna 200 is improved well. The distance between the first radiator 211 and the third radiator 213 may be understood as a distance between the center (geometric center) of the first radiator 211 and the center of the third radiator 213.

In an embodiment, the first position 201 and the second position 202 are symmetrical with respect to a virtual axis of the second side 132, and the second side has a same length on two sides of the virtual axis.

It should be understood that, as symmetry of the first radiator 211 increases, a radiation characteristic of the antenna 200 is better.

In an embodiment, the third position 203 may be located on the first side 131.

It should be understood that the third position 203 may be located on the first side 131 or the second side 132, to generate a current that is co-directional with the current on the first radiator 211, which may be determined based on an actual internal layout of the electronic device. This is not limited in embodiments of this disclosure.

In an embodiment, the second radiator 212 is configured to generate a second parasitic resonance. A resonant point frequency of the second parasitic resonance is higher than the resonant point frequency of the second resonance.

It should be understood that the second radiator 212 may be used to improve radiation efficiency and system efficiency of the antenna 200 in the resonant frequency band of the second resonance, so that the antenna 200 has a better radiation characteristic in the first frequency band.

In an embodiment, a frequency difference between a resonant point of the second parasitic resonance and the resonant point of the second resonance is greater than or equal to 200 MHz and less than or equal to 500 MHz.

It should be understood that ends of radiators on two sides of the second position 202 are both open ends, and when the first feed circuit 221 feeds the electrical signal, a coupling between the first radiator 211 and the second radiator 212 is strong. Therefore, there is a specific frequency interval between the resonant point of the second parasitic resonance generated by the second radiator 212 and the resonant point of the second resonance generated by the first radiator 211. When the frequency difference between the resonant point of the second parasitic resonance and the resonant point of the second resonance is greater than or equal to 200 MHz and less than or equal to 500 MHz, radiation efficiency and system efficiency of the antenna 200 in the first frequency band are improved well.

In an embodiment, the first radiator 211 further includes the first connection point 2111 and the second connection point 2112. The first connection point 2111 is located between the first position 201 and the first feed point 231 (including the first position 201 and the first feed point 231, where in the following embodiments, both A and B are included when “being located between A and B” is mentioned). It should be understood that, in embodiments of this disclosure, a feed circuit may be coupled to a feed point via a feed member. When the feed point coincides with a connection point, both a switch and the feed circuit may be coupled to a radiator (the feed point/connection point) via the feed member. The second connection point 2112 is located between the second position 202 and the first feed point 231. The electronic device 10 further includes a first switch 251 and a second switch 252. A common port of the first switch 251 is coupled to the first connection point 2111. A common port of the second switch 252 is coupled to the second connection point 2112.

It should be understood that the first switch 251 and the second switch 252 may be configured to adjust a resonant point frequency of a resonance generated by the first radiator 211. When the first switch 251 and the second switch 252 are in different switch states, the first radiator 211 may be configured to generate different resonances. In an embodiment, when the first switch 251 is in a first switch state, and the second switch 252 is in a second switch state, the first radiator 211 may be configured to generate the first resonance and the second resonance. When the first switch 251 is in a third switch state, and the second switch 252 is in a fourth switch state, the first radiator 211 may be configured to generate a third resonance (in the CM mode) and a fourth resonance (in the DM mode). A resonant point frequency of the third resonance is lower than a resonant point frequency of the fourth resonance, and the resonant point frequency of the third resonance is higher than the resonant point frequency of the first resonance. A resonant point frequency of the fourth resonance is higher than the resonant point frequency of the second resonance. A resonant frequency band of the fourth resonance includes a second frequency band.

It should be understood that a switch status of the switch may be understood as an electrical connection relationship between the common port (a first port, which may be understood as that the switch is coupled to the radiator through the port) of the switch and a connection port. In an embodiment, the first switch state may be that the common port is disconnected from and not electrically connected to the connection port. Alternatively, in an embodiment, the first switch state may be that the common port is short-circuited to and electrically connected to the connection port. In an embodiment, the connection port may be directly grounded, or at least one electronic component may be electrically connected between the connection port and a ground plane. Alternatively, in an embodiment, the switch includes a plurality of common ports. The first switch state may be that at least some of the plurality of common ports are short-circuited to and electrically connected to a plurality of connection ports. All switch statuses in the foregoing embodiment may be accordingly understood. This is not limited in embodiments of this disclosure. The switch status may be adjusted based on actual production or design.

In an embodiment, the first switch 251 or the second switch 252 may be a single pole four throw (SPFT) switch. It should be understood that, in embodiments of this disclosure, the switch may be selected based on actual production or design, or may be a single pole x throw (SPXT) switch. This is not limited in embodiments of this disclosure. All switches in embodiments of this disclosure may be accordingly understood provided that a quantity of connection ports of the switch is greater than or equal to a quantity of electronic components or radio frequency channels that need to be connected.

It should be understood that, when the switch includes the plurality of common ports, the switch in this embodiment of this disclosure may alternatively be an x pole x throw (XPXT) switch, or may be formed by connecting a plurality of single pole single throw (SPST) switches in parallel.

In an embodiment, a length DI of the side frame between the first connection point 2111 and the first position 201 and the length L1 of the side frame between the first position 201 and the second position 202 satisfy: D1≤L1×30%. In an embodiment, D1≤L1×10%. In an embodiment, D1 is less than or equal to 3 mm.

In an embodiment, a length D2 of the side frame between the second connection point 2112 and the second position 202 and the length L1 of the side frame between the first position 201 and the second position 202 satisfy: D2≤L1×30%. In an embodiment, D2≤L1×10%. In an embodiment, D2 is less than or equal to 3 mm.

It should be understood that, when the first connection point 2111 is disposed in an area close to the first position 201, and the second connection point 2112 is disposed in an area close to the second position 202, an electric field in the area is strong, to facilitate adjustment of the resonant point frequency of the resonance generated by the first radiator 211.

In an embodiment, the first frequency band includes at least a part of frequency bands in 1980 MHz to 2010 MHz. The second frequency band includes at least a part of frequency bands in 2170 MHz to 2200 MHz.

It should be understood that the technical solution provided in this embodiment of this disclosure may be applied to a Tiantong satellite system, or may be applied to a BeiDou satellite system. For example, the first frequency band may include at least a part of frequency bands in an L frequency band (1610 MHz to 1626.5 MHz), and the second frequency band may include at least a part of frequency bands in an S frequency band (2483.5 MHz to 2500 MHz). Alternatively, the technical solution may be applied to another satellite communication system. This is not limited in embodiments of this disclosure.

In an embodiment, the third radiator 213 may further include a third connection point 2131. The electronic device 10 further includes a third switch 253. A common port of the third switch 253 is coupled to the third connection point 2131.

It should be understood that the third switch 253 may be configured to adjust a resonant point frequency of a resonance generated by the third radiator 213, so that the resonant point frequency of the resonance generated by the third radiator 213 and the resonant point frequency of the second resonance or the resonant point frequency of the fourth resonance generated by the first radiator 211 may be within the foregoing range, to improve directionality of the antenna 200.

In an embodiment, a length D3 of the side frame between the third connection point 2131 and the third position 203 and a length L2 of the side frame between the first ground point 241 and the third position 203 satisfy: D3≤L2×30%. In an embodiment, D3≤L2×10%. In an embodiment, D3 is less than or equal to 3 mm.

In an embodiment, the second radiator 212 may further include a fourth connection point 2121. The electronic device 10 further includes a fourth switch 254. A common port of the fourth switch 254 is coupled to the fourth connection point 2121.

It should be understood that the fourth switch 254 may be configured to adjust a resonant point frequency of a resonance generated by the second radiator 212, so that the resonant point frequency of the resonance generated by the second radiator 212 and the resonant point frequency of the second resonance or the resonant point frequency of the fourth resonance generated by the first radiator 211 may be within the foregoing range, to improve radiation efficiency and system efficiency of the antenna 200 in the first frequency band.

In an embodiment, a length D4 of the side frame between the third connection point 2131 and the second position 202 and a length L3 of the side frame between the first ground point 241 and the second position 202 satisfy: D4≤L3×30%. In an embodiment, D4≤L3×10%. In an embodiment, D4 is less than or equal to 3 mm.

In an embodiment, satellite communication and cellular communication are not performed at the same time. When the electronic device 10 performs satellite communication, the third radiator 213 may be configured to improve directionality of the antenna 200, and the second radiator 212 may be configured to improve system efficiency and radiation efficiency of the antenna 200. When the electronic device 10 does not perform satellite communication, the first radiator 211, the second radiator 212, or the third radiator 213 may be reused as a radiator of the antenna for cellular communication.

In an embodiment, the second radiator 212 may further include a second feed point 232, as shown in FIG. 10. The electronic device 10 may further include a second feed circuit 222. The second feed circuit 222 is coupled to the second feed point 232. In an embodiment, the second feed point 232 is located between the fourth connection point 2121 and the first ground point 241.

In an embodiment, the second feed point 232 coincides with the fourth connection point 2121. Coinciding may be understood as that the second feed circuit 222 and the fourth switch 254 are coupled to the second radiator 212 via a same connection component. In an embodiment, the third radiator 213 may further include a third feed point 233. The electronic device 10 may further include a third feed circuit 223. The third feed circuit 223 is coupled to the third feed point 233. In an embodiment, the third feed point 233 is located between the third connection point 2131 and the first ground point 241.

It should be understood that the first radiator 211 and the first feed circuit 221 may form a first antenna element. The second radiator 212 and the second feed circuit 222 may form a second antenna element, and the second radiator 212 may operate in a quarter-wavelength mode. The third radiator 213 and the third feed circuit 223 form a third antenna element, and the third radiator 213 may operate in the quarter-wavelength mode.

In an embodiment, the third feed point 233 coincides with the third connection point 2131.

In an embodiment, an operating frequency band of the second antenna element may include 2.4 GHz in Wi-Fi and/or at least a part of frequency bands in sub 6G, for example, a frequency band n77. In an embodiment, an operating frequency band of the third antenna element may include at least a part of frequency bands in a middle band (middle band, MB) (1710 MHz to 2170 MHz) and/or at least a part of frequency bands in a high band (high band, HB) (2300 MHz to 2690 MHz), for example, B1 (1920 MHz to 1980 MHz), B3 (1710 MHz to 1785 MHz), and B7 (2500 MHz to 2570 MHz) in LTE.

It should be understood that the third switch 253 may be further configured to determine a resonant point frequency of a resonance generated by the third antenna element, so that the third antenna element can operate in different communication frequency bands. For example, the third switch 253 may be in different switch states, so that different electronic components are electrically connected between the third connection point 2131 and the ground plane. The fourth switch 254 may be further configured to determine a resonant point frequency of a resonance generated by the second antenna element, so that the second antenna element can operate in different communication frequency bands. For example, the fourth switch 254 may be in different switch states, so that different electronic components are electrically connected between the fourth connection point 2121 and the ground plane.

In an embodiment, the antenna 200 may further include a fourth radiator 214. The side frame 11 may further include a second ground point 242. The first position 201 is located between the second ground point 242 and the first feed point 231. The side frame 11 is grounded at the second ground point 242. The fourth radiator 214 includes at least a part of the side frame between the first position 201 and the second ground point 242.

It should be understood that the fourth radiator 214 and the fourth feed circuit 224 may form a fourth antenna element, and the fourth radiator 214 may operate in the quarter-wavelength mode, and may be configured to extend a communication frequency band of the electronic device 10. In an embodiment, an operating frequency band of the fourth antenna element may include at least a part of frequency bands in the middle band (1710 MHz to 2170 MHz), and/or at least a part of frequency bands in a high band (2300 MHz to 2690 MHz), and/or at least a part of frequency bands in sub 6G, for example, the frequency band n77.

In an embodiment, the fourth radiator 213 may further include a fifth connection point 2131. The electronic device 10 further includes a fifth switch 255. A common port of the fifth switch 255 is coupled to the fifth connection point 2131.

It should be understood that the fifth switch 255 may be configured to adjust a resonant point frequency of a resonance generated by the fourth radiator 214, so that the fourth antenna element can operate in different communication frequency bands. For example, the fifth switch 255 may be in different switch states, so that different electronic components are electrically connected between the fifth connection point 2141 and the ground plane.

In addition, when the electronic device 10 performs satellite communication, the fourth antenna element does not operate. The fifth switch 255 may be in a fifth switch state. For example, a common port of the fifth switch 255 is electrically connected to a connection port, and the connection port is electrically connected to the ground plane directly or electrically connected to the ground plane via a 0-ohm resistor. The fourth radiator 214 is grounded at the fifth connection point 2141, to prevent interference of the fourth radiator 214 to satellite communication.

In an embodiment, the side frame 11 may further include a third ground point 243. The third ground point 243 is located between the first position 201 and the first feed point 231. The side frame 11 is grounded at the third ground point 243. Refer to an embodiment shown in FIG. 9B.

FIG. 9B is a diagram of an electronic device 10 according to an embodiment of this disclosure.

As shown in FIG. 9B, the electronic device 10 may include the conductive side frame 11, the antenna 200, and the first feed circuit 221.

The side frame 11 further includes the third position 203 and the second ground point 242. The second position 202 is located between the first position 204 and the third position 203. The second ground point 242 is located between the second position 202 and the third position 203.

The antenna 200 includes the second radiator 212 and the third radiator 213. The second radiator 212 is a conductive part of the side frame between the second position 202 and the second ground point 242. The third radiator 213 is a conductive part of the side frame between the second ground point 242 and the third position 203.

A third slot is provided on the side frame 11. The side frame 11 is coupled to the ground plane 300 at the second ground point 242.

A first end (an end close to the second position 202) of the second radiator 212 is an open end, and a second end (an end close to the second ground point 242) of the second radiator 212 is a ground end. A first end (an end close to the second ground point 242) of the third radiator 213 is a ground end, and a second end (an end close to the third position 203) of the third radiator 213 is an open end.

The third radiator 213 is configured to generate a first parasitic resonance. A resonant point frequency of the first parasitic resonance is lower than a resonant point frequency of a first main resonance.

When the first radiator 211 generates the first main resonance in a DM mode, the third radiator 213 may be excited to generate the first parasitic resonance. In an embodiment, when the first feed circuit 221 feeds an electrical signal, at a resonant point of the first main resonance, a current on the first radiator 211 and a current on the third radiator 213 are co-directional. In this way, a path of the current generated by the first radiator 211 can be extended, an effect of a similar current array can be obtained, and directionality of the antenna 200 can be improved. The third radiator 213 can be used to improve directionality of the antenna 200, and energy radiated by the antenna 200 toward the top of the electronic device 10 (for example, in a y direction) increases. In this way, when using the electronic device 10 to perform satellite navigation or communication in a first frequency band, a user does not need to change a posture of holding the electronic device 10, to obtain good user experience.

In an embodiment, the third radiator 213 may further include the third connection point 2131. The electronic device 10 further includes a third tuning circuit 253. The third tuning circuit 253 is coupled to the third connection point 2131.

It should be understood that the third tuning circuit 253 may be configured to adjust a resonant point frequency of a resonance generated by the third radiator 213, so that the third radiator 213 generates the first parasitic resonance and a second parasitic resonance. In this way, the path of the current generated by the first radiator 211 is extended in the first frequency band and a second frequency band, the effect of the similar current array can be obtained, and directionality of the antenna 200 can be improved.

In an embodiment, a length L2 of the side frame between the second position 202 and the third position 203 and a length L1 of the side frame between the first position 201 and the second position 202 satisfy: L1×80%≤L2≤L1.

In an embodiment, a frequency difference between the resonant point of the first main resonance and a resonant point of the first parasitic resonance is less than or equal to 200 MHz. In an embodiment, a frequency difference between a resonant point of a fourth resonance and a resonant point of the second parasitic resonance is less than or equal to 200 MHz.

It should be understood that, when the frequency difference between the resonant point of the first main resonance (or a second main resonance) and the resonant point of the first parasitic resonance (or the second parasitic resonance) is less than or equal to 200 MHz, the first feed circuit 221 feeds the electrical signal, and at the resonant point of the first main resonance (or the second main resonance), a proportion of currents that are generated by the third radiator 213 and that are co-directional with the current on the first radiator 211 is larger, to further improve directionality of the antenna 200.

In an embodiment, a length D3 of the side frame between the third connection point 2131 and the third position 203 and a length H1 of the side frame between the second ground point 242 and the third position 203 satisfy: D3≤H1×30%. In an embodiment, D3<H1×10%. In an embodiment, D3 is less than or equal to 3 mm.

In an embodiment, a distance between the first radiator 211 and the third radiator 213 may be greater than or equal to two tenths of a first wavelength and less than or equal to one half of the first wavelength. The first wavelength is a vacuum wavelength corresponding to the first frequency band. It should be understood that, because there is a specific correspondence between the vacuum wavelength and a medium wavelength (a conduction wavelength), calculation may be performed based on an equivalent dielectric constant of a medium disposed around the radiator. This may be accordingly understood in embodiments of this disclosure.

Correspondingly, the first radiator 211 may operate in a one-half-wavelength mode (corresponding to the DM mode). The distance between the first radiator 211 and the third radiator 213 may be greater than or equal to four tenths of the length L1 of the conductive part of the side frame between the first position 201 and the second position 202 and less than or equal to the length L1 of the conductive part of the side frame between the first position 201 and the second position 202.

It should be understood that, when the distance between the first radiator 211 and the third radiator 213 is within the foregoing range, directionality of the antenna 200 is improved well. The distance between the first radiator 211 and the third radiator 213 may be understood as a distance between the center (geometric center) of the first radiator 211 and the center of the third radiator 213.

In an embodiment, the third position 203 may be located on the first side 131.

It should be understood that the third position 203 may be located on the first side 131 or the second side 132, to generate a current that is co-directional with the current on the first radiator 211, which may be determined based on an actual internal layout of the electronic device. This is not limited in embodiments of this disclosure.

In an embodiment, the second radiator 212 is configured to generate a third parasitic resonance. A resonant point frequency of the third parasitic resonance is higher than the resonant point frequency of the first main resonance.

It should be understood that the second radiator 212 may be used to improve radiation efficiency and system efficiency of the antenna 200 in a resonant frequency band of the first main resonance, so that the antenna 200 has a better radiation characteristic in the first frequency band.

In an embodiment, the second radiator 212 may further include a fourth connection point 2121. The electronic device 10 further includes a fourth tuning circuit 254. The fourth tuning circuit 254 is coupled to the fourth connection point 2121.

It should be understood that the fourth tuning circuit 254 may be configured to adjust a resonant point frequency of a resonance generated by the second radiator 212, so that the second radiator 212 generates the third parasitic resonance and a fourth parasitic resonance, to improve radiation efficiency and system efficiency of the antenna 200 in the first frequency band and the second frequency band.

In an embodiment, a frequency difference between a resonant point of the third parasitic resonance and the resonant point of the first main resonance is greater than or equal to 200 MHz and less than or equal to 500 MHz. In an embodiment, a frequency difference between the resonant point of the fourth parasitic resonance and a resonant point of a second main resonance is greater than or equal to 200 MHz and less than or equal to 500 MHz.

It should be understood that ends of radiators on two sides of the second position 202 are both open ends, and when the first feed circuit 221 feeds the electrical signal, a coupling between the first radiator 211 and the second radiator 212 is strong. Therefore, there is a specific frequency interval between the resonant point of the parasitic resonance generated by the second radiator 212 and the resonant point of the resonance generated by the first radiator 211. When the frequency difference between the resonant point of the third parasitic resonance (the fourth parasitic resonance) and the resonant point of the first main resonance (the second main resonance) is greater than or equal to 200 MHz and less than or equal to 500 MHz, radiation efficiency and system efficiency of the antenna 200 in the first frequency band (the second frequency band) are improved well.

In an embodiment, a length D4 of the side frame between the third connection point 2131 and the second position 202 and a length H2 of the side frame between the second ground point 242 and the second position 202 satisfy: D4≤H2×30%. In an embodiment, D4≤H2×10%. In an embodiment, D4 is less than or equal to 3 mm.

In an embodiment, satellite communication and cellular communication are not performed at the same time. When the electronic device 10 performs satellite communication, the third radiator 213 may be configured to improve directionality of the antenna 200, and the second radiator 212 may be configured to improve system efficiency and radiation efficiency of the antenna 200. When the electronic device 10 does not perform satellite communication, the first radiator 211, the second radiator 212, or the third radiator 213 may be reused as a radiator of the antenna for cellular communication.

In an embodiment, the second radiator 212 may further include the second feed point 232, as shown in FIG. 10. The electronic device 10 may further include the second feed circuit 222. The second feed circuit 222 is coupled to the second feed point 232. In an embodiment, the second feed point 232 is located between the fourth connection point 2121 and the second ground point 242.

In an embodiment, a length R2 of the second radiator 212 (a length of the side frame between the second position 202 and the second ground point 242) and the length L1 of the side frame (the first radiator 211) between a first position 201 and the second position 202 satisfy: L1×35%≤R2≤L1×60%. In an embodiment, the second feed point 232 coincides with the fourth connection point 2121. Coinciding may be understood as that the second feed circuit 222 and the fourth tuning circuit 254 are coupled to the second radiator 212 via a same connection component.

In an embodiment, the third radiator 213 may further include the third feed point 233. The electronic device 10 may further include the third feed circuit 223. The third feed circuit 223 is coupled to the third feed point 233. In an embodiment, the third feed point 233 is located between the third connection point 2131 and the second ground point 242.

In an embodiment, a length R3 of the third radiator 213 (the length of the side frame between the third position 203 and the second ground point 242) and the length L1 of the side frame (the first radiator 211) between a first position 201 and the second position 202 satisfy: L1×30%≤R3≤L1×55%.

It should be understood that the first radiator 211 and the first feed circuit 221 may form a first antenna. The second radiator 212 and the second feed circuit 222 may form a second antenna. The first end (the end close to the second position 202) of the second radiator 212 is an open end, and the second end (the end close to the second ground point 242) of the second radiator 212 is a ground end. Therefore, the second antenna may operate in a quarter-wavelength mode (in the quarter-wavelength mode, currents and electric fields are co-directional on the radiator, a high current point is located near the ground end, and a strong electric field point is located near the open end). The third radiator 213 and the third feed circuit 223 form a third antenna. The first end (the end close to the second ground point 242) of the third radiator 213 is a ground end, and the second end (the end close to the third position 203) of the third radiator 213 is an open end. Therefore, the third antenna may operate in the quarter-wavelength mode.

In an embodiment, the third feed point 233 coincides with the third connection point 2131.

In an embodiment, an operating frequency band of the second antenna may include 2.4 GHz in Wi-Fi and/or at least a part of frequency bands in sub 6G, for example, a frequency band n77. In an embodiment, an operating frequency band of the third antenna may include at least a part of frequency bands in a middle band (MB) (1710 MHz to 2170 MHz) and/or at least a part of frequency bands in a high band (HB) (2300 MHz to 2690 MHz), for example, B1 (1920 MHz to 1980 MHz), B3 (1710 MHz to 1785 MHz), and B7 (2500 MHz to 2570 MHz) in LTE.

It should be understood that the third tuning circuit 253 may be further configured to determine a resonant point frequency of a resonance generated by the third antenna, so that the third antenna can operate in different communication frequency bands. For example, the third tuning circuit 253 may be in different circuit states, so that different electronic components are electrically connected between the third connection point 2131 and the ground plane. The fourth tuning circuit 254 may be further configured to determine a resonant point frequency of a resonance generated by the second antenna, so that the second antenna can operate in different communication frequency bands. For example, the fourth tuning circuit 254 may be in different circuit states, so that different electronic components are electrically connected between the fourth connection point 2121 and the ground plane.

In addition, when the electronic device performs satellite communication or does not perform satellite communication, both the second radiator 212 and the third radiator 213 generate the resonances. When the electronic device 10 performs satellite communication, the second antenna and the third antenna do not operate as main feed antennas (for example, the antenna is disconnected from a corresponding feed source, or a corresponding feed source of the antenna is turned off). The second radiator 212 and the third radiator 213 generate the parasitic resonances in a manner of indirect couplings to the first radiator 211. This improves a radiation characteristic of the antenna 200 (for example, the frequency difference between the resonant point of the parasitic resonance and the resonant point of the main resonance is within the foregoing range). When the electronic device 10 does not perform satellite communication, the second antenna and the third antenna may operate as main feed antennas. The second radiator 212 and the third radiator 213 may generate resonances by using separately fed electrical signals. The resonant point frequency of the resonance is different from the resonant point frequency of the parasitic resonance.

In embodiments of this disclosure, that the electronic device 10 does not perform satellite communication may be understood as that the antenna 200 is disconnected from a corresponding feed source (for example, a satellite communication chip or module), or a corresponding feed source (for example, a satellite communication chip or module) of the antenna 200 is turned off. It should be understood that, when the electronic device 10 does not perform satellite communication, the electronic device may perform cellular communication, data communication transmission using Wi-Fi, or the like.

In an embodiment, the antenna 200 may further include a fourth radiator 214. The side frame 11 may further include a third ground point 243. The first position 201 is located between the third ground point 243 and the first ground point 241. The side frame 11 is coupled to the ground plane 300 at the third ground point 243. The fourth radiator 214 is a conductive part of the side frame between the first position 201 and the third ground point 243.

In an embodiment, a length R4 of the fourth radiator 214 (a length of the side frame between the first position 201 and the third ground point 243) and the length L1 of the side frame (the first radiator 211) between the first position 201 and the second position 202 satisfy: L1×40%≤R4≤L1×85%.

It should be understood that the fourth radiator 214 and the fourth feed circuit 224 may form a fourth antenna, may operate in the quarter-wavelength mode, and may be configured to extend a communication frequency band of the electronic device 10. In an embodiment, an operating frequency band of the fourth antenna may include at least a part of frequency bands in the middle band (1710 MHz to 2170 MHz), and/or at least a part of frequency bands in the high band (2300 MHz to 2690 MHz), and/or at least a part of frequency bands in sub 6G, for example, a frequency band n77.

In an embodiment, the fourth radiator 214 may further include the fifth connection point 2141. The electronic device 10 further includes a fifth tuning circuit 255. The fifth tuning circuit 255 is coupled to the fifth connection point 2141.

It should be understood that the fifth tuning circuit 255 may be configured to adjust a resonant point frequency of a resonance generated by the fourth radiator 214, so that the fourth antenna can operate in different communication frequency bands. For example, the fifth tuning circuit 255 may be in different tuning circuit states, so that different electronic components are electrically connected between the fifth connection point 2141 and the ground plane.

In addition, when the electronic device 10 performs satellite communication, the fourth antenna does not operate. The fifth tuning circuit 255 may be in different circuit states. For example, the fifth tuning circuit 255 is electrically connected to the ground plane directly or electrically connected to the ground plane via a 0-ohm resistor. The fourth radiator 214 is directly coupled to the ground plane 300 at the fifth connection point 2141, to prevent interference of the fourth radiator 214 to satellite communication.

When the electronic device performs satellite communication, the fourth antenna does not operate as a main feed antenna, and the fourth radiator 214 may not generate an operating resonance, or generate a parasitic operating resonance in an indirect coupling manner. When the electronic device 10 does not perform satellite communication, the fourth antenna may operate as a main feed antenna, and the fourth radiator 214 may generate a resonance by using a fed electrical signal.

In an embodiment, the side frame 11 may further include the third ground point 243. The third ground point 243 is located between the first position 201 and a first feed point 231. The side frame 11 is grounded at the third ground point 243.

It should be understood that the third ground point 243 may be configured to improve isolation between the second antenna and the fourth antenna. In addition, when the fourth antenna operates, the fourth radiator 214 is used as a main radiation stub (including a fourth feed point 234), and the side frame between a fourth ground point 244 and the first position 201 may be used as a parasitic stub of the fourth antenna, and is configured to improve a radiation characteristic of the fourth antenna. The first tuning circuit 251 may be in different circuit states, and different electronic components are electrically connected between the first connection point and the ground plane, so that the parasitic stub can generate resonances of different frequencies.

Correspondingly, the side frame between the second position 202 and the first ground point 241 is used as a main radiation stub of the first antenna, and the first antenna may operate in the quarter-wavelength mode. A second tuning circuit 252 may be further configured to determine a resonant point frequency of a resonance generated by the first antenna, so that the first antenna can operate in different communication frequency bands. For example, the second tuning circuit 252 may be in different tuning circuit states, so that different electronic components are electrically connected between the second connection point and the ground plane.

In an embodiment, an operating frequency band of the first antenna may include an L1 frequency band in a GPS and/or at least a part of frequency bands in sub 6G, for example, a frequency band n79.

In an embodiment, the L1 frequency band in the GPS may include 1575.42 MHz±1.023 MHz. In an embodiment, the sub 6G may include the frequency band n77 and the frequency band n79. The frequency band n77 may include 3300 MHz to 4200 MHz. The frequency band n79 may include 4400 MHz to 5000 MHz.

It should be understood that, when the first antenna operates in the L1 frequency band in the GPS, because the L1 frequency band in the GPS and a satellite communication frequency band are incompatible with each other (cannot be shared and match), the electronic device 10 may further include a switch coupled between the first feed point 231 and the ground plane. When the electronic device 10 performs satellite communication, the first antenna does not operate, and the switch is turned off (or an equivalent circuit between the first feed point 231 and the ground plane is an open circuit. For example, equivalent inductance between the first feed point 231 and the ground plane is greater than 20 nH). When the first antenna operates in the L1 frequency band in the GPS, the switch is turned on, and an electronic component may be electrically connected between the second tuning circuit and the ground plane to match the L1 frequency band.

In addition, when the electronic device performs satellite communication or does not perform satellite communication, the first radiator 211 generates the resonance. When the electronic device 10 performs satellite communication, the first antenna does not operate as a main feed antenna. An entire stub (the side frame between the first position 201 and the second position 202) of the first radiator 211 generates the first main resonance and the second main resonance. When the electronic device 10 does not perform satellite communication, the first antenna may operate as a main feed antenna. A part of a stub (the side frame between the second position 202 and the first ground point 241) of the first radiator 211 generates a resonance. A resonant point frequency of the resonance is different from the resonant point frequency of the first main resonance or the resonant point frequency of the second main resonance. For example, when the electronic device 10 does not perform satellite communication, the first antenna may operate as a GPS antenna, so that the electronic device can perform GPS positioning.

In an embodiment, at least one of the L1 frequency band and an L5 frequency band in the GPS may be supported through any one of the foregoing second antenna, third antenna, and fourth antenna, and the following fifth antenna and sixth antenna. For example, a signal of the at least one of the L1 frequency band and the L5 frequency band in the GPS may pass through the second feed circuit 222 and be radiated by the second radiator 212, or may pass through the third feed circuit 223 and be radiated by the third radiator 213. It should be understood that, because the L1 frequency band in the GPS includes 1575.42 MHz±1.023 MHz, and the L5 frequency band in the GPS includes 1176.45 MHz, there is a frequency difference between the satellite communication frequency band in embodiments of this disclosure and each of the L1 frequency band and the L5 frequency band, the electronic device in this application may also perform satellite communication and GPS satellite navigation at the same time.

In an embodiment, grounding may be implemented at the first ground point 241 via a first ground member. A width of a connection between the first ground member and the side frame is greater than or equal to 2 mm and less than or equal to 8 mm, so that there is better isolation between the second antenna and the fourth antenna.

It should be understood that a ground point and/or a connection point may be implemented via a metal dome or a connection rib structure in a middle plate of a middle frame. When a metal component like the metal dome is used, a distance between the ground point and/or the connection point and another point or end on a radiator may be understood as a distance calculated from the center of the metal dome. When the connection rib structure between the ground point and/or the connection point and the middle plate of the middle frame is used, a distance between the ground point and/or the connection point and another point or end on a radiator may be understood as a distance calculated from an edge of an end of the connection rib structure.

In an embodiment, the electronic device includes the middle frame, and the middle frame includes the side frame 11 and the middle plate. In an embodiment, the middle plate is electrically connected to the ground plane 300 at a plurality of positions. In an embodiment, the middle plate may be considered as a part of the ground plane 300. In an embodiment, the side frame 11 is electrically connected to the middle plate via a connection rib structure (for example, the first ground member, which is not shown in the figure). The connection rib structure (for example, the first ground member, which is not shown in the figure) is connected between the side frame and the middle plate, and is integrated with the side frame and the middle plate. For brevity of description, all ground members described in embodiments of this disclosure may be accordingly understood.

In an embodiment, a length by which the first ground member extends between the side frame and the ground plane is less than or equal to 6 mm.

In an embodiment, an electronic component is coupled between the first ground member and the ground plane. An equivalent capacitance value of the electronic component is greater than or equal to 3 pF.

It should be understood that, when the electronic device 10 operates in the satellite frequency band, the electronic component is in a disconnected state in at least a part of frequency bands in a satellite system (at least a part of frequency bands in a Tiantong satellite system and/or at least a part of frequency bands in a BeiDou satellite system), so that the first ground member and the ground plane can be approximately in an open-circuit state. The “open-circuit state” in this application is a current state between the first ground member and the ground plane. For example, in the “open-circuit state”, currents distributed on the first radiator 211 and the ground plane are basically not coupled/flowed via the first ground member and the electronic component. It should be understood that “the currents are basically not coupled/flowed” cannot be absolutely understood. In embodiments of this disclosure, when the electronic device 10 operates in the satellite frequency band, the first radiator 211 may generate a wire DM mode by disposing the electronic component. In this case, it may be considered that the electronic component is in the disconnected state in at least the part of frequency bands in the satellite system, and the currents are basically not coupled/flowed via the first ground element and the electronic component. In an embodiment, radiation efficiency and system efficiency of a resonance generated by the antenna 200 in the wire DM mode are high.

When the electronic device 10 does not operate in the satellite frequency band, the electronic component is in a connected state in the operating frequency band of the second antenna and/or the operating frequency band of the fourth antenna, so that the first ground member and the ground plane may be approximately in a short-circuit state. The “short-circuit state” in this application is a current state between the first ground member and the ground plane. For example, in the “short-circuit state”, currents distributed on the first radiator 211 and the ground plane are generally coupled/flowed via the first ground member and the electronic component. In an embodiment, the first radiator 211 is coupled to the ground plane via the first ground member and the electronic component, so that there is better isolation between the second antenna and the fourth antenna. It should be understood that open ends of the second antenna and the fourth antenna are respectively located on two sides of the first ground member, and good isolation is implemented between the second antenna and the fourth antenna by using a current short-circuit state at the first ground member.

The electronic component may be further configured to adjust an electrical length of the radiator. In an embodiment, the electronic component may be configured to adjust an electrical length of a conductive part between the first position 201 and the first ground point 241 or an electrical length of a conductive part between the second position 202 and the first ground point 241.

For brevity of description, structures of all ground members in embodiments of this disclosure may be accordingly understood. For brevity of description, details are not described again.

In an embodiment, a series-connected electronic component switch is coupled between the first ground member and the ground plane. The switch may be configured to control an electrical connection status between the first ground member and the ground plane.

It should be understood that, when the electronic device 10 operates in the satellite frequency band, the switch is in an open state, so that the first ground member can be disconnected from the ground plane, the first radiator 211 is not coupled to the ground plane, the first radiator 211 generates only the wire DM mode, and radiation efficiency and system efficiency of the resonance generated by the antenna 200 in the wire DM mode are high. When the electronic device 10 does not operate in the satellite frequency band, the switch is in an on state, so that the first ground member can be short-circuited to the ground plane, the first radiator 211 is coupled to the ground plane, and there can be better isolation between the second antenna and the fourth antenna.

In an embodiment, the first ground member may include a first dome and a second dome. An electronic component is coupled between the ground plane and each of the first dome and the second dome. An equivalent capacitance value of each electronic component is greater than or equal to 3 pF.

In an embodiment, when the first ground member is connected to the ground plane via the electronic component, a width of the first ground member may be greater than or equal to 1.5 mm and less than or equal to 12 mm. In an embodiment, the width of the first ground member may be greater than or equal to 2 mm and less than or equal to 8 mm.

It should be understood that, when the first ground member is coupled to the ground plane via the electronic component, the width of the first ground member may be understood as a distance (a length of the side frame) between a midpoint of an end that is of the first dome and that is coupled to the first radiator 211 and a midpoint of an end that is of the second dome and that is coupled to the first radiator 211. For brevity of description, in this embodiment of this disclosure, an example in which the first ground member includes two domes is merely used for description. In actual production or design, a plurality of domes may be further included (an electronic component is coupled between the ground plane and each of the plurality of domes). The first dome and the second dome may be understood as two domes that are farthest from each other in the plurality of domes.

In an embodiment, when the first ground member is coupled to the ground plane via the electronic component, the electronic device 10 may further include a SAR sensor (sensor). The SAR sensor may be electrically connected between the electronic component and the ground plane, and the first radiator 211 is used as an inductor of the SAR sensor. The SAR sensor is configured to determine a distance between a human body and the electronic device 10 (the first radiator 211).

In an embodiment, when the SAR sensor is electrically connected between the electronic component and the ground plane, equivalent capacitance values of all electronic components electrically connected to the first radiator 211 are less than or equal to 120 pF, so that the SAR sensor has a good working state.

In an embodiment, when the electronic component is coupled between the first ground member and the ground plane, based on a center frequency of an operating frequency band of the antenna 200, a frequency difference between a resonant point of a second resonance and a resonant point of a first resonance and/or a frequency difference between the resonant point of the fourth resonance and a resonant point of a third resonance may be determined.

In an embodiment, the center frequency of the operating frequency band of the antenna 200 is greater than or equal to 1 GHz and less than 2.5 GHz. For example, the operating frequency band includes at least a part of frequency bands in the Tiantong satellite system and at least a part of frequency bands in the BeiDou satellite system. The frequency difference between the resonant point of the second resonance and the resonant point of the first resonance is less than or equal to 500 MHz, and/or the frequency difference between the resonant point of the fourth resonance and the resonant point of the third resonance is less than or equal to 500 MHz. The frequency difference between the resonant point of the second resonance and the resonant point of the first resonance is greater than or equal to 50 MHz, and/or the frequency difference between the resonant point of the fourth resonance and the resonant point of the third resonance is greater than or equal to 50 MHz.

In an embodiment, the center frequency of the operating frequency band of the antenna 200 is greater than or equal to 2.5 GHz and less than or equal to 5 GHz. For example, the operating frequency band includes at least a part of frequency bands in another system. The frequency difference between the resonant point of the second resonance and the resonant point of the first resonance is less than or equal to 1200 MHz, and/or the frequency difference between the resonant point of the fourth resonance and the resonant point of the third resonance is less than or equal to 1200 MHz. The frequency difference between the resonant point of the second resonance and the resonant point of the first resonance is greater than or equal to 100 MHz, and/or the frequency difference between the resonant point of the fourth resonance and the resonant point of the third resonance is greater than or equal to 100 MHz. In an embodiment, grounding may be implemented at the second ground point 242 via a second ground member. A width of a connection between the second ground member and the side frame is greater than or equal to 2 mm and less than or equal to 12 mm.

It should be understood that a ground structure is disposed at the second ground point 242, and may be configured to improve isolation between the second antenna and the third antenna.

In an embodiment, when the first feed point 231 is located between the second end (the second position 202) and the first ground point 241, a part of the first radiator 211 between the first end (the first position 201) and the first ground point 241 may also be used as a radiator. The radiator may be coupled to a feed circuit and used as another antenna. The antenna may be configured to add a communication frequency band of the electronic device.

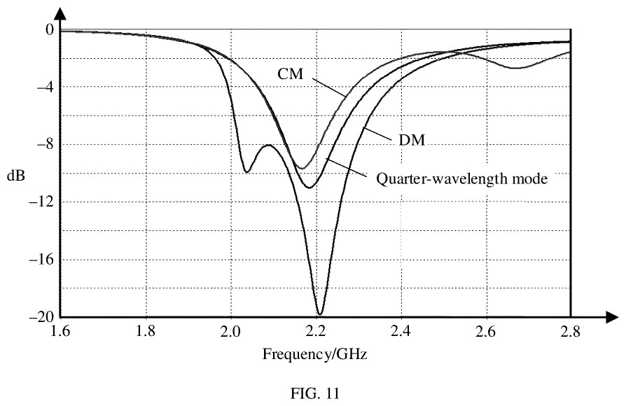

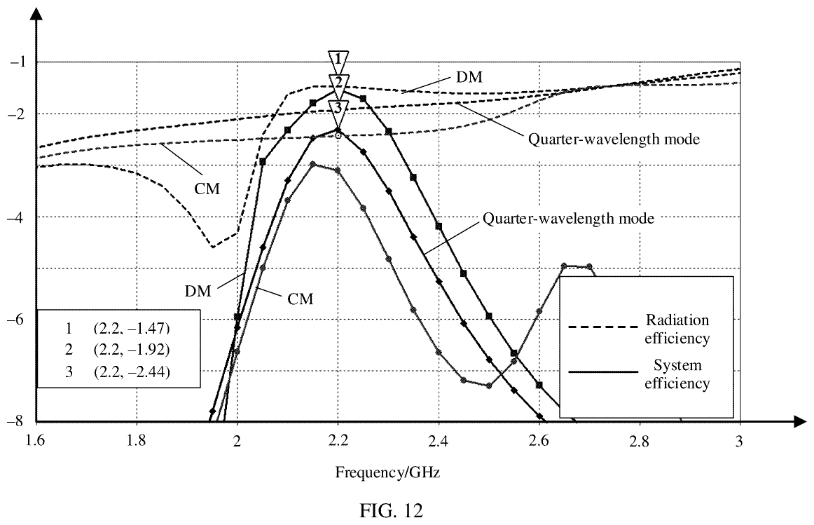

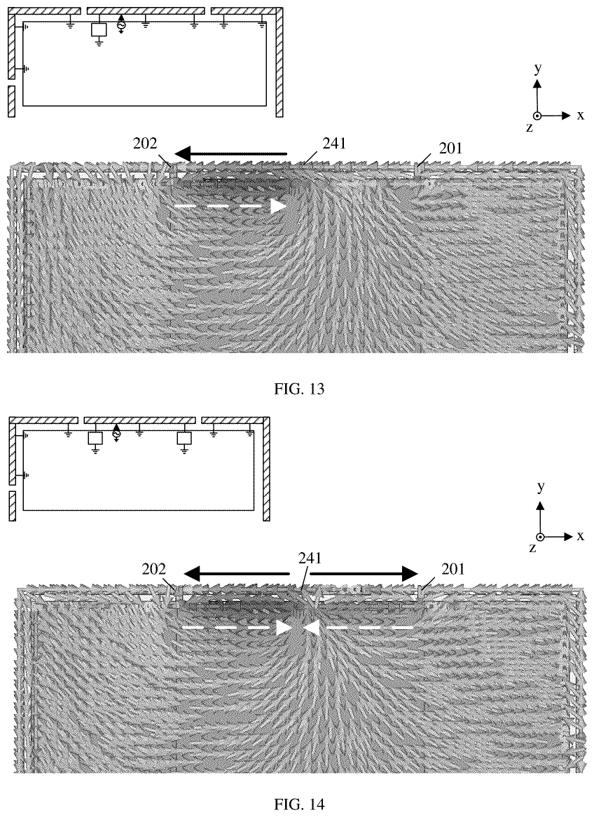

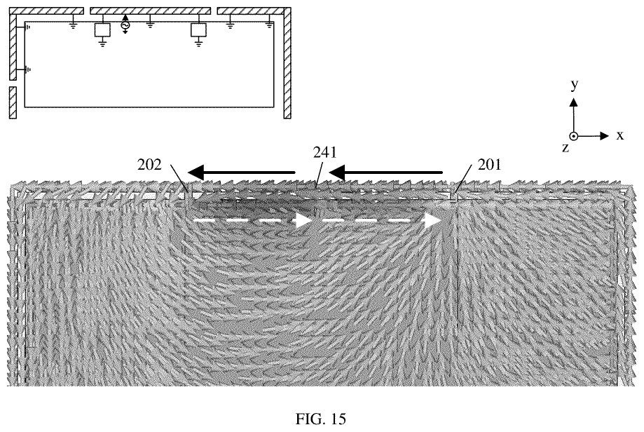

FIG. 11 to FIG. 15 show simulation results of the antenna 200 shown in FIG. 10. FIG. 11 shows a simulation result of an S-parameter of the antenna 200 shown in FIG. 10. FIG. 12 shows simulation results of system efficiency and radiation efficiency of the antenna 200 shown in FIG. 10. FIG. 13 is a diagram of current distribution corresponding to the quarter-wavelength mode when the antenna 200 shown in FIG. 10 operates at 2.2 GHz. FIG. 14 is a diagram of current distribution corresponding to the CM mode when the antenna 200 shown in FIG. 10 operates at 2.2 GHz. FIG. 15 is a diagram of current distribution corresponding to the DM mode when the antenna 200 shown in FIG. 10 operates at 2.2 GHz.

It should be understood that FIG. 11 to FIG. 15 show simulation results of the first radiator in different operating modes. The third connection point, the fourth connection point, and the fifth connection point are grounded (the third connection point, the fourth connection point, and the fifth connection point are electrically connected to the ground plane directly through the third tuning circuit, the fourth tuning circuit, and the fifth tuning circuit or are electrically connected to the ground plane via 0-ohm resistors), to prevent the second radiator, the third radiator, and the fourth radiator from affecting the first radiator. Correspondingly, the first tuning circuit and the second tuning circuit are in different circuit states (for example, are electrically connected to different electronic components), so that the first radiator operates in different operating modes at 2.2 GHz.

For brevity of description, in this embodiment of this disclosure, an example in which the first radiator forms a structure similar to a left-hand antenna (a length of the side frame between the first feed point and the second position is less than one half of a length of the side frame (the conductive part) between the second position and the first ground point) and operates in a quarter-wavelength mode of the left-hand antenna is merely used for description. The left-hand antenna may be, for example, an antenna that complies with a composite right and left hand (CRLH) transmission line structure.

When the first radiator operates in the quarter-wavelength mode, the first connection point is grounded (the first connection point is electrically connected to the ground plane directly through the first tuning circuit or electrically connected to the ground plane via the 0-ohm resistor), and the side frame between the first ground point and the first position is used as a ground stub, and does not participate in radiation. The first tuning circuit and the second tuning circuit are in different circuit states (for example, different electronic components are electrically connected between a connection point and the ground plane), so that the first radiator corresponds to the CM mode and the DM mode at 2.2 GHz when operating in the CM mode or the DM mode.

As shown in FIG. 11, the first radiator may generate a resonance at 2.2 GHz in each of the quarter-wavelength mode, the CM mode, and the DM mode.

As shown in FIG. 12, system efficiency and radiation efficiency in the DM mode are approximately 0.5 dB greater than system efficiency and radiation efficiency in the quarter-wavelength mode. System efficiency and radiation efficiency in the quarter-wavelength mode are approximately 0.5 dB greater than system efficiency and radiation efficiency in the CM mode.

As shown in FIG. 13, the side frame between the second position and the first ground point may correspond to the quarter-wavelength mode.

As shown in FIG. 14, when the first radiator generates the resonance, currents on the radiator in the CM mode may excite a transverse mode on the ground plane, but currents generated in the transverse mode cancel. As a result, system efficiency and radiation efficiency in the CM mode are lower.

As shown in FIG. 15, when the first radiator generates the resonance, the side frame between the first position and the second position mainly performs radiation. In addition, a transverse mode on the ground plane may be excited, and currents generated in the transverse mode are co-directional and do not cancel. Therefore, system efficiency and radiation efficiency in the DM mode are higher.

When the first side frame is located in the center of the second side, the transverse mode may be excited (a proportion of the transverse mode exceeds that of a longitudinal mode), but the currents corresponding to the transverse mode cancel. As a result, system efficiency and radiation efficiency in the CM mode are lower.

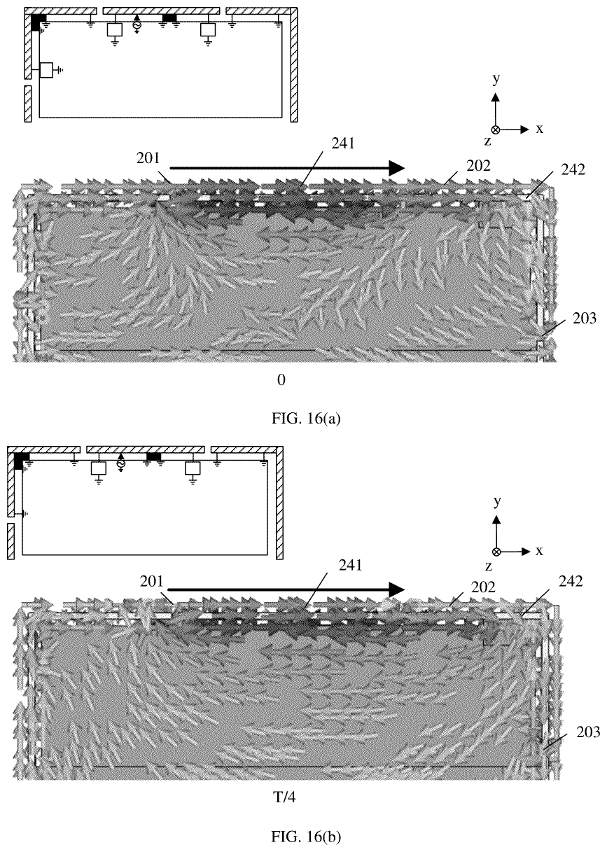

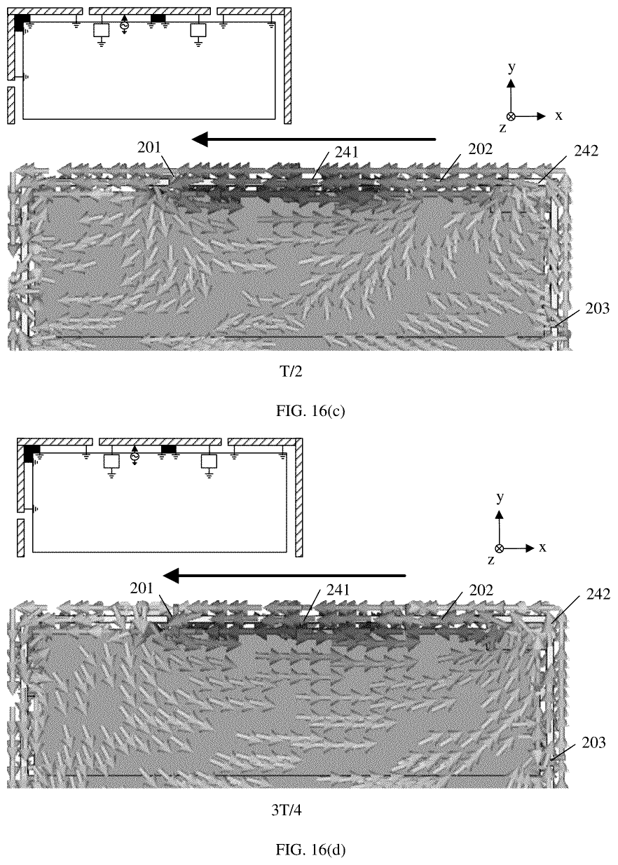

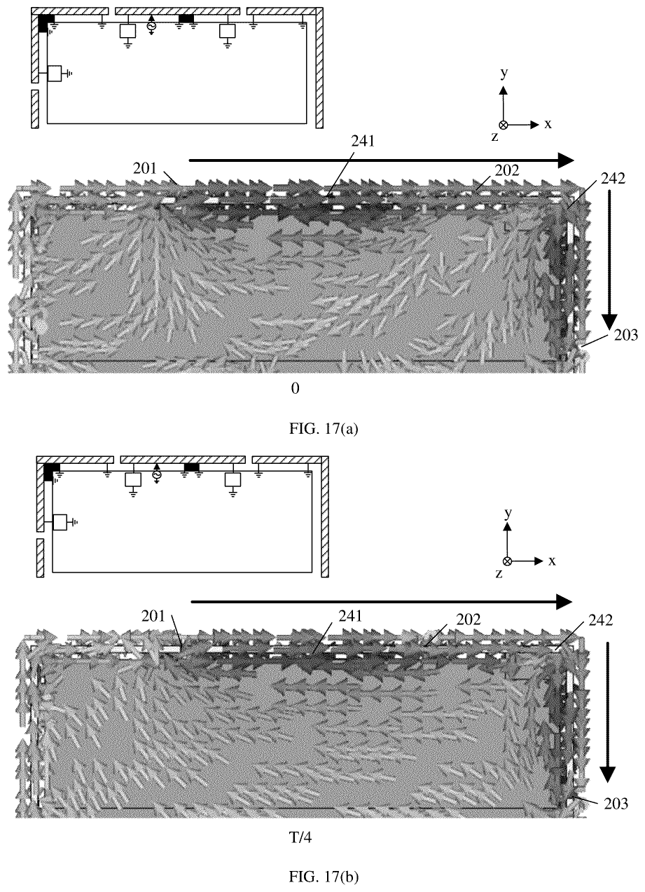

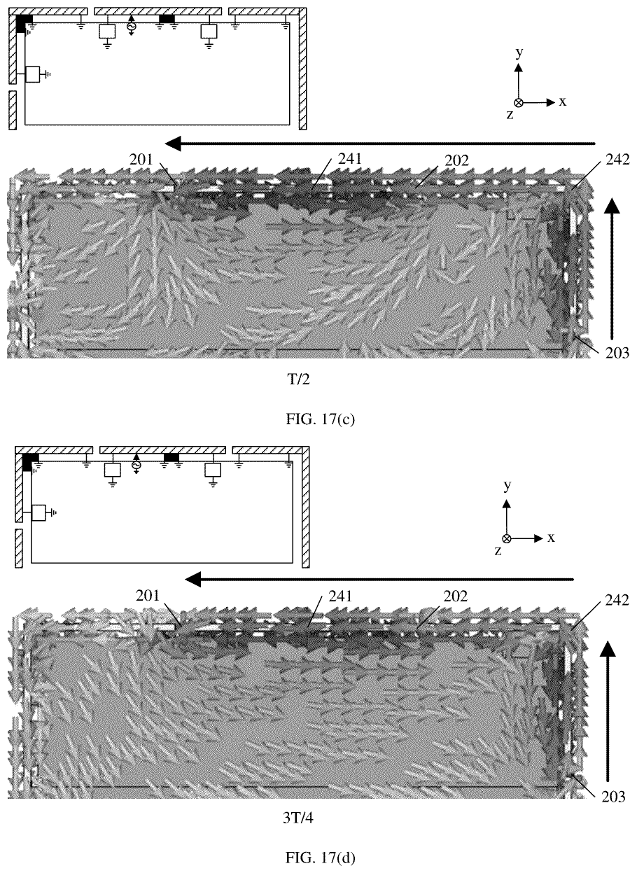

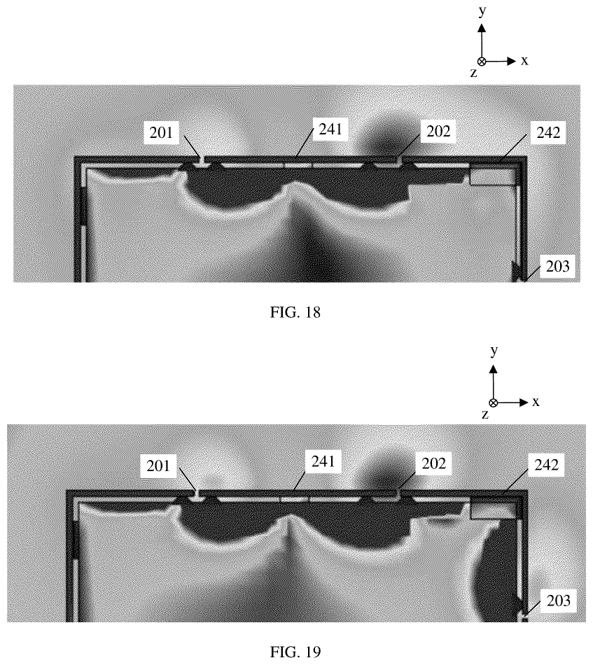

FIG. 16(a) to FIG. 19 are diagrams (rear views) of current and electric field distribution of the antenna 200 shown in FIG. 10. FIG. 16(a) to FIG. 16(d) are a diagram (rear view) of current distribution of the antenna 200 shown in FIG. 10 when the third connection point 2131 is grounded. FIG. 17(a) to FIG. 17(d) are a diagram (rear view) of current distribution of the antenna 200 shown in FIG. 10 when the third connection point 2131 is not grounded. FIG. 18 is a diagram (rear view) of electric field distribution of the antenna 200 shown in FIG. 10 when the third connection point 2131 is grounded. FIG. 19 is a diagram (rear view) of electric field distribution of the antenna 200 shown in FIG. 10 when the third connection point 2131 is not grounded.

It should be understood that FIG. 16(a) to FIG. 19 are diagrams in which currents between the third radiator and the first radiator form a similar array in a current cycle T at 2.2 GHz when the antenna generates radiation. The fourth connection point and the fifth connection point are grounded (the fourth connection point and the fifth connection point are electrically connected to the ground plane directly through the fourth tuning circuit and the fifth tuning circuit or are electrically connected to the ground plane via the 0-ohm resistors), to prevent the second radiator and the fourth radiator from affecting current and electric field distribution. The first tuning circuit and the second tuning circuit are in a corresponding tuning circuit state, so that the first radiator operates in the DM mode at 2.2 GHz.

FIG. 16(a) to FIG. 16(d) are the diagram of current distribution when the third connection point is grounded (the third connection point is electrically connected to the ground plane directly through the third tuning circuit or electrically connected to the ground plane via the 0-ohm resistor) and the third radiator may be used as a ground stub and does not participate in radiation. Currents are mainly concentrated on the first radiator.

FIG. 17(a) to FIG. 17(d) are the diagram of current distribution when an electronic component is electrically connected between the third tuning circuit and the ground plane (the resonant point frequency of the first parasitic resonance generated by the third radiator is lower than a resonant point frequency of the first resonance generated by the first radiator). At the resonant point (2.2 GHz) of the second resonance, the current on the first radiator and the current on the third radiator are co-directional, and the path of the current generated by the first radiator is extended.

As shown in FIG. 18, when the third radiator is used as the ground stub, an electric field near the third radiator is weak.

As shown in FIG. 19, when the electronic component is electrically connected between the third tuning circuit and the ground plane (the resonant point frequency of the first parasitic resonance generated by the third radiator is lower than the resonant point frequency of the first resonance generated by the first radiator), an electric field near the third radiator is strong.

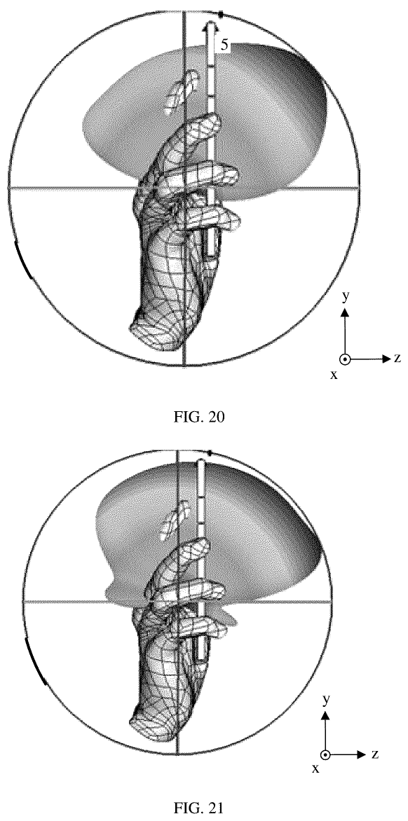

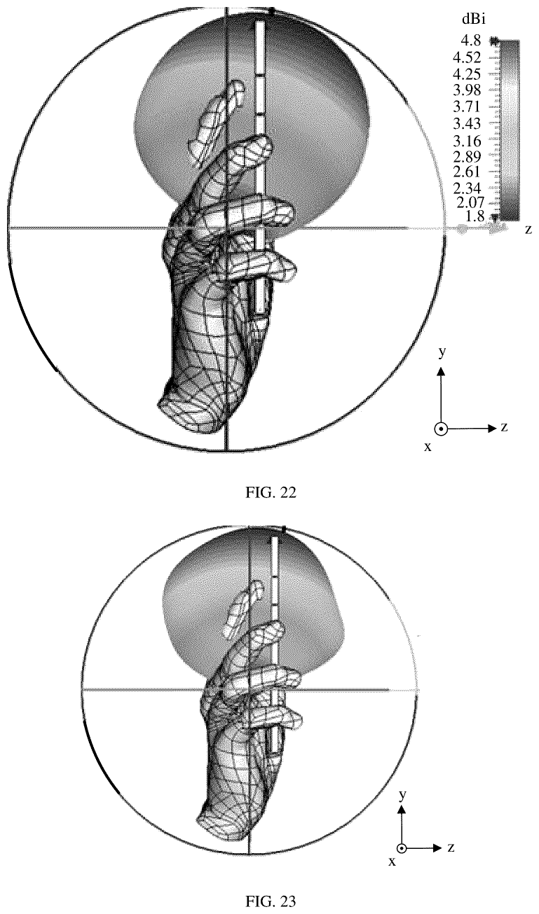

FIG. 20 to FIG. 23 show simulation results of patterns of the antenna 200 shown in FIG. 10. FIG. 20 is a pattern of a directional gain of the antenna 200 shown in FIG. 10 when the third connection point is grounded. FIG. 21 is a pattern of left-hand circular polarization directionality of the antenna 200 shown in FIG. 10 when the third connection point is grounded. FIG. 22 is a pattern of a directional gain of the antenna 200 shown in FIG. 10 when the third connection point is not grounded. FIG. 23 is a pattern of left-hand circular polarization 35 directionality of the antenna 200 shown in FIG. 10 when the third connection point is not grounded.

It should be understood that the simulation results of the patterns shown in FIG. 20 to FIG. 23 are all simulation results obtained when the electronic device is disposed in a hand model.

As shown in FIG. 20, when the third radiator is used as the ground stub, the directional gain of the antenna is 4.05 dBi. A maximum radiation direction of radiation generated by the antenna deviates from the top of the electronic device (for example, the y direction).

As shown in FIG. 21, when the third radiator is used as the ground stub, a left-hand circular polarization directional gain of the antenna is 1.1 dBic.

As shown in FIG. 22, when the electronic component is electrically connected between the third tuning circuit and the ground plane (the resonant point frequency of the first parasitic resonance generated by the third radiator is lower than the resonant point frequency of the first resonance generated by the first radiator), because the current on the first radiator and the current on the third radiator are co-directional, the currents between the third radiator and the first radiator forms the similar array, compared with that in the gain pattern shown in FIG. 20, a maximum radiation direction of radiation generated by the antenna is close to the top of the electronic device (for example, the y direction), and the directional gain is increased from 4.05 dBi to 4.8 dBi.

As shown in FIG. 23, when the electronic component is electrically connected between the third tuning circuit and the ground plane, a left-hand circular polarization directional gain of the antenna is increased from 1.1 dBic to 1.9 dBic.

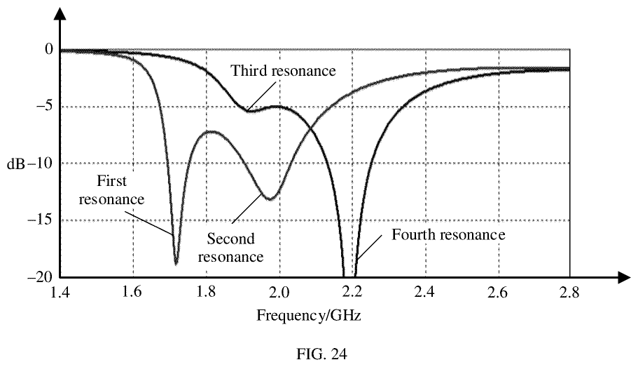

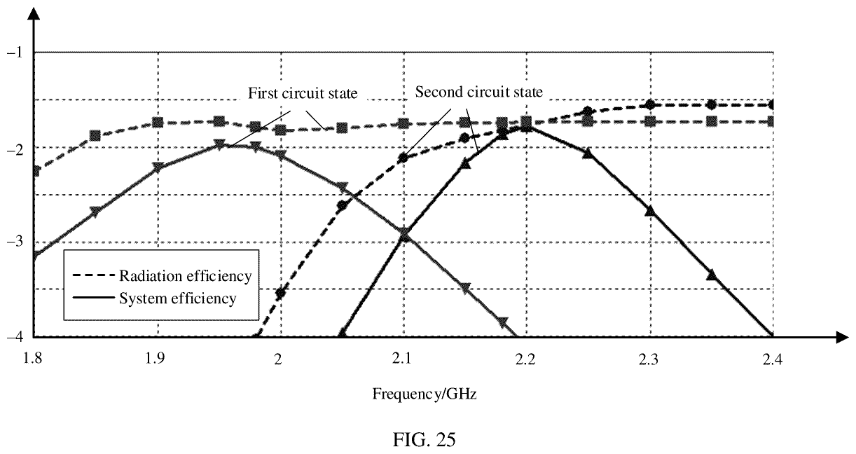

FIG. 24 and FIG. 25 show simulation results of the antenna 200 shown in FIG. 10. FIG. 24 shows a simulation result of an S-parameter of the antenna 200 shown in FIG. 10. FIG. 25 shows simulation results of system efficiency and radiation efficiency of the antenna 200 shown in FIG. 10.

It should be understood that FIG. 24 and FIG. 25 show simulation results of the antenna when the first tuning circuit and the second tuning circuit are in different circuit states. For example, when the first tuning circuit and the second tuning circuit are in a first circuit state (for example, a first electronic component is electrically connected between the connection point and the ground plane), a resonance generated by the antenna includes the first resonance and the second resonance. When the first tuning circuit and the second tuning circuit are in a second circuit state (for example, a second electronic component is electrically connected between the connection point and the ground plane), a resonance generated by the antenna includes the third resonance and the fourth resonance.

Correspondingly, the third tuning circuit may be in the first circuit state and the second circuit state when the first radiator separately generates the second resonance and the fourth resonance, so that a resonant point frequency of a parasitic resonance generated by the third radiator, a resonant point frequency of the second resonance, and a resonant point frequency of the fourth resonance are within the ranges described in the foregoing embodiments. This improves directionality of the antenna.

In addition, the fourth tuning circuit may be in the first circuit state and the second circuit state when the first radiator separately generates the second resonance and the fourth resonance, so that a resonant point frequency of a parasitic resonance generated by the fourth radiator, the resonant point frequency of the second resonance, and the resonant point frequency of the fourth resonance are within the ranges described in the foregoing embodiments. This improves radiation efficiency and system efficiency of the antenna.

It should be understood that, because a gain of the antenna is related to directionality and efficiency (radiation efficiency and system efficiency) of the antenna, when efficiency (radiation efficiency and system efficiency) of the antenna is improved, and directionality remains unchanged, the gain of the antenna can still be improved.

The fifth connection point may be electrically connected to the ground plane directly through the fifth tuning circuit or electrically connected to the ground plane via the 0-ohm resistor, and the fourth radiator is coupled to the ground plane at the fifth connection point, to prevent interference of the fourth radiator to satellite communication.

As shown in FIG. 24, when the first feed circuit feeds the electrical signal, the antenna may generate two resonances each time when the first tuning circuit and the second tuning circuit are in different circuit states. When the first tuning circuit and the second tuning circuit are in the first circuit state, the resonance generated by the antenna includes the first resonance (near 1.7 GHz) and the second resonance (near 2 GHz). With S11<−6 dB as a boundary, an operating frequency band of the antenna may include 1980 MHz to 2010 MHz.

When the first tuning circuit and the second tuning circuit are in the second circuit state, the resonance generated by the antenna includes the third resonance (near 2 GHz) and the fourth resonance (near 2.2 GHz). With S11<−6 dB as the boundary, the operating frequency band of the antenna may include 2170 MHz to 2200 MHz.

As shown in FIG. 25, the first radiator operates in the DM mode at both 1980 MHz to 2010 MHz and 2170 MHz to 2200 MHz, and the third radiator can improve system efficiency and radiation efficiency of the antenna. Therefore, the antenna has good system efficiency and radiation efficiency in the foregoing frequency bands.

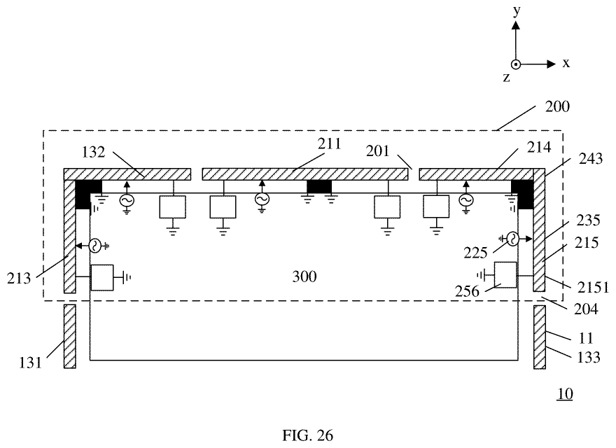

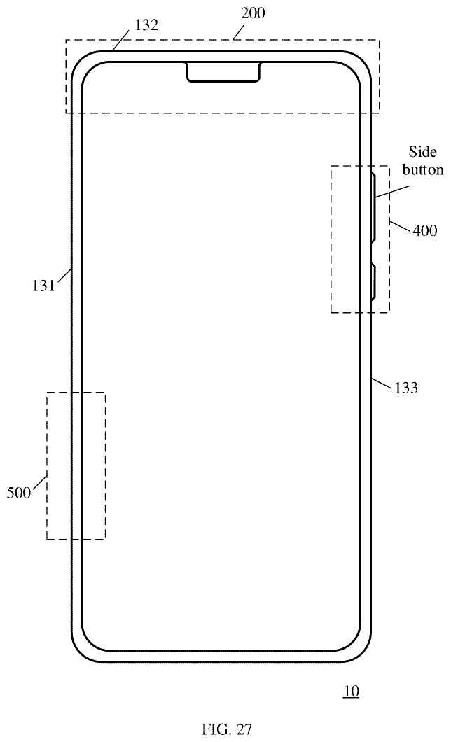

FIG. 26 is a diagram of another electronic device 10 according to an embodiment of this disclosure.

As shown in FIG. 26, the side frame 11 may further include a fourth position 204. The third ground point 243 is located between the first position 201 and the fourth position 204. A fourth slot is provided at the fourth position 204. The antenna 200 further includes a fifth radiator 215. The fifth radiator 215 includes at least a part of the side frame between the third ground point 243 and the fourth position 204. The fifth radiator 215 is configured to generate a third parasitic resonance. A resonant point frequency of the third parasitic resonance is lower than a resonant point frequency of a first main resonance.

It should be understood that a difference between the electronic device 10 shown in FIG. 26 and the electronic device 10 shown in FIG. 10 lies only in that the fourth slot is provided at the fourth position 204, so that the antenna 200 includes the fifth radiator 215.

In the technical solutions provided in embodiments of this disclosure, when the first radiator 211 generates the first main resonance in a wire DM mode, the fifth radiator 215 may be excited to generate the fifth parasitic resonance. In an embodiment, when the first feed circuit 221 feeds an electrical signal, at a resonant point of the first main resonance, a current on the first radiator 211 and a current on the fifth radiator 215 are co-directional. In this way, a path of the current generated by the first radiator 211 can be extended. An effect of a similar current array can be obtained using co-directional currents on the first radiator 211, the third radiator 213, and the fifth radiator 215, and directivity of the antenna 200 can be further improved.

In an embodiment, a length L3 of the side frame between the first position 201 and the fourth position 204 and a length LI of the side frame between the first position 201 and the second position 202 satisfy: L1≤L3≤L1×120%.

In an embodiment, the fifth radiator 215 may further include a sixth connection point 2151. The electronic device 10 further includes a sixth tuning circuit 256. The sixth tuning circuit 256 is coupled to the sixth connection point 2151.

It should be understood that the sixth tuning circuit 256 may be configured to adjust a resonant point frequency of a resonance generated by the fifth radiator 215, so that the fifth radiator 215 generates the fifth parasitic resonance and a sixth parasitic resonance. In this way, the path of the current generated by the first radiator 211 is extended in a first frequency band and a second frequency band, the effect of the similar current array can be obtained, and directionality of the antenna 200 can be improved.

In an embodiment, a frequency difference between the resonant point of the first main resonance and a resonant point of the fifth parasitic resonance is less than or equal to 200 MHz. In an embodiment, a frequency difference between a resonant point of a second main resonance and a resonant point of the sixth parasitic resonance is less than or equal to 200 MHz.

It should be understood that, when the frequency difference between the resonant point of the first main resonance (or the second main resonance) and the resonant point of the fifth parasitic resonance (or the sixth parasitic resonance) is less than or equal to 200 MHz, the first feed circuit 221 feeds the electrical signal, and at the resonant point of the first main resonance (or the second main resonance), a proportion of currents that are generated by the fifth radiator 215 and that are co-directional with the current on the first radiator 211 is larger, to further improve directionality of the antenna 200.

In an embodiment, the side frame 11 may include a third side 133 that intersects the second side 132 at an angle. A length of the third side 133 is greater than a length of the second side 132. In an embodiment, the fourth position 204 is located on the third side 133.

In an embodiment, the fifth radiator 215 may further include a fifth feed point 235. The electronic device 10 may further include a fifth feed circuit 225. The fifth feed circuit 225 is coupled to the fifth feed point 235. In an embodiment, the fifth feed point 235 is located between the sixth connection point 2151 and the third ground point 243.

It should be understood that, when the antenna 200 does not perform satellite communication, the fifth radiator 215 and the fifth feed circuit 225 may form the fifth antenna, and the fifth radiator 215 may operate in a quarter-wavelength mode.

In an embodiment, a length R5 of the fifth radiator 215 (a length of the side frame between the fourth position 204 and the third ground point 243) and the length L1 of the side frame (the first radiator 211) between the first position 201 and the second position 202 satisfy: L1×40%≤R5≤L1×65%.

In an embodiment, an operating frequency band of the fifth antenna may include at least a part of frequency bands in a middle band (MB) (1710 MHz to 2170 MHz) and/or at least a part of frequency bands in a high band (HB) (2300 MHz to 2690 MHz), for example, B1 (1920 MHz to 1980 MHz), B3 (1710 MHz to 1785 MHz), and B7 (2500 MHz to 2570 MHz) in LTE.

It should be understood that the sixth tuning circuit 256 may be further configured to determine a resonant point frequency of a resonance generated by the fifth antenna, so that the fifth antenna can operate in different communication frequency bands. For example, the sixth tuning circuit 256 may be in different circuit states, so that different electronic components are electrically connected between the sixth connection point 2151 and the ground plane.

In addition, when the electronic device performs satellite communication or does not perform satellite communication, the fifth radiator 215 generates the resonance. When the electronic device 10 performs satellite communication, the fifth antenna does not operate as a main feed antenna. The fifth radiator 215 generates a parasitic resonance in a manner of an indirect coupling to the first radiator 211. This improves a radiation characteristic of the antenna 200 (for example, a frequency difference between a resonant point of the parasitic resonance and a resonant point of a main resonance is within the foregoing range). When the electronic device 10 does not perform satellite communication, the fifth antenna operates as a main feed antenna. The fifth radiator 215 may generate the resonance by using the fed electrical signal. A resonant point frequency of the resonance is different from the resonant point frequency of the parasitic resonance.

In an embodiment, grounding may be implemented at the third ground point 243 via a third ground member. A width of a connection between the third ground member and the side frame is greater than or equal to 1 mm and less than or equal to 20 mm.

It should be understood that a ground structure at the third ground point 243 may be configured to improve isolation between a fourth antenna and the fifth antenna.

In an embodiment, a distance between the third ground point 243 and a sixth ground point 246 is greater than or equal to 1 mm and less than or equal to 20 mm, so that there is better isolation between the fourth antenna and the fifth antenna.

It should be understood that, for brevity of description, in this embodiment of this disclosure, an example in which operating frequency bands of a first antenna, a second antenna, a third antenna, the fourth antenna, and the fifth antenna include the foregoing frequency bands is merely used for description. In actual production or design, the operating frequency bands of the first antenna, the second antenna, the third antenna, the fourth antenna, and the fifth antenna may include other frequency bands. This is not limited in embodiments of this disclosure.

In this embodiment of this disclosure, the first antenna and the antenna 200 feed electrical signals through a same feed circuit (the first feed circuit). When the electronic device 10 performs satellite communication, the feed circuit cannot feed the electrical signal of the first antenna. Therefore, the first antenna does not operate. In an embodiment, if the first antenna is configured to feed a signal of the L1 frequency band in the GPS, the antenna 200 for satellite communication and the first antenna operating in the L1 frequency band in the GPS do not operate at the same time. In an embodiment, if the first antenna is configured to feed a signal of the 2.4 GHz frequency band in Wi-Fi, the antenna 200 for satellite communication and the first antenna operating in the 2.4 GHz frequency band in Wi-Fi do not operate at the same time. Similarly, the first antenna may be further configured to feed a signal of another frequency band. Details are not described herein again.

When the electronic device 10 performs satellite communication, at least a part of frequency bands in the operating frequency bands of the second antenna (for example, the 2.4 GHz frequency band in Wi-Fi and the frequency band N77), the third antenna (for example, the MB or the HB), the fourth antenna (for example, the MB or the HB and the frequency band N77), and the fifth antenna (for example, the MB or the HB) is close to the first main resonance or the second main resonance of the antenna 200 (for example, a difference between a center frequency of a part of frequency bands in the operating frequency bands and a resonant point frequency of a main resonance is less than or equal to 200 MHz). Consequently, isolation between the antenna 200, and the second antenna, the third antenna, the fourth antenna, and the fifth antenna is poor (for example, isolation between the antenna 200, and the second antenna, the third antenna, the fourth antenna, and the fifth antenna is less than 25 dB). When the antenna 200 generates a resonance, and the second antenna, the third antenna, the fourth antenna, and the fifth antenna operate, some power is injected into corresponding feed circuits from the feed points of the second antenna, the third antenna, the fourth antenna, and the fifth antenna, causing damage to some components in the feed circuits.

In an embodiment, the operating frequency band of the second antenna, the third antenna, the fourth antenna, or the fifth antenna is not close to the first main resonance or the second main resonance of the antenna 200 (for example, a difference between a center frequency of a part of frequency bands in the operating frequency bands and a resonant point frequency of a main resonance is greater than 200 MHz). When the electronic device 10 performs satellite communication, the second antenna, the third antenna, the fourth antenna, or the fifth antenna may operate with the antenna 200 at the same time.

In an embodiment, the operating frequency band of the second antenna, the third antenna, the fourth antenna, or the fifth antenna may include the L1 frequency band in the GPS. The L1 frequency band in the GPS is not close to a frequency band in satellite communication, and there is good isolation. Therefore, an antenna including the L1 frequency band in the GPS can operate with the antenna 200 at the same time. When performing satellite communication (sending or receiving a message or performing voice communication), the electronic device 10 may perform positioning at the same time.

In an embodiment, the electronic device 10 may further include an antenna 400 and an antenna 500, as shown in FIG. 27.

An operating frequency band of the antenna 400 may include a BT frequency band (2.4 GHz to 2.4835 GHz). An operating frequency band of the antenna 500 may include at least a part of frequency bands in the middle band (middle band, MB) (1710 MHz to 2170 MHz) and/or at least a part of frequency bands in the high band (high band, HB) (2300 MHz to 2690 MHz), for example, B1 (1920 MHz to 1980 MHz), B3 (1710 MHz to 1785 MHz), and B7 (2500 MHz to 2570 MHz) in LTE.

In an embodiment, a distance between the antenna 400 and the first radiator in the antenna 200 in an extension direction of the first side 131 or an extension direction of the third side 133 may be greater than one sixth of a length of the first side 131 or the length of the third side 133. In an embodiment, the antenna 400 may be located near a side button of the electronic device 10.

In an embodiment, a distance between the antenna 500 and the first radiator in the antenna 200 in the extension direction of the first side 131 or the extension direction of the third side 133 may be greater than one half of the length of the first side 131 or the length of the third side 133.

It should be understood that, when the operating frequency band of the antenna 400 is close to but does not overlap an operating frequency band of the antenna 200, and the distance between the antenna 400 and the first radiator in the antenna 200 in the extension direction of the first side 131 or the extension direction of the third side 133 may be greater than one sixth of the length of the first side 131 or the third side 133, there may be good isolation between the antenna 400 and the antenna 200, and the antenna 400 and the antenna 200 may operate at the same time. In an embodiment, the electronic device 10 may establish a Bluetooth connection to an external wearable device (for example, a headset or a watch) through the antenna 400.

When the operating frequency band of the antenna 500 is close to but does not overlap the operating frequency band of the antenna 200, and the distance between the antenna 500 and the first radiator in the antenna 200 in the extension direction of the first side 131 or the extension direction of the third side 133 may be greater than one half of the length of the first side 131 or the third side 133, there may be good isolation between the antenna 500 and the antenna 200, and the antenna 500 and the antenna 200 may operate at the same time.

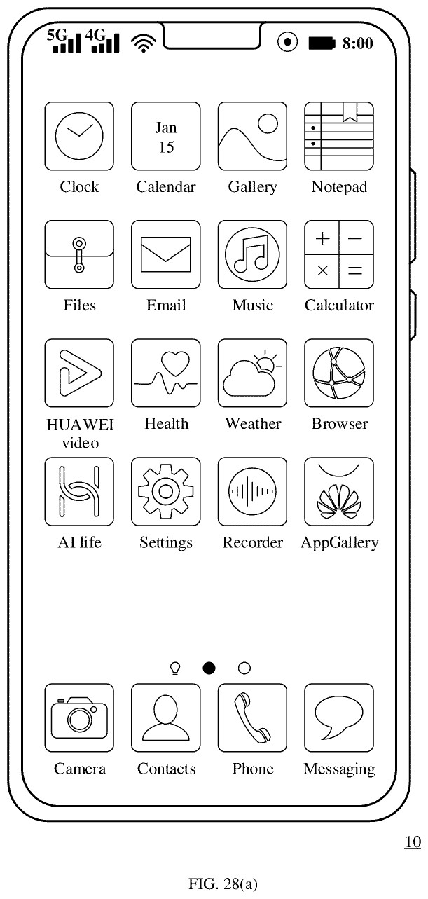

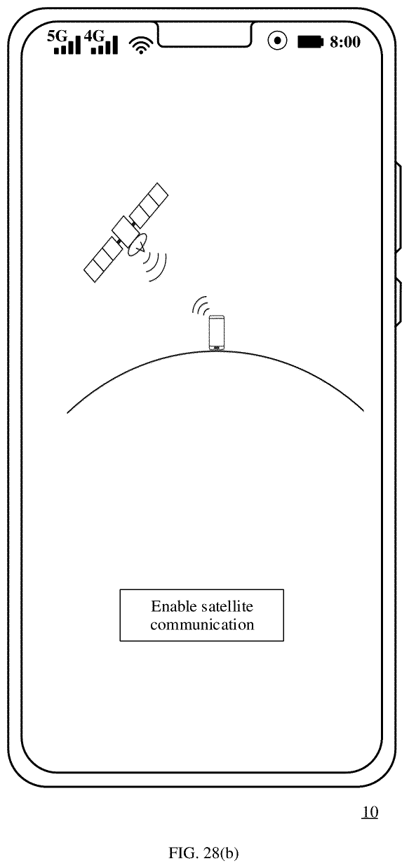

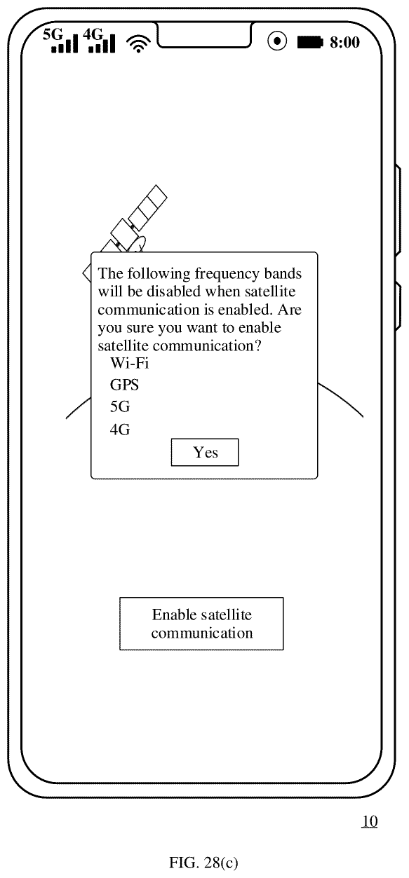

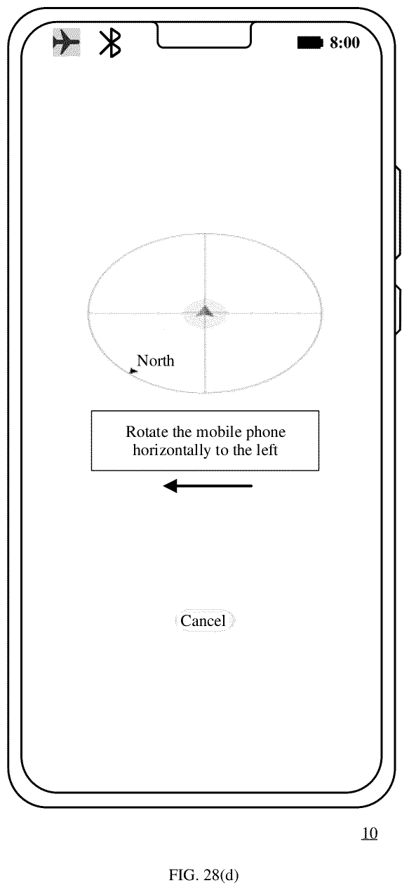

FIG. 28(a) to FIG. 28(d) are a diagram of a graphical user interface of an electronic device 10 according to an embodiment of this disclosure.

It should be understood that, for brevity of description, in this embodiment of this disclosure, an example in which operating frequency bands of a first antenna, a second antenna, a third antenna, a fourth antenna, and a fifth antenna include the foregoing frequency bands is merely used for description. In actual production or design, the operating frequency bands of the first antenna, the second antenna, the third antenna, the fourth antenna, and the fifth antenna may include other frequency bands. This is not limited in embodiments of this disclosure.

When the electronic device 10 does not perform satellite communication, the electronic device 10 may perform communication through the first antenna, the second antenna, the third antenna, the fourth antenna, or the fifth antenna in the foregoing embodiments, and may perform communication using a 4G/5G frequency band in a cellular network or Wi-Fi, and perform positioning via a GPS, as shown in FIG. 28(a).

When being ready to perform satellite communication, a user starts a satellite communication application, as shown in FIG. 28(b).

It should be understood that, in this embodiment of this disclosure, only a graphical user interface shown in FIG. 28(b) is used as an example for description. In actual production or design, the graphical user interface may alternatively be adjusted.

When the user enables satellite communication, on a graphical user interface, the user is reminded of information about frequency bands to be disabled, as shown in FIG. 28(c).

It should be understood that, after the user enables satellite communication, the electronic device 10 may shut down some antennas related to the antenna 200 in the foregoing embodiments, for example, the second antenna (for example, a 2.4 GHz frequency band in Wi-Fi or the frequency band N77), the third antenna (for example, an MB or an HB), the fourth antenna (for example, the MB or the HB and the frequency band N77), and the fifth antenna (for example, the MB or the HB) in the foregoing embodiments.

In addition, some antennas in the electronic device 10 may not be shut down, for example, the antenna 400 and the antenna 500 in the foregoing embodiments. The electronic device 10 may establish a Bluetooth connection to an external wearable device (for example, a headset or a watch) through the antenna 400. Alternatively, when the operating frequency band of the second antenna, the third antenna, the fourth antenna, or the fifth antenna in the foregoing embodiments is not close to a first main resonance or a second main resonance of the antenna 200, satellite communication may be performed at the same time.

After the user enables satellite communication, the user may perform satellite alignment according to a step displayed on a graphical user interface, to perform satellite communication, as shown in FIG. 28(d).

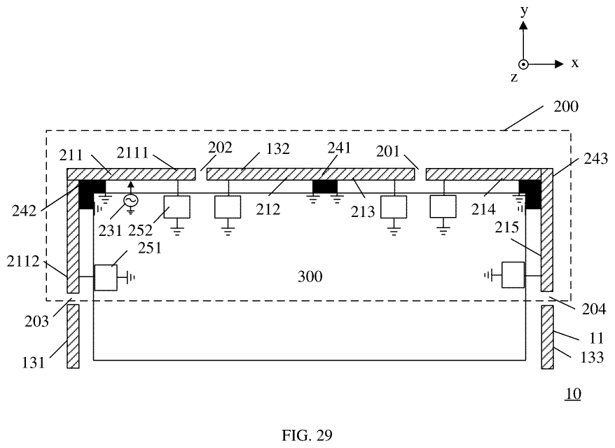

FIG. 29 is a diagram of another electronic device 10 according to an embodiment of this disclosure.

As shown in FIG. 29, the side frame 11 may include the second position 202 located on the second side 132, the third position 203 located on the first side 131, and the second ground point 242. Slots are provided at the second position 202 and the third position 203 of the side frame 11. The side frame 11 is coupled to the ground plane 300 at the second ground point 242.

The antenna 200 may include the first radiator 211, the first feed circuit 221, the first tuning circuit 251, and the second tuning circuit 252. The first radiator 211 is a conductive part of the side frame between the second position 202 and the third position 203. A first end (an end close to the second position 202) and a second end (an end close to the third position 203) of the first radiator 211 are open ends.

The first radiator 211 includes a first feed point. A distance between the first feed point and the second position 201 is different from a distance between the first feed point and the third position 203, so that the first radiator 211 generates a wire CM mode and a wire DM mode at the same time. The first feed circuit 221 is coupled to the first feed point, and is configured to feed an electrical signal, to excite the antenna 200 to generate a resonance. That the distance between the first feed point and the second position 202 is different from the distance between the first feed point and the third position 203 may be understood as that a length of the first radiator 211 between the first feed point and the first end is different from a length of the first radiator 211 between the first feed point and the second end.

The first radiator 211 further includes the first connection point 2111 and the second connection point 2112. The first connection point 2111 is located between the second position 202 and the second ground point 242. The second connection point 2112 is located between the third position 203 and the second ground point 242. The first tuning circuit 251 is coupled to the first connection point 2111, and the second tuning circuit 252 is coupled to the second connection point 2112.

In an embodiment, the first tuning circuit 251 and the second tuning circuit 252 are in a first circuit state, and the first radiator 211 is configured to generate a first main resonance, where a resonant frequency band of the first main resonance includes a first frequency band. In an embodiment, the first tuning circuit 251 and the second tuning circuit 252 are in the first circuit state, and the first radiator 211 is configured to generate a first resonance and a second resonance, where a resonant point frequency of the first resonance is lower than a resonant point frequency of the second resonance, and the second resonance is the first main resonance.

In an embodiment, the first tuning circuit 251 and the second tuning circuit 252 are in a second circuit state, and the first radiator 211 is configured to generate a second main resonance, where a resonant frequency band of the second main resonance includes a second frequency band. In an embodiment, the first tuning circuit 251 and the second tuning circuit 252 are in the second circuit state, and the first radiator 211 is configured to generate a third resonance and a fourth resonance, where a resonant point frequency of the third resonance is lower than a resonant point frequency of the fourth resonance, and the fourth resonance is the second main resonance.

It should be understood that, according to the technical solutions provided in embodiments of this disclosure, the wire CM mode and the wire DM mode of the first radiator 211 may be excited at the same time. In the first circuit state, the first resonance is mainly generated in the wire CM mode, and the second resonance is mainly generated in the wire DM mode. In the second circuit state, the third resonance is mainly generated in the wire CM mode, and the fourth resonance is mainly generated in the wire DM mode.

Compared with that in a case in which the first radiator 211 is completely disposed on the second side 132, when a second part of the first radiator 211 is disposed on the second side 132, although radiation efficiency and system efficiency of a resonance generated by the antenna 200 in the wire DM mode are reduced to some extent, the antenna 200 still has good performance. Because a gain of the antenna is related to directionality and efficiency (radiation efficiency and system efficiency) of the antenna, when efficiency (radiation efficiency and system efficiency) of the antenna is improved, and directionality remains unchanged, the gain of the antenna can still be improved.

In an embodiment, a frequency difference between a resonant point of the second resonance and a resonant point of the first resonance is less than or equal to 300 MHz. In an embodiment, the frequency difference between the resonant point of the second resonance and the resonant point of the first resonance is greater than or equal to 100 MHz.

In an embodiment, a frequency difference between a resonant point of the fourth resonance and a resonant point of the third resonance is less than or equal to 300 MHz. In an embodiment, the frequency difference between the resonant point of the fourth resonance and the resonant point of the third resonance is greater than or equal to 100 MHz.

In an embodiment, a length of a first part of the first radiator 211 on the first side 131 is greater than or equal to one half of a length of the second part of the first radiator 211 on the second side 132 and less than or equal to three halves of the length of the second part of the first radiator 211 on the second side 132.

It should be understood that, in the antenna 200 shown in FIG. 29, a connection area between the first part and the second part of the first radiator 211 is in a fold line shape. Therefore, in this case, the length of the first part may be understood as a length of a conductor between the third position 203 and the connection area, and the length of the second part may be understood as a length between the second position 202 and the connection area. In an embodiment, a connection area between the first part and the second part of the first radiator 211 is in an arc shape. Therefore, in this case, the length of the first part may be understood as a length by which the first part extends in an extension direction of the first side 131, and the length of the second part may be understood as a length by which the second part extends in an extension direction of the second side 132.

When the first radiator 211 is in a bent shape, and the length of the first part on the first side 131 and the length of the second part on the second side 132 are within the foregoing range, radiation efficiency and system efficiency of the resonance generated in the wire DM mode are good.

A difference between the antenna 300 shown in FIG. 29 and the antenna 200 shown in the foregoing embodiments lies only in that positions of main radiators (radiators that feed electrical signals) are different during satellite communication.

In a same structure of the side frame 11, in the foregoing embodiments, the conductive part (the first radiator 211) of the side frame between the first position 201 and the second position 202 is used as the main radiator. In the antenna 200 shown in FIG. 29, the conductive part (the first radiator 211) of the side frame between the second position 202 and the third position 203 is used as the main radiator.

The same structure of the side frame 11 may be understood as follows: A slot may be provided at each of the first position 201, the second position 202, the third position 203, and the fourth position 204 of the side frame 11, and the side frame 11 may be coupled to the ground plane 300 at the first ground point 241, the second ground point 242, and the third ground point 243. The same structure of the side frame 11 may alternatively be understood as that ratios of lengths of the side frame between the first position 201, the second position 202, the third position 203, and the fourth position 204 are the same. The same structure of the side frame 11 may alternatively be understood as widths of connections to the side frame via ground members at the first ground point 241, the second ground point 242, and the third ground point 243.

In addition, in the electronic device 10 shown in FIG. 29, the third position 203 is located on the first side 131 of the side frame 11, and the second position 202 is located on the second side. The first radiator 211 is in the bent shape, for example, an L shape.

In an embodiment, a length of the first radiator 211 between the first connection point 2111 and the first end is less than or equal to one half of a length of the first radiator 211 between the second ground point 242 and the first end. In an embodiment, a distance between the first connection point 2111 and the second position 202 on the first radiator 211 is less than or equal to one half of a distance between the second ground point 242 and the second position 202 on the first radiator 211.

In an embodiment, a length D1 of the side frame between the first connection point 2111 and the second position 202 and a length L1 of the side frame between the third position 203 and the second position 202 satisfy: D1≤L1×30%. In an embodiment, D1≤L1×10%. In an embodiment, D1 is less than or equal to 8 mm.

In an embodiment, a length of the first radiator 211 between the second connection point 2112 and the second end is less than or equal to one half of a length of the first radiator 211 between the second ground point 242 and the second end. In an embodiment, a distance between the second connection point 2112 and the third position 203 on the first radiator 211 is less than or equal to one half of a distance between the second ground point 242 and the third position 203 on the first radiator 211.

In an embodiment, a length D2 of the side frame between the second connection point 2112 and the third position 203 and the length L1 of the side frame between the third position 203 and the second position 202 satisfy: D2≤L1×30%. In an embodiment, D2≤L1×10%. In an embodiment, D2 is less than or equal to 8 mm.

In an embodiment, in the antenna 200 shown in FIG. 29, the antenna 200 includes the second radiator 212 and the third radiator 213. The second radiator 212 is a conductive part of the side frame between the second position 202 and the first ground point 241. The third radiator 213 is a conductive part of the side frame between the second ground point 242 and the first position 201.

In an embodiment, the antenna 200 includes the fourth radiator 214 and the fifth radiator 215. A structure of each of the fourth radiator 214 and the fifth radiator 215 may be the same as the structure shown in 200 shown in FIG. 26.

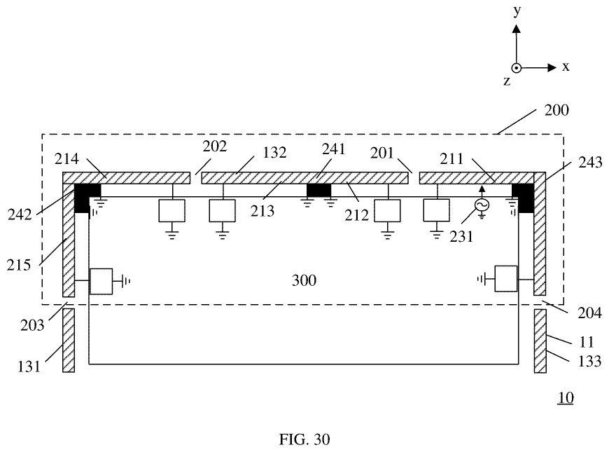

It should be understood that, in the embodiment shown in FIG. 29, an example in which the first radiator 211 is the conductive part of the side frame between the second position 202 and the third position 203 is used for description. In actual production or application, a conductive part of the side frame between the first position 201 and the fourth position 204 may alternatively be used as the first radiator 211. For brevity of description, details are not described again, as shown in FIG. 30.

In the several embodiments provided in this disclosure, it should be understood that the disclosed system, apparatus, and method may be implemented in other manners. For example, the described apparatus embodiments are examples. For example, division into the units is merely logical function division, and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The foregoing descriptions are merely specific implementations and are not intended to limit the protection scope of this disclosure. Any variation or replacement readily determined by a person skilled in the art within the technical scope of this disclosure is intended to fall within the protection scope of the accompanying claims.

1. An electronic device, comprising:
a ground plane;
a side frame comprising a first side and a second side that intersect at an angle, wherein:
the second side comprises a first position, a second position, and a first ground member positioned between the first position and the second position;
a first slot and a second slot are respectively provided at the first position and the second position of the side frame; and
the side frame is coupled to the ground plane via the first ground member, wherein a width of a connection between the first ground member and the side frame is greater than or equal to 2 mm and less than or equal to 8 mm; or
an electronic component is coupled between the first ground member and the ground plane, and an equivalent capacitance value of the electronic component is greater than or equal to 3 pF; and
a first antenna, comprising:
a first radiator, comprising:
a first connection point; and
a second connection point, wherein:
the first connection point is positioned between the first end of the first radiator and the first ground member of the side frame, the second connection point is positioned between the second end of the first radiator and the first ground member of the side frame;
the first radiator is a conductive part of the side frame extending between the first position and the second position;
a first end of the first radiator is located at the first position of the side frame; and
a second end of the first radiator is located at the second position of the side frame;
a first feed circuit, the first feed circuit including the first radiator, wherein:
the first radiator comprises a first feed point;
a length of the first radiator extending between the first feed point and the first end of the first radiator is different from a length of the first radiator extending between the first feed point and the second end of the first radiator; and
the first feed circuit is coupled to the first feed point; and
a first tuning circuit and a second tuning circuit, wherein:
the first tuning circuit is coupled to the first connection point of the first radiator, and the second tuning circuit is coupled to the second connection point of the first radiator, wherein:
the first tuning circuit and the second tuning circuit comprise one of a first circuit state or a second circuit state, wherein:
when the first tuning circuit and the second tuning circuit are in the first circuit state, and the first radiator is configured to generate a first main resonance, a resonant frequency band of the first main resonance comprises a transmit frequency band for satellite communication; and
when the first tuning circuit and the second tuning circuit are in the second circuit state, and the first radiator is configured to generate a second main resonance, a resonant frequency band of the second main resonance comprises a receive frequency band for satellite communication.

2. The electronic device according to claim 1, wherein:
a length of the first radiator extending between the first connection point and the first end of the radiator is less than or equal to one half of a length of the first radiator extending between the first end of the radiator and a connection position extending between the first radiator and the first ground member; or
a length of the first radiator extending between the second connection point and the second end of the radiator is less than or equal to one half of a length of the first radiator extending between the second end and a connection position between the first radiator and the first ground member.

3. The electronic device according to claim 1, wherein:
when the first tuning circuit and the second tuning circuit are in the first circuit state, and the first radiator is configured to generate a first resonance and a second resonance, a resonant point frequency of the first resonance is lower than a resonant point frequency of the second resonance, and the second resonance is a first main resonance; or
when the first tuning circuit and the second tuning circuit are in the second circuit state, and the first radiator is configured to generate a third resonance and a fourth resonance, a resonant point frequency of the third resonance is lower than a resonant point frequency of the fourth resonance, and the fourth resonance is a second main resonance.

4. The electronic device according to claim 3, wherein:
a frequency difference between a resonant point of the second resonance and a resonant point of the first resonance is less than or equal to 300 MHz; or
a frequency difference between a resonant point of the fourth resonance and a resonant point of the third resonance is less than or equal to 300 MHz.

5. The electronic device according to claim 4, wherein:
the frequency difference between the resonant point of the second resonance and the resonant point of the first resonance is greater than or equal to 100 MHz and less than or equal to 300 MHz; or
the frequency difference between the resonant point of the fourth resonance and the resonant point of the third resonance is greater than or equal to 100 MHz and less than or equal to 300 MHz.

6. The electronic device according to claim 3, wherein:
the width of the connection between the first ground member and the side frame is greater than or equal to 2 mm and less than 4 mm and a frequency difference between a resonant point of the second resonance and a resonant point of the first resonance is less than or equal to 450 MHz, or a frequency difference between a resonant point of the fourth resonance and a resonant point of the third resonance is less than or equal to 450 MHz; or
the width of the connection between the first ground member and the side frame is greater than or equal to 4 mm and less than or equal to 8 mm and the frequency difference between the resonant point of the second resonance and the resonant point of the first resonance is less than or equal to 400 MHz, or the frequency difference between the resonant point of the fourth resonance and the resonant point of the third resonance is less than or equal to 400 MHz; or
the electronic component is coupled between the first ground member and the ground plane and a frequency difference between a resonant point of the second resonance and a resonant point of the first resonance is less than or equal to 500 MHz, or a frequency difference between a resonant point of the fourth resonance and a resonant point of the third resonance is less than or equal to 500 MHz.

7. The electronic device according to claim 6, wherein:
the width of the connection between the first ground member and the side frame is greater than or equal to 2 mm and less than 4 mm and the frequency difference between the resonant point of the second resonance and the resonant point of the first resonance is greater than or equal to 50 MHz and less than or equal to 450 MHz, or the frequency difference between the resonant point of the fourth resonance and the resonant point of the third resonance is greater than or equal to 50 MHz and less than or equal to 450 MHz; and
the width of the connection between the first ground member and the side frame is greater than or equal to 4 mm and less than or equal to 8 mm, the frequency difference between the resonant point of the second resonance and the resonant point of the first resonance is greater than or equal to 50 MHz and is less than or equal to 400 MHz, or the frequency difference between the resonant point of the fourth resonance and the resonant point of the third resonance is greater than or equal to 50 MHz and is less than or equal to 400 MHz; or
the electronic component is coupled between the first ground member and the ground plane, the frequency difference between the resonant point of the second resonance and the resonant point of the first resonance is greater than or equal to 50 MHz and is less than or equal to 500 MHz, or the frequency difference between the resonant point of the fourth resonance and the resonant point of the third resonance is greater than or equal to 50 MHz and is less than or equal to 500 MHz.

8. The electronic device according to claim 1, wherein:
the side frame further comprises a third position and a second ground point, the third position is located on the first side, the second position is located between the first position and the third position, and the second ground point is located between the second position and the third position;
a third slot is provided at the third position of the side frame, and the side frame is coupled to the ground plane at the second ground point; and
the first antenna further comprises a second radiator or a third radiator, the second radiator is a conductive part of the side frame extending between the second position of the side frame and the second ground point, and the third radiator is a conductive part of the side frame extending between the second ground point and the third position of the side frame.

9. The electronic device according to claim 8, wherein:
the third radiator further comprises a third connection point; and
the electronic device further comprises a third tuning circuit that is coupled to the third connection point, wherein:
when the third tuning circuit is in the first circuit state, the third radiator is configured to generate a first parasitic resonance, wherein a frequency difference between the resonant point of the first main resonance and a resonant point of the first parasitic resonance is less than or equal to 200 MHz; or
when the third tuning circuit is in the second circuit state, the third radiator is configured to generate a second parasitic resonance, wherein a frequency difference between the resonant point of the second main resonance and a resonant point of the second parasitic resonance is less than or equal to 200 MHz.

10. The electronic device according to claim 9, wherein a length R1 of the third radiator and a length L1 of the first radiator satisfy: L1 30%≤R1≤L1 55%.

11. The electronic device according to claim 8, wherein:
the second radiator further comprises a fourth connection point; and
the electronic device further comprises a fourth tuning circuit that is coupled to the fourth connection point, wherein:
when the fourth tuning circuit is in the first circuit state, the second radiator is configured to generate a third parasitic resonance, wherein a frequency difference between a resonant point of the third parasitic resonance and the resonant point of the first main resonance is greater than or equal to 200 MHz and less than or equal to 500 MHz; or
when the fourth tuning circuit is in the second circuit state, the second radiator is configured to generate a fourth parasitic resonance, wherein a frequency difference between a resonant point of the fourth parasitic resonance and the resonant point of the second main resonance is greater than or equal to 200 MHz and less than or equal to 500 MHz.

12. The electronic device according to claim 11, wherein a length R2 of the second radiator and a length L1 of the first radiator satisfy: L1 35%≤R2≤L1 60%.

13. The electronic device according to claim 8, wherein:
the side frame further comprises a fourth position and a third ground point, the first position is located between the second position and the fourth position, and the third ground point is located between the first position and the fourth position;
a fourth slot is provided at the fourth position of the side frame, and the side frame is coupled to the ground plane at the third ground point; and
the first antenna further comprises a fourth radiator and a fifth radiator, the fourth radiator is a conductive part of the side frame between the first position and the third ground point, and the fifth radiator is a conductive part of the side frame between the third ground point and the fourth position.

14. The electronic device according to claim 13, wherein:
the fifth radiator further comprises a fifth connection point; and
the electronic device further comprises a fifth tuning circuit that is coupled to the fifth connection point, wherein:
when the fifth tuning circuit is in the first circuit state, the fifth radiator is configured to generate a fifth parasitic resonance, wherein a frequency difference between the resonant point of the first main resonance and a resonant point of the fifth parasitic resonance is less than or equal to 200 MHz; or
when the fifth tuning circuit is in the second circuit state, the fifth radiator is configured to generate a sixth parasitic resonance, wherein a frequency difference between the resonant point of the second main resonance and a resonant point of the sixth parasitic resonance is less than or equal to 200 MHz.

15. The electronic device according to claim 14, wherein a length R3 of the fifth radiator and a length L1 of the first radiator satisfy: L1 40%≤R3≤L1 65%.

16. The electronic device according to claim 1, wherein:
a length by which the first ground member extends between the side frame and the ground plane is less than or equal to 6 mm.

17. The electronic device according to claim 1, wherein the first ground member is positioned in a central area of the first radiator.

18. The electronic device according to claim 1, wherein the first feed point is positioned between the first ground member and the second end of the first radiator, and the electronic device further comprises:
a sixth antenna, wherein the sixth antenna comprises:
a sixth radiator, wherein the sixth radiator comprises a sixth feed point and is a radiator part of the first radiator positioned between the first ground member and the first end of the first radiator; and
a sixth feed circuit, wherein the sixth feed circuit is coupled to the sixth feed point.

19. An electronic device, comprising:
a ground plane;
a side frame comprising a first side and a second side that intersect at an angle, wherein:
the second side comprises a first position and a second position;
a first slot and a second slot are respectively provided at the first position and the second position of the side frame; and
a first antenna, comprising:
a first radiator, comprising:
a first connection point;
a second connection point, wherein:
the first connection point is positioned between the first end and the first feed point and the second connection point is located between the second end and the first feed point;
the first radiator is a conductive part of the side frame extending between the first position and the second position;
a first end of the first radiator is located at the first position; and
a second end of the first radiator is located at the second position;
a first feed circuit, the first feed circuit including the first radiator, wherein:
the first radiator comprises a first feed point;
the first feed circuit is coupled to the first feed point;
a length of the first radiator extending between the first feed point and the first end is different from a length of the first radiator extending between the first feed point and the second end;
a first tuning circuit and a second tuning circuit, wherein,
the first tuning circuit is coupled to the first connection point, and
the second tuning circuit is coupled to the second connection point; wherein:
an operating frequency band of the first antenna comprises a satellite communication frequency band, an L1 frequency band in a global positioning system (GPS), and at least a part of frequency bands in sub 6G;
when the electronic device performs satellite communication, the first radiator is configured to resonate in the satellite communication frequency band; and
when the electronic device does not perform satellite communication, the first radiator is configured to resonate in the L1 frequency band in the GPS and/or resonate in at least the part of frequency bands in the sub 6G,
the first tuning circuit and the second tuning circuit comprise a first circuit state or a second circuit state, wherein:
when the first tuning circuit and the second tuning circuit are in the first circuit state, the first radiator is configured to generate a first main resonance, wherein a resonant frequency band of the first main resonance comprises a transmit frequency band in satellite communication;
when the first tuning circuit and the second tuning circuit are in the second circuit state, the first radiator is configured to generate a second main resonance, wherein a resonant frequency band of the second main resonance comprises a receive frequency band in satellite communication.

20. The electronic device according to claim 19, wherein:
the side frame further comprises a third position and a first ground point, the third position is located on the first side, the second position is located between the first position and the third position, and the first ground point is located between the second position and the third position;
a third slot is provided at the third position of the side frame, and the side frame is coupled to the ground plane at the first ground point; and
the first antenna further comprises a second radiator and a third radiator, the second radiator is a conductive part of the side frame extending between the second position and the first ground point, and the third radiator is a conductive part of the side frame extending between the first ground point and the third position.
